(19) United States
(12) Patent Application Publication
(10) Pub. No.: US 2011/0125518 A1
(43) Pub. Date: May 26, 2011

(54) APPARATUSES, METHODS AND SYSTEMS FOR A MOBILE HEALTHCARE MANAGER-BASED PATIENT COMPREHENSION VALIDATOR

(76) Inventor: Rabin Chandra Kemp Dhoble, Newtown, PA (US)

(21) Appl. No.: 12/819,476

(22) Filed: Jun. 21, 2010

Related U.S. Application Data
(60) Provisional application No. 61/248,072, filed on Oct. 2, 2009.
(60) Provisional application No. 61/248,848, filed on Oct. 5, 2009.
(60) Provisional application No. 61/250,459, filed on Oct. 9, 2009.
(60) Provisional application No. 61/322,424, filed on Apr. 9, 2010.
(60) Provisional application No. 61/331,807, filed on May 5, 2010.

(51) Int. Cl. G06Q 50/00; G06Q 30/00

(52) U.S. Cl. 705/2

(57) ABSTRACT

The Apparatuses, Methods and Systems for a Mobile Healthcare Manager (“MHM”) Based Patient Comprehension Validator may provide an elegant and consistent multimedia interactive reference standard to maximize personal understanding of health information and coach individuals toward better health outcomes. In one embodiment, a prescription comprehension validation processor-implemented method is disclosed, comprising: obtaining a coordinated patient management trigger; identifying via a processor a prescription media object to provide for a user based on the obtained trigger; providing the identified prescription media object for the user; providing a request for user feedback to the provided prescription media object; obtaining the user feedback to the provided prescription media object; analyzing the obtained user feedback to the provided prescription media object; and validating, based on the analysis, user comprehension of information included in the provided prescription media object based on the obtained user feedback to the provided prescription media object.

### RELATED APPLICATIONS

Applicant hereby claims priority under 35 USC §119 for U.S. provisional patent application Ser. No. 61/248,072 filed Oct. 2, 2009, entitled “APPARATUSES, METHODS AND SYSTEMS FOR A MOBILE HEALTHCARE MANAGEMENT SYSTEM” (Attorney Docket No. 20275-002PV), U.S. provisional patent application Ser. No. 61/248,848 filed Oct. 5, 2009, entitled “APPARATUSES, METHODS AND SYSTEMS FOR A MOBILE HEALTHCARE MANAGEMENT SYSTEM” (Attorney Docket No. 20275-002PV2), U.S. provisional patent application Ser. No. 61/250,459 filed Oct. 9, 2009, entitled “APPARATUSES, METHODS AND SYSTEMS FOR A MOBILE HEALTHCARE MANAGEMENT SYSTEM” (Attorney Docket No. 20275-002PV3), U.S. provisional patent application Ser. No. 61/322,424 filed Apr. 9, 2010, entitled “APPARATUSES, METHODS AND SYSTEMS FOR A MOBILE HEALTHCARE MANAGEMENT SYSTEM” (Attorney Docket No. 20275-003PV), and U.S. provisional patent application Ser. No. 61/331,807 filed May 5, 2010, entitled “APPARATUSES, METHODS AND SYSTEMS FOR A MOBILE HEALTHCARE MANAGEMENT SYSTEM” (Attorney Docket No. 20275-003PV1).

The instant application is related by subject matter to the following co-pending applications: U.S. patent application Ser. No. ______ filed ______, entitled “APPARATUSES, METHODS AND SYSTEMS FOR A MOBILE HEALTHCARE 2 MANAGER” (Attorney Docket No. 20275-003US), U.S. patent application Ser. No. ______ filed ______, entitled “APPARATUSES, METHODS AND SYSTEMS FOR A MOBILE HEALTHCARE MANAGER-BASED PATIENT FEEDBACK DRIVEN PRESCRIPTION OPTIMIZER” (Attorney Docket No. 20275-003US2), U.S. patent application Ser. No. ______ filed ______, entitled “APPARATUSES, METHODS AND SYSTEMS FOR A MOBILE HEALTHCARE MANAGER-BASED PATIENT ADHERENCE MONITOR” (Attorney Docket No. 20275-003US3), U.S. patent application Ser. No. ______ filed ______, entitled “APPARATUSES, METHODS AND SYSTEMS FOR A MOBILE HEALTHCARE MANAGER-BASED PROVIDER INCENTIVE MANAGER” (Attorney Docket No. 20275-003US4), U.S. patent application Ser. No. ______ filed ______, entitled “APPARATUSES, METHODS AND SYSTEMS FOR A MOBILE HEALTHCARE MANAGER-BASED VIRAL SHARING PROVIDER” (Attorney Docket No. 20275-003US5), U.S. patent application Ser. No. ______ filed ______, entitled “APPARATUSES, METHODS AND SYSTEMS FOR A MOBILE HEALTHCARE MANAGER-BASED HEALTHCARE CONSULTATION MANAGER” (Attorney Docket No. 20275-003US6), and U.S. patent application Ser. No. ______ filed ______, entitled “APPARATUSES, METHODS AND SYSTEMS FOR A MOBILE HEALTHCARE MANAGER-BASED VIDEO PRESCRIPTION PROVIDER” (Attorney Docket No. 20275-003US7).

The entire contents of the aforementioned applications are herein expressly incorporated by reference.

### FIELD

The present invention is directed generally to apparatuses, methods, and systems of healthcare management, and more particularly, to APPARATUSES, METHODS AND SYSTEMS FOR A MOBILE HEALTHCARE MANAGER-BASED PATIENT COMPREHENSION VALIDATOR.

### BACKGROUND

A doctor may diagnose a patient's medical condition. The doctor may use patient medical information in assessing and prescribing treatment plans relevant to the patient's condition. Patients may talk with their doctors for descriptions of how to follow their treatment plans. People may also refer to online medical reference websites like WebMD.com in search of health related information.

### SUMMARY

The APPARATUSES, METHODS AND SYSTEMS FOR A MOBILE HEALTHCARE MANAGER (“MHM”) provide an elegant and consistent multimedia interactive reference standard to maximize personal understanding of health information and coach individuals toward better health outcomes.

In one embodiment, a prescription delivery processor-implemented method is disclosed, comprising: obtaining a trigger media object including information on a trigger for coordinated patient management for a user; decoding a healthcare information object identifier from the obtained trigger media object; identifying via a processor a prescription media object to provide for the user based on the healthcare information object identifier; and providing the identified prescription media object for the user.

In one embodiment, a prescription media request processor-implemented method is disclosed, comprising: generating via a processor a trigger media object including information on a trigger for coordinated patient management for a user; providing the trigger media object; obtaining a prescription media object including health information in response to providing the trigger media object; and presenting the prescription media object for the user.

In one embodiment, a prescription comprehension validation processor-implemented method is disclosed, comprising: obtaining a coordinated patient management trigger; identifying via a processor a prescription media object to provide for a user based on the obtained trigger; providing the identified prescription media object for the user; providing a request for user feedback to the provided prescription media object; obtaining the user feedback to the provided prescription media object; analyzing the obtained user feedback to the provided prescription media object; and validating, based on the analysis, user comprehension of information included in the provided prescription media object based on the obtained user feedback to the provided prescription media object.

In one embodiment, a prescription comprehension confirmation processor-implemented method is disclosed, comprising: generating via a processor a coordinated patient management trigger; providing the coordinated patient management trigger; obtaining a prescription media object in response to providing the coordinated patient management trigger; presenting the obtained prescription media object for the user; obtaining a request for user feedback to the obtained prescription media object; providing the user feedback to the obtained prescription media object; and obtaining an indication of validation of user comprehension of information in the obtained prescription media object, in response to providing the user feedback to the obtained prescription media object.

In one embodiment, a prescription optimization processor-implemented method is disclosed, comprising: obtaining a coordinated patient management trigger for a user; obtaining a medical history record of the user using the obtained trigger; analyzing, via a processor, the obtained medical history record of the user; identifying, based on the analysis of the medical history record, a current treatment plan for the user; generating a user feedback request based on the identified current treatment plan; providing the user feedback request to a user device of the user; obtaining user feedback in response to providing the user feedback request; analyzing the obtained user feedback based on the current treatment plan for the user; generating a modified treatment plan for the user based on the analysis of the obtained user feedback; and providing the modified treatment plan for the user.

In one embodiment, a treatment progress reporting processor-implemented method is disclosed, comprising: generating a coordinated patient management trigger for a user; providing the coordinated patient management trigger; obtaining a request for user feedback on a current treatment plan; generating, via a processor, the user feedback on the current treatment plan, upon obtaining the request for user feedback; providing the generated user feedback on the current treatment plan; obtaining a modified treatment plan for the user, upon providing the generated user feedback on the current treatment plan; obtaining a request for user feedback on the modified treatment plan, upon providing the acknowledgment of the modified treatment plan for the user; generating the user feedback on the modified treatment plan, upon obtaining the request for user feedback on the modified treatment plan; and providing the generated user feedback on the modified treatment plan.

In one embodiment, a patient adherence processor-implemented method is disclosed, comprising: obtaining a user identification of a user; obtaining a medical history record of the user using the obtained user identification; analyzing the obtained medical history record of the user; identifying, based on the analysis of the medical history record, a treatment plan for the user; analyzing, via a processor, the treatment plan for the user; identifying, based on the analysis of the treatment plan for the user, milestones included in the treatment plan for the user; identifying a media prescription object to provide for the user based on the determined progress of the user towards the milestone; providing the identified media prescription object for the user; providing a user feedback request; obtaining user feedback in response to providing the user feedback request; analyzing the obtained user feedback; and determining whether one of the milestones included in the treatment plan for the user has been achieved based on analyzing the obtained user feedback.

In one embodiment, a healthcare service provider performance incentivisation processor-implemented method is disclosed, comprising: providing prescription media objects for a plurality of users, wherein the prescription media objects are associated with a plurality of healthcare service providers; obtaining usage feedback on the provided prescription media objects from the plurality of users; aggregating the obtained usage feedback from the plurality of users; analyzing via a processor the aggregated usage feedback from the plurality of users; identifying a user trend based on the analysis of the aggregated usage feedback; and generating a performance report for one of the healthcare service providers based on the identified user trend.

In one embodiment, a healthcare content sharing processor-implemented method is disclosed, comprising: providing prescription media objects associated with a plurality of healthcare service providers to a plurality of users for sharing; obtaining information on user sharing of the provided prescription media objects; aggregating the information on user sharing of the provided prescription media objects; analyzing, via a processor, the aggregated information on user sharing of the provided prescription media objects; identifying a user trend based on analyzing the aggregated information on user sharing of the provided prescription media objects; and generating a performance report for one of the healthcare service providers based on the identified user trend.

In one embodiment, a healthcare consultation processor-implemented method is disclosed, comprising: obtaining a trigger media object for coordinated patient management for a user; obtaining a medical history record of the user using the obtained trigger media object; analyzing, via a processor, the obtained medical history record of the user; identifying, based on the analysis of the medical history record, a need for user consultation with a provider of a healthcare service; providing, for a plurality of such providers of the healthcare service, an indication of the identified need for user consultation; obtaining responses from the providers of the healthcare service to the provided indication of the identified need for user consultation; providing, for the user, information on the responsive providers of the healthcare service based on the obtained responses; obtaining a user selection of one of the responsive providers of the healthcare service for user consultation; upon obtaining the user selection of one of the responsive providers of the healthcare service for user consultation, providing the medical history record of the user to the user-selected provider of the healthcare service; and providing an indication to establish a communication between a user device of the user and the user-selected provider of the healthcare service for user consultation.

In one embodiment, an informed consultation processor-implemented method is disclosed, comprising: generating via a processor a trigger media object for coordinate patient management for a user; providing the generated trigger media object; obtaining an indication of a need for user consultation with a provider of a healthcare service; providing a request for information on providers of the healthcare service; obtaining the requested information on providers of the healthcare service; providing a user selection of one of the providers of the healthcare service for user consultation; obtaining an indication to establish a communication between a user device of the user and the user-selected provider of the healthcare service for user consultation; and establishing a communication between the user device and the user-selected provider of the healthcare service for user consultation.

In one embodiment, a video prescription provider method is disclosed, comprising: obtaining a request for a video from a user; providing a request for a user identification of the user; obtaining the user identification of the user; querying via a processor a user database using the obtained user identification; determining that the user is authenticated to access the video, based on querying the user database; and providing the requested video for the user; wherein the request for the video is obtained from a mobile device of the user; and wherein the video includes information on a healthcare topic.

### BRIEF DESCRIPTION OF THE DRAWINGS

The accompanying appendices and/or drawings illustrate various non-limiting, example, inventive aspects in accordance with the present disclosure:

FIG. 1 is of a block diagram illustrating various Mobile Healthcare Manager (“MHM”) components and/or affiliated entities included in coordinated patient management in some embodiments of the MHM.

FIG. 2 is of a data flow diagram illustrating aspects of coordinated user management in some embodiments of the MHM.

FIG. 3 is of a logic flow diagram illustrating aspects of user management in some embodiments of the MHM.

FIGS. 4A-B are of logic flow diagrams illustrating aspects of device management in some embodiments of the MHM.

FIGS. 5A-B are of logic flow diagrams illustrating aspects of user experience management in some embodiments of the MHM.

FIGS. 6A-C are of logic flow diagrams illustrating aspects of coordinated user management in some embodiments of the MHM.

FIGS. 7A-J are of illustrations of various aspects of user interaction with the MHM in some embodiments of the MHM.

FIGS. 8A-E are of logic flow diagrams illustrating aspects of coordinated user management and management of affiliated entities in some embodiments of the MHM.

FIG. 9 is of a block diagram illustrating embodiments of the MHM controller.

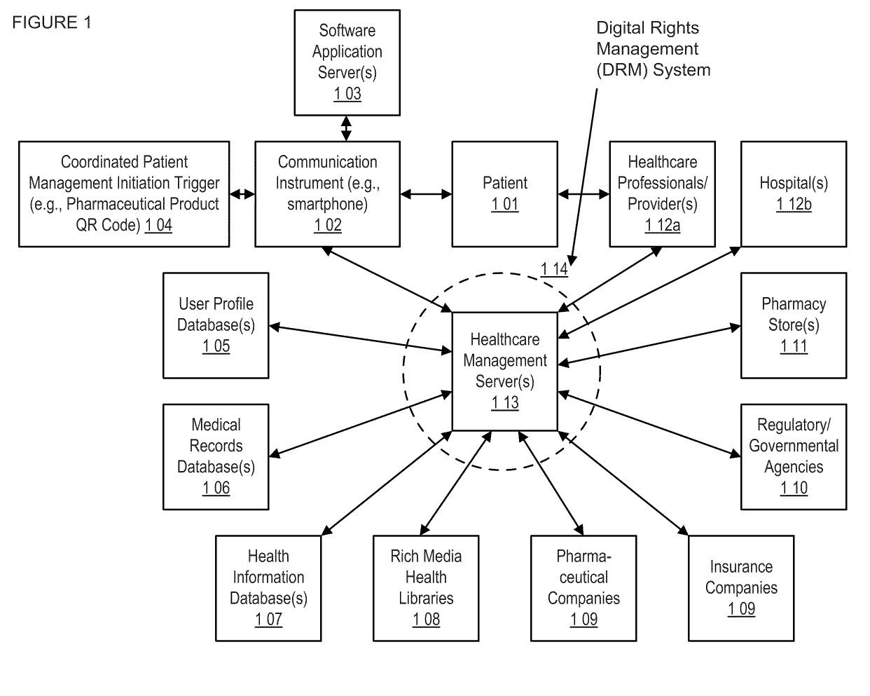

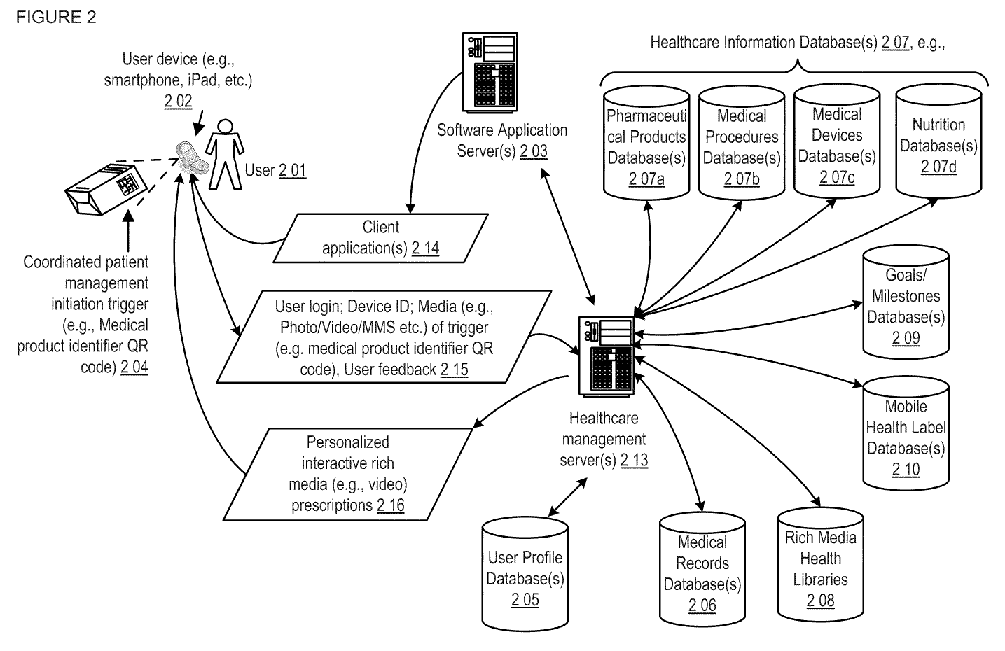

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### MHM

The efficacy of a treatment plan prescribed by a healthcare services provider may depend on the patient clearly understanding the medical information provided at diagnosis, and meticulously following any treatment plan prescribed by the qualified healthcare provider. The abilities and resources available to the various personnel, organizations and/or institutions participating in providing healthcare services to the patient may also be impacted by the post-diagnosis/prescription actions of the patient. In some implementations, the MHM may provide for improved Continuing Medical Instruction (hereinafter “CMI”) of a user following diagnosis of a medical condition of the user and/or prescription of a treatment plan for the user. For example, in some implementations, the MHM may allow a user to submit a request for information related to a medical product, healthcare device, medical procedure, nutritional diet and/or the like, and provide in response rich media presentations and/or interactive CMI tutorials detailing information tailored to the specific request and user profile. In some implementations, the MHM may utilize various Customer Relationship Management (hereinafter “CRM”) solutions to improve a user's post-diagnosis/prescription healthcare management experience. For example, the MHM may provide the tutorials in a format that is sensitive to the specific regional and cultural requirements and characteristics associated with the user. In some implementations, the MHM may enable a user to submit information via a mobile device and receive CMI tutorials in response on the same device and/or alternate device(s). In some implementations, the MHM may utilize information unique to a mobile user, such as language settings on a mobile device, personal profile information, user location as obtained via a Global Positioning System (GPS) and/or the like, in tailoring the CMI tutorial experience to match the needs to the user. In some implementations, the MHM may provide patient adherence programs, e.g., automatically populate a calendar of the user with information related to important dates, timelines, events, meetings, appointments and/or reminders to perform certain actions, provide newsfeeds/subscriptions/brochures etc. to the user on topics of relevance to the user, re-fill prescription medications for the user, process shipment of medications for the user and/or the like, to facilitate easy following of prescribed treatment plans by the user.

The MHM may ensure that patient reported outcomes (e.g., a questionnaire completed by the patient/interviewer of the patient, hereinafter “PRO-Feedback”) and/or other feedback from the user are received in required situations. For example, the MHM may ensure that user feedback is obtained certifying that the user has fully studied the relevant medical information and has understood the consequences of following and/or not following the prescribed course of treatment. In some implementations, feedback from a user may be utilized in order to ensure the user receives coverage of medical costs under an insurance plan. For example, on a video enabled-mobile device such as the iPhone 4, a user may state “I understand that I should take the prescribed medicine twice a day,” which may be captured and provided to health care professionals for review of understanding. The MHM may aggregate and analyze user data, characteristics, CMI tutorial adoption, user interactive feedback, system usage, user behavior(s) and/or the like, and structure pay-for-performance incentives based on the intelligence for various entities participating in providing healthcare products and/or services for system users. For example, in some implementations, the user data may be statistically analyzed to determine advertising revenues based on the number of requests received for media/healthcare informationals/tutorials/content of a media/content provider, dissemination/adoption among the MHM user base of media/informational/tutorials/content of a media/content provider, and/or the like. In some implementations, feedback from users may be statistically analyzed to determine efficacy of a prescribed medication over a large sample population, to facilitate payment to a pharmaceutical company on a pay-for-performance plan. Alternate implementations of the MHM highlighting various other advantageous aspects are further discussed below.

### MHM Logic and Data Flows

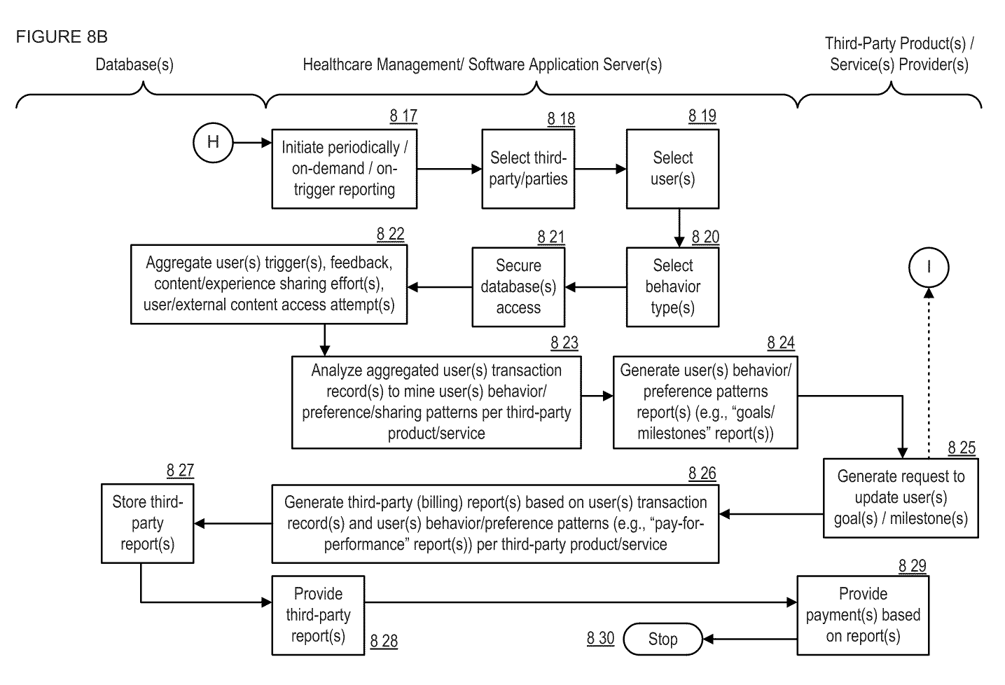

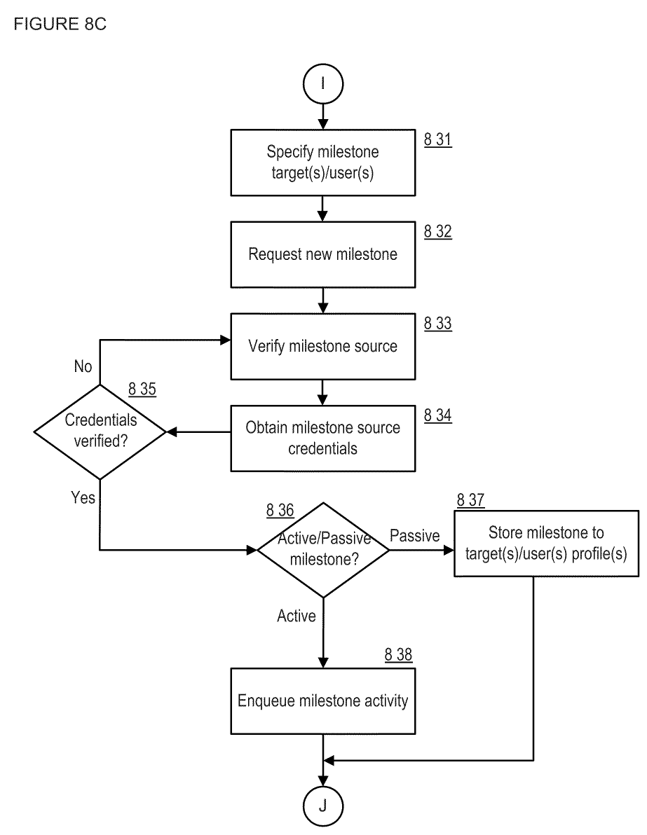

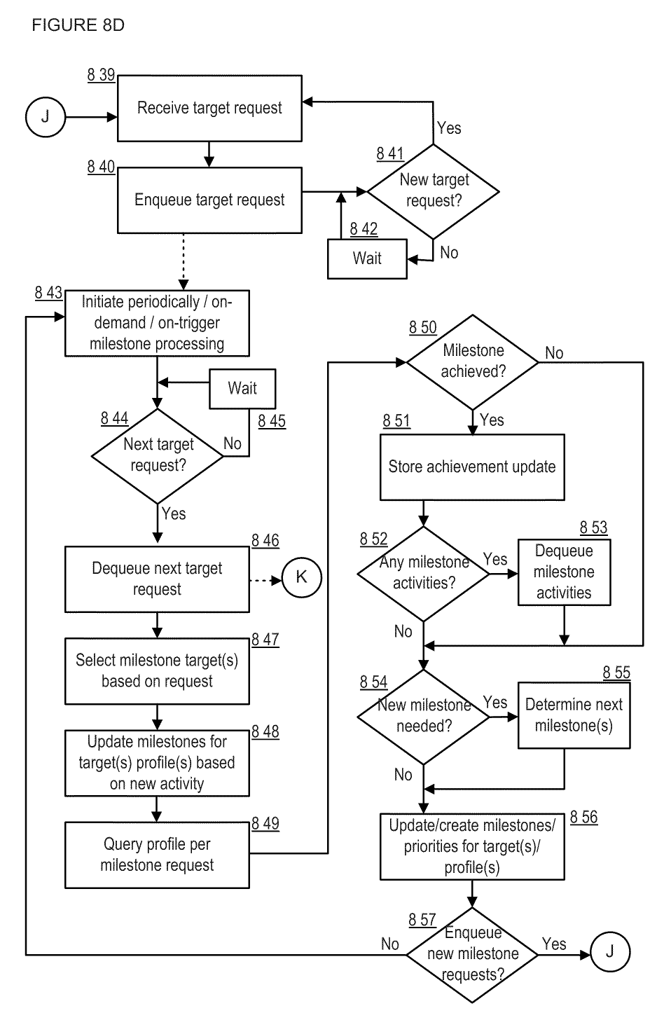

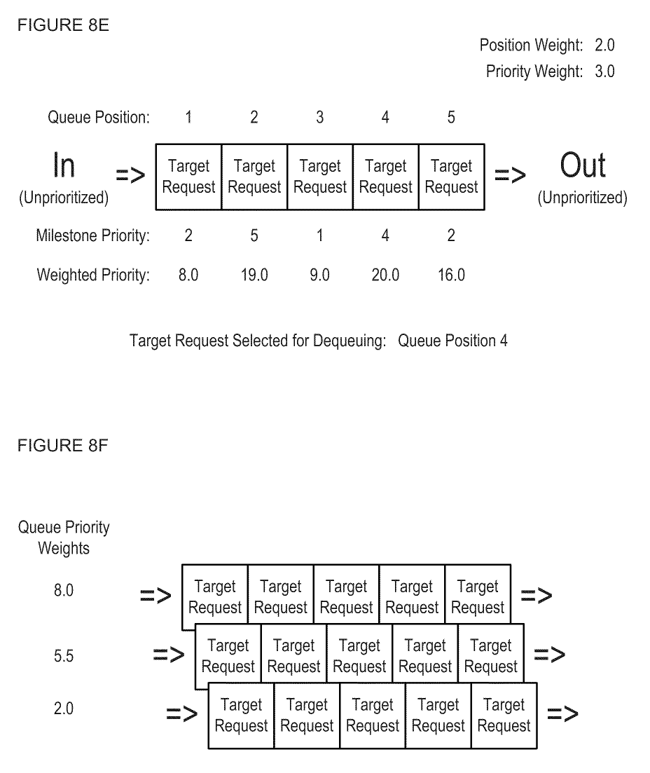

FIG. 1 is of a block diagram illustrating various Mobile Healthcare Manager (MHM) components and/or affiliated entities included in coordinated patient management in some embodiments of the MHM. A variety of other compositions and arrangements of MHM components and/or affiliated entities may be used in alternative embodiments of the MHM as is further discussed in FIG. 8.

In some implementations, healthcare management server(s) 113 may be configured to coordinate activities of various MHM components and/or affiliated entities (e.g., data vendors, databases, users, user devices, healthcare professionals/providers, hospitals, pharmacy stores, regulatory government agencies, national health systems, public health agencies, insurance companies, pharmaceutical companies etc.) to provide coordinated patient management services for a user 101. The various MHM components and/or affiliated entities may communicate with each other via one or more communications networks. User 101 may utilize communication instrument(s) 102 to interact with the healthcare management server(s). The communication instrument(s) may comprise hardware and/or software components to facilitate capture of various types of data. In some implementations, the communication instrument(s) may download and/or install application software from software application server(s) 103; in some embodiments, the application server 103 may be incorporated into the healthcare management servers 113. The application software may be configured to facilitate the communication instrument(s) to perform various tasks, including, but not limited to, capturing media (e.g., text, symbols, data files, audio, video, camera images, screenshots/screen grabs etc.), providing user interactive experiences (e.g., graphical user interface(s), command line interfaces etc.), performing computations/analyses on user-related data, communication/synchronizing data between the communication instrument and the healthcare management server(s) and/or other MHM components and/or affiliated entities, and/or the like.

In some implementations, the communication instrument(s) and/or application software may facilitate capturing and providing media to the healthcare management server(s), wherein receipt of the media at the healthcare management server(s) may trigger the healthcare management server(s) to facilitate coordinated patient management activities in conjunction with the MHM components and/or affiliated entities. In some implementations, the media may embody information captured from sources including, but not limited to, a medical product container, product sample packet, shelf talker, brochure, flyer, poster, outdoor/indoor banner/advertisement, website, display monitor, voice recordings, live conversations, audio playback, and/or the like. The media may embody information related to an object about which it may be desired to educate users, and may be provided by one or more media/content providers. For example, in some implementations, the user may wish to receive (or the MHM components and/or affiliated entities may wish to provide for the user) information regarding a product, procedure, device, medical condition, lifestyle choice/habit, nutrition diet and/or other like object of information.

The user may capture media embodying information about the object using the communication instrument(s) and/or application software. For example, the user may utilize a smartphone as a communication instrument, wherein the smartphone may be equipped with a camera. In such an example, the smartphone camera may be utilized to capture media (e.g., picture and/or video) embodying information about a coordinated patient management initiation trigger 104 identifying the object including, but not limited to, a barcode, verification tag (or v-tag), QR Code®, dot matrix code, product label and/or the like. Alternate coordinated patient management initiation triggers including, but not limited to, a biometric user identifier (e.g., fingerprint, retinal scan etc.), radio-frequency identification (RFID) tag, user request communication, and/or the like, may be used in conjunction with appropriate media-capturing hardware and/or software to capture the information identifying the object from the coordinated patient management initiation trigger using the communication instrument(s).

In some implementations, the healthcare management server(s) may obtain the media embodying information identifying the object from the communication instrument(s) along with an identifier for the user (e.g., user name, user ID etc.) and/or communication instrument(s) (e.g., Internet Protocol (IP) address, Media Access Control (MAC) address, device name, device ID etc.). The healthcare management server(s) may utilize the user and/or instrument identifier to obtain a record of the user's medical history from a medical records database 106. In some implementations, the healthcare management server 113 may access the medical records database 106 located on a remote computer. In some implementations, the medical records database 106 may be available in a local storage of the healthcare management server 113. The patient's medical history may comprise information including, but not limited to, prior medical conditions, known allergies, risk factors, current prescriptions, accident history, vaccination history, PRO-Feedback/feedback from the patient regarding the effectiveness of prior medications, and/or the like. In some implementations, digital rights management control (including control of access rights and data flow paths) may be incorporated to protect the privacy of the patient profiles and medical history information, in accordance with regulatory standards such as the Health Insurance Portability and Accountability Act (HIPAA).

In some implementations, the healthcare management server(s) may also access health information database(s) 107. The health information database(s) may include information related to at least pharmaceutical prescription/generic/over-the-counter products, medical procedures, medical devices, diets and nutrition, and/or the like. For example, the health information database(s) may comprise information including, but not limited to, currently available drugs, compatibility information of a drug with other drugs, side effects, risk factors for products, procedures and dietary regimens, clinical study data, analytics based on feedback regarding the medications from MHM patient users, and/or the like. In some implementations, the healthcare management server may access the health information database(s) located on a remote computer via a computer network, such as a local area network, the Internet, and/or the like. In some implementations, the health information database(s) may be available in a local storage of the healthcare management server(s).

In some implementations, the healthcare management server(s) may have access to a set of rich media health libraries 108. The rich media health libraries 108 may comprise a large collection of static, rich media, interactive presentations, newsfeeds, informational, subscriptions and/or tutorials related to a large collection of medical conditions, products, services and/or other information applied to wide variety of patient types. In some implementations, the healthcare management server(s) may utilize the information obtained from the media obtained from the user's communication instrument(s), the patient medical records database(s), and the health information database(s) to determine media content from the rich media health libraries to provide for the user. In some implementations, the healthcare management server(s) may provide the media to the communication instrument(s) from which the media embodying information about the coordinated patient management initiation trigger was obtained. In providing coordinated patient management services for the user 101, the healthcare management server may, in some implementations, access user profile database(s) 105 to determine the appropriate media content and/or format to provide for the user 101. In some implementations, the user profile database(s) may comprise information including, but not limited to, username, address, contact information, language preference, identified characteristics and/or risk factors, cultural preferences such as cuisine and/or the like, gender, age, weight, preferred healthcare provider, health insurance provider, and pharmacy, store and/or the like. The healthcare management server 113 may utilize the information from the user profiles database(s) 105 to determine the preferences of the user, and deliver the content to the patient in a format that is appropriate in view of the user profile information. The healthcare management server may, in some implementations, also utilize global positioning system (GPS) information, if the communication instrument(s) is determined to be a mobile device, in addition to information from the user profiles database 105 in determining the content and/or format of the provided rich media.

In some implementations, the healthcare management server(s) may determine that the rich media to be presented to the patient requires that the user provide PRO-Feedback and/or other forms of feedback. This feedback may be utilized as acknowledgments from the user 101 that the content in the provided media was received, viewed, and/or understood by the user.

In some implementations, the feedback may take the form of answers to a questionnaire which test the knowledge of the user 101 after presentation of the media to the patient 101. The feedback may also take the form of response to survey questions designed to evaluate the condition of the user 101, and/or the user's opinion on the effectiveness of current treatment. In some implementations, the MHM may provide the user with one or more portable interactive patient diaries and integrated case report forms. For example, the healthcare management server(s) may periodically request the user to provide PRO-Feedback, journal/diary entries, engage in video/audio/text chat with a representative and/or artificial intelligence (AI) expert system and/or the like.

The feedback may, in some implementations, be utilized as acknowledgment that the user 101 administered the prescribed dosage of the required treatment option. For example, this may be accomplished by having the user 101 send a picture of the product code as proof that the treatment option was accessed. In another example, on a video enabled-mobile device such as the iPhone 4, a user may state, “I understand that I should take (have taken) the prescribed medicine twice a day,” which may be captured and provided to health care professionals for review of understanding and compliance. In some implementations, the survey may be designed so that the user provides feedback that indicates the wellness of the user, symptoms exhibited by the user, healing trajectory, and/or the like. In some implementations, the feedback may take the form of pictures/video of the injury area and/or any areas exhibiting side effects, acquired using the user's communication instrument(s) 102. In alternate implementations, the feedback requested may take the form of data acquired from medical diagnostic instruments, including, but not limited to, heart monitors, blood glucose level monitors, weighing scale and/or the like. For example, incorporating LifeScan's glucose meter data interchange or LifeCase and LifeApp System with an iPhone may provide a data import conduit. In some implementations, the user may be required to provide pictures of the user's meals, prescriptions medications, over-the-counter medications and/or other health supplements that the user may be consuming. The feedback information may also include, in some implementations, calendar data indicating the user's exercise regimen. The feedback may be subsequently used to determine the times at which further feedback is requested. For example, in some implementations, the feedback may be periodically requested to coincide with the times included in the exercise regimen calendar data. This information may be compared against prior survey data stored in the medical records database(s) 106 to provide an indicator of the progress of the user. The use of feedback from the user may be used in various other ways, of which several non-limiting illustrative examples are further discussed.

In some implementations, the MHM may provide patient adherence programs. For example, the MHM may be configured such that event reminders corresponding to actions the user should undertake as recommended by the MHM′ coordinated patient management may be populated automatically into a calendar application included in at least one communication instrument(s) of the user. In one embodiment, iCalendar (*.ics) formatted files may be sent to the user via email, messages, file sharing, etc. for automatic calendar population. The inclusion of event reminders may facilitate the user's efforts to meticulously adhere to treatment plans prescribed by the user's healthcare professional(s)/provider(s) 112a and/or hospital(s) 112b. In some implementations, the MHM may be configured to automatically re-fill a user's prescriptions (e.g., periodically/upon providing PRO-Feedback and/or other user feedback, etc.) and/or process shipment of user prescriptions to facilitate the user's efforts to meticulously adhere to the prescribed treatment plans. In some implementations, a physician may provide a video prescription that includes tutorial, compliance and/or CMI information and/or survey requirements, wherein in the user must consume and/or understand the tutorial/compliance/CMI information to be in compliance with the physician's prescription and/or obtain compensation/reimbursement from their employer/insurer. For example, the physician may provide an iCalendar (*.ics) file including patient adherence program appointments, the appointments including hyperlinks to, e.g., interactive Flash/HTML5 video prescriptions, HTML survey forms, and/or the like. An exemplary listing of an iCalendar (*.ics) file illustrating substantive aspects of providing a patient adherence program appointment reminder including a hyperlink for a video prescription is provided below:

BEGIN:VCALENDAR
METHOD:PUBLISH
VERSION:2.0
X-WR-CALNAME:Personal
PRODID:-//Apple Inc.//iCal 4.0.2//EN
X-APPLE-CALENDAR-COLOR:#0252D4
X-WR-TIMEZONE:America/New_York
CALSCALE:GREGORIAN
BEGIN:VTIMEZONE
TZID:America/New_York
BEGIN:DAYLIGHT
TZOFFSETFROM:-0500
RRULE:FREQ=YEARLY;BYMONTH=3;BYDAY=2SU
DTSTART:20070311T020000
TZNAME:EDT
TZOFFSETTO:-0400
END:DAYLIGHT
BEGIN:STANDARD
TZOFFSETFROM:-0400
RRULE:FREQ=YEARLY;BYMONTH=11;BYDAY=1SU
DTSTART:20071104T020000
TZNAME:EST
TZOFFSETTO:-0500
END:STANDARD
END:VTIMEZONE
BEGIN:VEVENT
CREATED:20100615T075253Z
UID:1B5F34E0-22C9-46ED-91B7-6EF32F6B078E
DTEND;TZID=America/New_York:20100615T170000
RRULE:FREQ=WEEKLY;INTERVAL=1;UNTIL=20100817T035959Z
TRANSP:OPAQUE
SUMMARY:MHM Tutorial
DTSTART;TZID=America/New_York:20100615T160000
DTSTAMP:20100615T080229Z
LOCATION:Online Physician
SEQUENCE:10
URL;VALUE=URI:www.mhm.com/watch?v=a9Bg12T&resource=secured
BEGIN:VALARM
X-WR-ALARMUID:17AF157C-B3AE-41FB-9A5C-4A3644E007AD
TRIGGER:-PT5M
DESCRIPTION:Event reminder
ACTION:DISPLAY
END:VALARM
END:VEVENT
END:VCALENDAR

Upon obtaining feedback from the patient, the patient may be required to access the secured resource associated with the hyperlink to authenticate that the patient consumed the provided tutorial. The patient may also be required to provide PRO Feedback and/or other forms of feedback (e.g., via the video prescription object, HTML form, etc.) to validate that the user understood the tutorial/compliance/CMI information to be in compliance with the physician's prescription. Upon obtaining sufficient user feedback, the MHM may provide the physician's prescription via communications sessions created when the user accessed the hyperlink to the secured resource. For example, the MHM may provide the prescription as an XML data file. An exemplary XML data file illustrating substantive aspects of providing a physician's prescription is provided below:

```
<?XML version = “1.0” encoding = “UTF-8”?>
<mhm_prescription>
        <timestamp>2010-06-15 09:23:47</timestamp>
        <patient>
            <name>John Q. Public</name>
            <mhm_id>838-557-1095</mhm_id>
            <medicine>
                <treating>Diabetes - Type II</treating>
                <name>Metformin<name>
                <dose>500mg bid pc<dose>
                <quantity>30<quantity>
                <refills>2<refills>
            </medicine>
        </patient>
        <physician>
            <name>Mary A. Prescribor, M.D.</name>
            <mhm_id>A3F78B2E</mhm_id>
            <md5_auth>258bcfe7a676f34b3dc55a76cacc6104</
            md5_auth>
        </physician>
</mhm_prescription>
```

Such procedures may provide an elegant, consistent and authentic multimedia interactive reference standard to maximize personal understanding of health information and coach individuals toward better health outcomes. In some implementations, the user may be signed up, automatically, or with explicit permission from the patient, to receive event notifications, reminders and/or the like from the healthcare management server(s) 113. These event notifications/reminders may, in various implementations, take the form of postal mail messages, electronic mail messages, SMS messages, MMS messages, automated phone calls and/or the like. These may, for example, also include notification of and/or participation in health tracking scores, contests, promotions, and/or lottery draws for users who maintain a sufficiently high standard of adherence to their treatment prescriptions.

The healthcare management server(s) may also include interfaces to various personnel, organizations and/or institutions involved in providing coordinated patient management products and/or services for the user. In some implementations, the healthcare management server(s) 113 may be disposed in communication with the patient's healthcare provider(s)/professional(s)/hospital(s), the patient's preferred pharmacy store(s) 111 (e.g., as determined from the user profile database(s) 105), the user's healthcare insurance company 109, regulatory/governmental agencies 110 and/or like organizations/institutions/individuals. The MHM components and/or various affiliated entities may coordinate their activities in order to provide credits and/or other financial incentives to the user 101. In some implementations, the healthcare management server 113 may be disposed in communication with other individuals, entities, organization or institutions that may have a financial or other interest in the healthcare management of the user 101.

In some implementations, the healthcare management system may be configured so that the financial/service obligations of the third-party participants (e.g., pharmacy, insurance company, healthcare professional/provider/hospital etc.) may only be triggered upon the user acknowledging receipt of the rich media content via the healthcare management server(s) specific to the coordinated patient management initiation trigger and/or user. In some implementations, the financial obligations of the third-party participants may only be triggered upon the user's feedback satisfying specified minimum requirements. For example, the user may be required to answer a series of questions related to the user's understanding of the information in the content provided from the rich media health libraries. If the user provides feedback that is deemed satisfactory according to a set of pre-defined rules related to the content, appropriate notifications may be provided to the interested third-party participants. By way of non-limiting example, if the user demonstrates that the user has received and understood all the medical information associated with the user's medical condition and the specific prescription treatment plan, and/or signed on to receive notifications from the healthcare management server to ensure that the user adheres meticulously to the treatment plan, the insurance provider for the user may be notified to cover the treatment costs and/or provide insurance co-pay/reimbursements/coupons etc. for the user, and/or the pharmacy store(s) 111 may be notified to re-fill and/or deliver the required treatment to the user 101. In some implementations, if the feedback from the user indicates that the treatment plan has been working successfully, the insurance company may be served notification to compensate the healthcare professional(s), provider(s), hospital(s) and/or the like for products and/or services rendered. Such implementations may allow a “pay-for-performance” model to develop wherein the various interested entities may be compensated for product(s) and/or service(s) rendered on the basis of meritorious performance. It is to be understood that various other implementations that may be performed are contemplated whereby the incentives for each interested party (e.g., patient, healthcare professional, insurer, etc.) may be structured in order to alter the behavior of the interested parties in order to improve the efficiency of the healthcare system.

In some implementations, the user prescription data, feedback on the user's progress, medical records history, user profile and/or the like, may be utilized to perform analysis to determine statistical trends. The subject of the statistical analyses may include studies on how many times user(s) requested (e.g., by scanning a QR code) media/informational/tutorials/content specific to a media/content/tutorial provider, user behavior in response to provided rich media content, established incentives structures and/or treatments, quality of work product of healthcare providers and professionals, and/or the like. The results of such studies can be utilized, in some implementations for example, by regulatory/governmental oversight agencies 110 charged with ensuring quality standards in the healthcare profession. Some implementations may utilize the results of analysis of user response to optimize incentive structures in the system to achieve greater efficiencies in the healthcare marketplace. Some implementations may utilize the results of analysis of patient response to various treatments to determine physiological, emotional and/or psychological responses to specific treatment options. Such implementations may yield analytical information that is qualitatively and quantitatively superior to drug screening clinical trials utilizing a small sample of test subjects. For example, users may be requested to opt-in to a program whereby their information may be combined into a large pool of subjects obtained from the customer base of a pharmaceutical/insurance company. In some implementations, the healthcare management server(s) 113 may be configured to perform independent testing while ensuring the privacy of patient information. The overall result of the analysis may be transmitted to interested coordinated patient management participants.

FIG. 2 is of a data flow diagram illustrating aspects of coordinated user management in some embodiments of the MHM. In some implementations, user 201 may request to register user device 202 with the MHM. In response, the MHM may provide client applications 214 for the user device via software application server(s) 203 and register the device with the MHM. In some implementations, user device 202 may perform installation procedures in order to install and register some of the provided client applications 214 on the user device, e.g., obtaining the application via the iTunes App store, the Android application marketplace, and/or the like. The user device and/or software applications may together facilitate capturing media embodying information about a coordinated patient management initiation trigger 204. The user device may transmit 215 the capture media with user identification/login credentials and/or device identification to healthcare management server(s) 213. Upon receiving the transmitted media captured by the user device, the healthcare management server(s) may initiate coordination of the MHM components and/or various entities involved to provide coordinated patient management for the user. In some implementations, the healthcare management server(s) may authenticate the user and/or device prior to initiating coordinated patient management. Upon authentication, the healthcare management server(s) may utilize the user and/or device identification details to secure access rights to user profile database(s) 205. For example, the healthcare management server may be executing a hypertext preprocessor (“PHP”) script including commands in Structured Query Language (SQL) to communicate with a relational database. The PHP script of the healthcare management server(s) may utilize user and/or device identification details in the SQL commands to obtain access to the database. An example PHP/SQL command illustrating substantive aspects of using user and/or device authentication details to obtain access to a database is provided below:

function UserProfile($DBserver, $userid, $password) {
mysql_connect($DBserver, $userid, $password); // access database server
mysql_select_db(“Table.SQL”); // select database to search
}

The healthcare management server(s) may query the user profile database using user and/or device identification and obtain user preferences based on the query. In some implementations, the healthcare management server(s) may utilize the user identification details to secure access rights to medical records database(s) 206, and obtain medical history record(s) for the user based on querying the medical records database(s) using the user identification details. In some implementations, the healthcare management server(s) may secure access rights to mobile health label (MHLabel) database(s) 210, which may store information on correlating coordinated patient management initiation trigger(s) to healthcare information topics such as medical products, procedures, devices, diet and nutrition, and/or the like. The healthcare management server(s) may decode the coordinated patient management initiation trigger from the media obtained from the user device using information stored in the MHLabel database(s). In some implementations, the decoding of the coordinated patient management initiation trigger by the healthcare management server(s) in conjunction with the MHLabel database(s) may yield a name of a healthcare information topic (e.g., a medical device, procedure, nutrition diet etc.) related to which interactive rich media content may be provided for the user. In some implementations, the healthcare management server(s) may use the results of the process of decoding the coordinated patient management initiation trigger to query one or more healthcare information database(s) 207 including, but not limited to, pharmaceutical products, medical procedures, medical devices, diets and nutrition database(s) and/or the like. Upon receiving the search query, the healthcare information database(s) may return results including detailed information on aspects of the healthcare information topic submitted as the search query.

In some implementations, the healthcare management server(s) may perform all of the above search queries, and thereby obtain user preferences, medical history record(s), names of healthcare information topics appropriate for the user, and detailed information related to the named healthcare information topics. In some implementations, the healthcare management server(s) may secure access to rich media health libraries 208. The healthcare management server(s) may query the rich media health libraries using as search terms any combination of user preferences, medical history record(s) information, names of healthcare information topics, and/or information on aspects of the healthcare information topics. The rich media health libraries may store a large collection of static, rich media, interactive presentations, informationals and/or tutorials related to a large collection of medical conditions, products, services and/or other information applied to wide variety of patient types. In response to a submitted multi-dimensional search query, the rich media health libraries may return one or more personalized interactive rich media prescription 216 objects (e.g. audio, images, video, interactive content etc.) selected from its libraries to provide for the user, based on the user preferences, medical history record(s) information, names of healthcare information topics, and/or information on aspects of the healthcare information topics.

In some implementations, the healthcare management server(s) may provide such personalized interactive rich media prescriptions 216 to the user device. The user device, operating in conjunction with the client applications 214, may display the personalized interactive rich media prescription objects (hereinafter “media prescriptions”) to the user. In some implementations, the media prescriptions may require the user to provide PRO-Feedback and/or other forms of user feedback 215 by methods including, but not limited to, activating (e.g., clicking, checking boxes, touch-sensitive screen elements, etc.) user interface elements, typing text, speaking, recording images and/or videos, providing streaming video, and/or the like. The user may provide such forms of feedback, which may be provided to the healthcare management server(s).

The healthcare management server(s) may determine whether the feedback provided by the user is sufficient or not. In some implementations, the healthcare management server(s) may secure access to goals/milestones database(s) 209. The goals/milestones database(s) may store information on personalized goals for the user, and milestones the user may need to complete along with path to achieving the goals personalized for the user. The healthcare management server(s) may query the goals/milestones database using the user and/or device identification information, and obtain goals and/or milestones specific to the user and/or device. The healthcare management server(s) may compare the feedback provided by the user with the goals/milestones to determine whether further feedback is required to be provided by the user. In some implementations, the user may repeatedly provide feedback to the media prescriptions until the healthcare management server(s) determines that the user has achieved the required milestones/goals related to the provided media prescriptions. Upon the user achieving the required goals/milestones, the healthcare management server(s) may operate in conjunction with the other MHM components and/or various entities involved in providing coordinated patient management to update the goals/milestones for the user in the goals/milestones database(s)

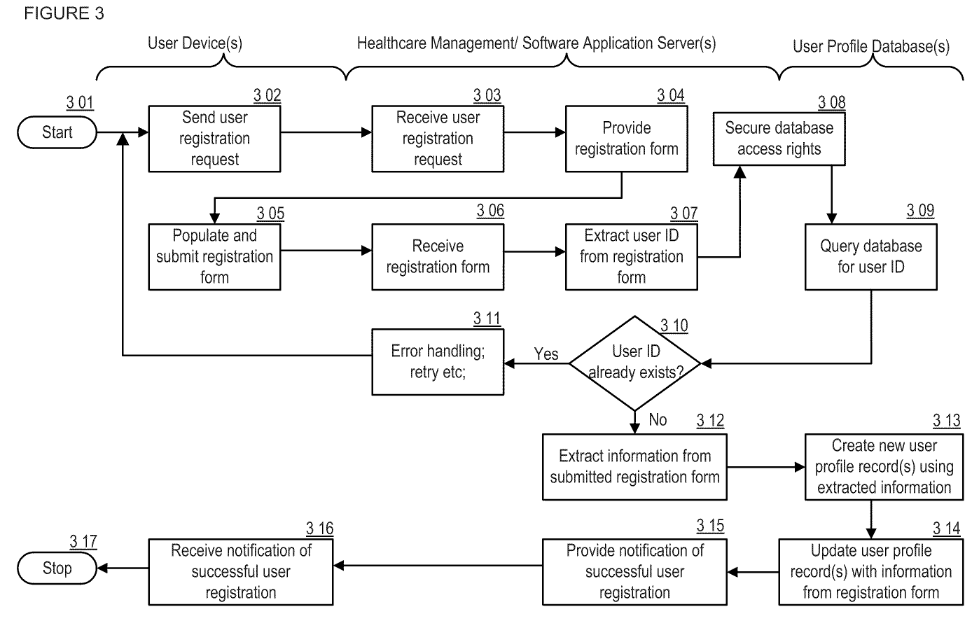

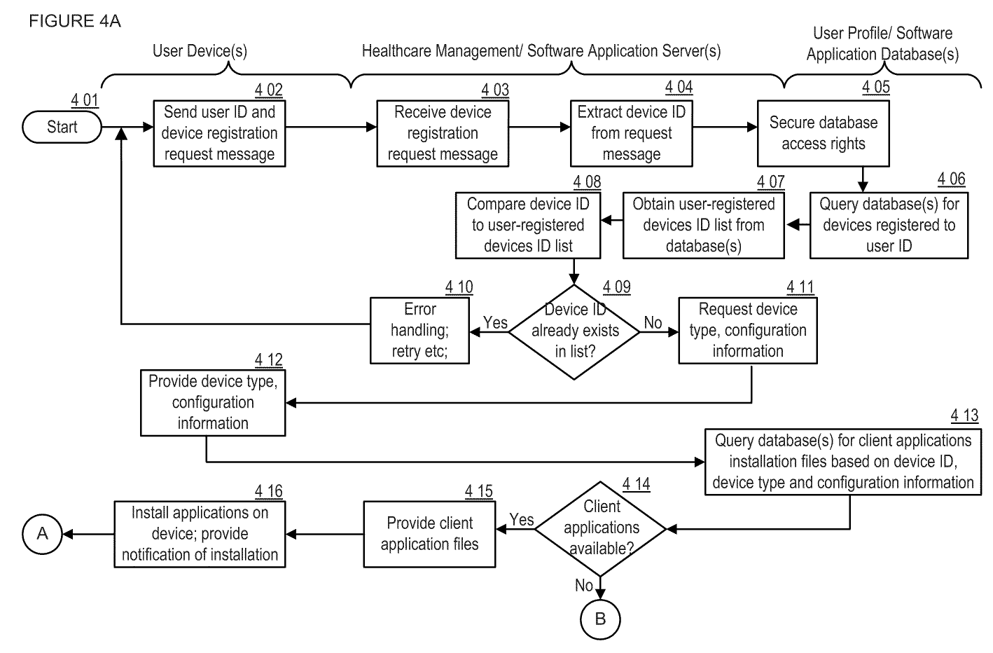

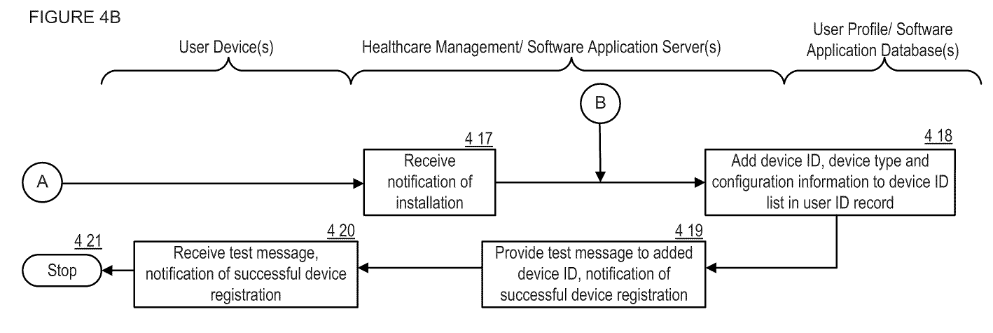

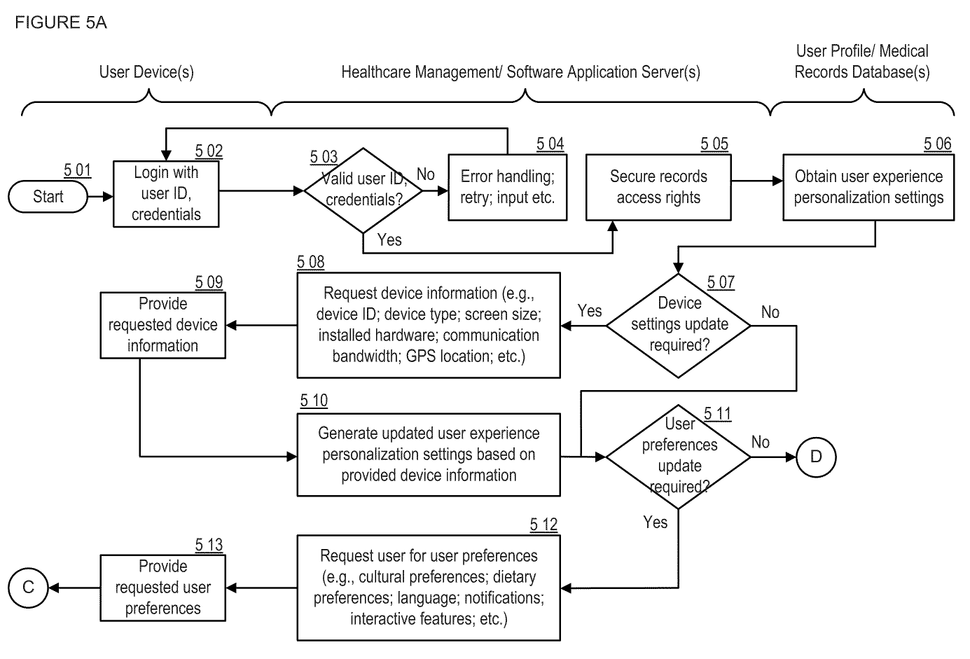

FIG. 3 is of a logic flow diagram illustrating aspects of user management in some embodiments of the MHM. In some implementations, a new user may wish to register for coordinated patient management services offered by the MHM. The user may provide a user registration request 302 to the healthcare management server(s). For example, the user device may run a browser application within the operating system environment of the device. The user device may use a HTTP(S) POST message to provide the request to the healthcare management server(s). A non-limiting example of a program listing illustrating substantive aspects of providing such a request, written substantially in the form of HTML, is provided below:

<HTML>
<FORM action=“https://wwww.MHM.com/cgi-bin/register”
method=“post”>
<LABEL for=“firstname”>First name: </LABEL>
<INPUT type=“text” id=“firstname”><BR>
<LABEL for=“lastname”>Last name: </LABEL>
<INPUT type=“text” id=“lastname”><BR>
<INPUT type=“radio” name=“sex” value=“Male”> Male<BR>
<INPUT type=“radio” name=“sex” value=“Female”> Female<BR>
<INPUT type=“submit” value=“Send”> <INPUT type=“reset”></P>
</FORM>
</HTML>

The healthcare management server(s), upon receiving 303 the request from the user, may provide a registration form 304 for the user to complete. For example, the healthcare management server(s) may provide an HTML web page to the browser running on the user device with HTML INPUT fields that the user may complete prior to submitting the registration form. The user may populate and submit 305 the provided registration form. In some implementations, the registration form may comprise input fields including, but not limited to, user ID, first name, last name, social security number, address, age, gender, date of birth, insurance provider, healthcare professional, healthcare provider, preferred hospital, and/or the like. The registration form may be transmitted using secure encrypted communication protocols such as secure HTTP(S), secure sockets layer (SSL), and/or the like. The healthcare management server(s) may receive the registration form provided by the user, and extract the provided user ID 307 and/or other identification details from the registration from. Upon extracting the identification information, the healthcare management server(s) may secure access rights to the user profile database(s), and query the database using the user ID and/or other identification information. For example, the healthcare management server(s) may be executing hypertext preprocessor (PHP) script(s), and may interface using Structured Query Language (SQL) commands with relational database management system (RDBMS) database(s). A non-limiting example of a PHP command is provided below that illustrates substantive aspects of securing access to a remote database using a username and password, building a search query based on a user's provided user ID and social security number, querying the database based on the built search query, and returning the result of the search query as output:

function UserProfile($userid, $ssn, $DBserver, $password) {
mysql_connect(“201.408.185.132”,$DBserver,$password);
// access database server
mysql_select_db(“UserProfile.SQL”); // select database to search
$query = “SELECT userid ssn FROM ProfilesTable WHERE userid
LIKE ‘%’ $userid OR ssn LIKE ‘%’ $ssn; // create query for a profile
in the ProfilesTable table with ‘userid’ and ‘ssn’ as search terms
$result = mysql_query($query); // perform the search query
mysql_close(“UserProfile.SQL”); // close database access
return $result; // return search result
}

The healthcare management server(s) may analyze the results of the search query returned by the user profile database(s). If a profile already exists for the user in the user profile database(s), the healthcare management server(s) may return an error message 311 to the user device indicating that a profile already exists, and, in some implementations, may provide the user a method to retry registration. In some implementations, if the user profile is not found in the user profile database, the healthcare management server(s) may proceed to create a user profile for the now-determined new user. The healthcare management server(s) may extract user information from the user-submitted registration form 312, create a new user profile in the database using the extracted information 313, and populate the fields of the record for the user profile in the user profile database 314 with the information extracted from the submitted user registration form. For example, a non-limiting example PHP/SQL command illustrating substantive aspects of creating a new user profile in the database using the extracted information and populating the fields of the record for the user profile in the user profile database is provided below:

mysql_connect(″UserProfile.SQL″);) // connect to database
mysql_query(“INSERT INTO ProfilesTable (firstname, lastname, ssn,
dob, gender)
VALUES (‘Jane’, ‘Doe’, ‘123-45-6789’, ‘04-01-1974’, female’)”);
// add user
mysql_close(″UserProfile.SQL″); // close connection to database

The healthcare management server(s) may provide a notification 315 to the user device upon successful addition of a user record for the user in the user profile database(s) that the user has been successfully registered 316 within the MHM.

FIGS. 4A-B are of logic flow diagrams illustrating aspects of device management in some embodiments of the MHM. In some implementations, the user may wish to register one or more user devices with the MHM to provide the user interface with the MHM for coordinated patient management. The user may provide a request for device registration 402 along with a user ID identifying the user. Upon receiving the device registration request message 403, the healthcare management server(s) may extract the device ID 404 from the request message. The device ID may be any identifier that identifies the device, including but not limited to, Media Access Control (MAC) address, Internet Protocol (IP) address, machine name, Uniform/Universal Resource Locator (URL) address associated with the device, and/or the like. In some implementations, a device ID identifying the user device may be explicitly included in the user device registration request message provided by the user. In alternate implementations, the device ID may be extracted based on analyzing message headers and/or other metadata including in the user device registration request message provided by the user. Upon extracting the device ID from the user device registration request message, the healthcare management server(s) may secure access to the user profile database(s) 405, and query the user record of the user in the user profile database for devices registered to the user 406. The user profile database(s) may return a list of devices registered to the user 407. The healthcare management server(s) may compare 408 the device ID of the device extracted from the user device registration request message to the list of registered devices obtained from the user profile database(s). If the device ID is already present in the list of registered device, the healthcare management server(s) may return an error message 311 to the user device indicating that a user device has already been registered, and, in some implementations, may provide the user a method to retry user device registration. In some implementations, if the user device ID is not found among the list of device IDs registered to the user in the user profile database, the healthcare management server(s) may request device type and configuration information 411 from the user, including but not limited to, device type, device name, hardware configuration, connected peripherals, installed software, and/or the like. Upon receiving the request for further device information, the user device may respond 412, with or without the explicit knowledge of the user with the requested information.

The healthcare management server(s) and/or application software server(s) may analyze the received device type and configuration information and query 413 the software application database(s) for client application files that may be appropriate for providing to the user device. Upon receiving the results of the query to the software application, the software application server(s) determine if any client applications are available for the specific user device 414, and provide the client applications files for installation on the user device 415 if it is determined that client applications are available on the software application server(s) for the user device. For example, the software application servers may send, via a HTTP(S) POST message, a request that the user device establish a File Transfer Protocol (FTP) session with the application servers as a client to facilitate transfer of the required application files to the user device. In response to such a request, the user device may initiate a FTP(S) session, with the application server(s) acting as the server in the FTP session, and the user device acting as the client machine in the FTP transfer session. A non-limiting exemplary program listing written substantially in the form of FTP commands and illustrating substantive aspects of creating a FTP session, downloading application files onto the user device, and closing the FTP session is provided below:

ftp userID:password@appserver.MHM.com
get BlackberryOSAppFiles.tar.gz
close

Once the user device obtains the application files provided by the application server(s), the user device performs any installation and/or registration of software needed for the user device to interface with the MHM, and provide the healthcare management server(s) and/or application server(s) notification of successful installation of the application files 416. Upon receiving notification 417 of installation of the application filed on the user device, the healthcare management server(s) may add the device ID, device type information, configuration information, and information of application available on the user device to the user profile record in the user profile database(s) 418. The healthcare management server(s) may provide the user device a notification of successful registration 419, and may initiate a test session 419-420 to test the communication with the user device.

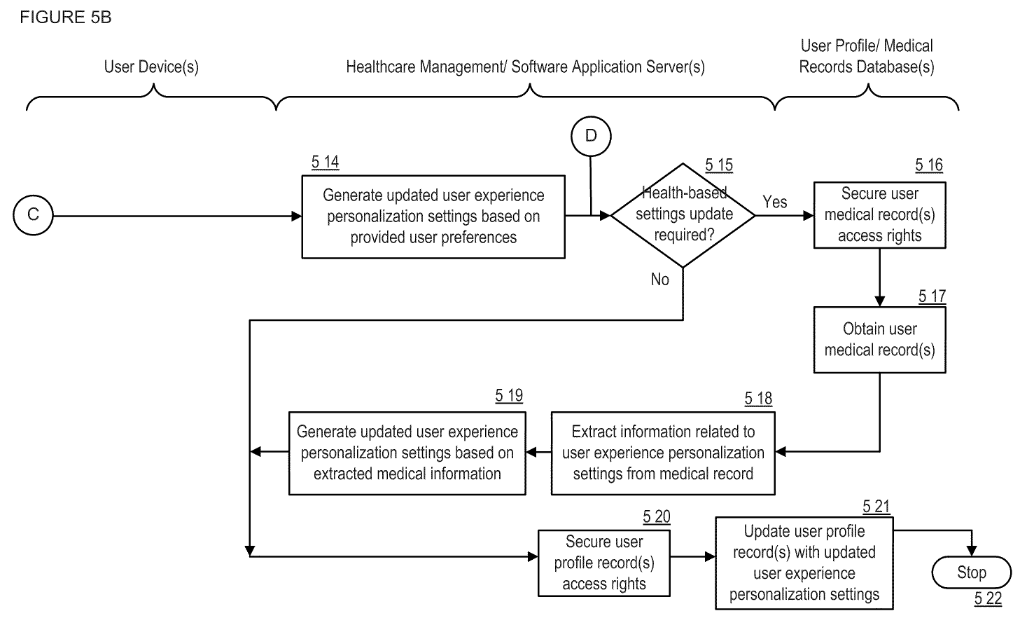

FIGS. 5A-B are of logic flow diagrams illustrating aspects of user experience management in some embodiments of the MHM. In some implementations, the healthcare management server(s) may provide interactive rich media prescriptions, with personalized user experience settings based on the preferences of the user and the configuration of the user device, as stored in the user profile database(s). In some implementations, a user accessing the MHM may attempt to login 502 by providing a user ID and password. The healthcare management server(s) may access and query the user profile database(s) to determine whether the user ID is valid 503. If the user ID does not exist in the user profile database(s), the healthcare management server(s) may provide an error response 504, and route the user device back to a login screen. If the user ID and password are verified, the healthcare management server(s) may secure access 505 to the user profile database(s) and obtain user experience personalization settings . For example, the healthcare management server(s) may utilize a server-side PHP script including SQL commands. A non-limiting example of a PHP/SQL command illustrating substantive aspects of obtaining user experience personalization settings from the user profile database is provided below:

mysql_connect(″UserProfile.SQL″);) // connect to database
// create a query to retrieve a user's preferred language, diet, device for
// communication, device resolution, media quality, and time of last
// settings update using the user ID to search the ProfilesTable table
// within the UserProfile.SQL database
$query = ″SELECT language diet deviceID resolution quality
lastupdate FROM ProfilesTable WHERE userid LIKE ‘%’ $userid”;
$result = mysql_query($query); // perform the search query
mysql_close(″UserProfile.SQL″); // close connection to database

Upon obtaining the user experience personalization settings for the user from the user profile database(s), the healthcare management server(s) may determine whether a device settings update needs to be performed 507. User device settings may include, but not be limited to, preferred device ID, screen resolution, refresh rate, listing of peripheral hardware included, listing of software installed on the device, toggle indicating if GPS is enabled for the device, operating system and version numbers, media formats, communication methods, and/or the like. In some implementations, the healthcare management server(s) may determine that an update needs to be performed based on how much time has elapsed since the last update to the device settings. In some implementations, the user may provide a request from a user device for device settings to be updated, by sending a request message including a device ID and device settings that are required to be changed, along with values for the device settings. For example, a browser may be running on the device, and the device may utilize an AJAX (asynchronous JavaScript and extended markup language (XML)) XMLHttpRequest message to pass the data variables and values to a server-side PHP script executing on the healthcare management server(s). A non-limiting example of a AJAX command illustrating substantive aspects of sending a device settings update message to a PHP server-side script is provided below:

<script type=″text/javascript″ language=″JavaScript″>
update = new XMLHttpRequest( );
userID=”janedoe”; // update settings for one of this user's devices
deviceID=”AA-B2-CF-F3_B0”; // update settings for this user device
resolution=”640×480”; // change the screen resolution to 640 × 480 pixels
// pass the variables and values to a device settings update PHP server
// script and get acknowledgment of the device settings update
update.open(″GET″,″http://users.MHM.com/devicesettingsupdate.-
php?userid=″+escape (userID)+″&device=″+escape(deviceID) +″&res=
″+escape(resolution), true);
update.onreadystatechange = useHttpResponse( ); //set up
acknowledgment receipt
update.send(null); // send the device settings update request to the server
function useHttpResponse( ) {
if (http.readyState == 4) {dat=http.responseText; document.write.dat;}
}
</script>

In this example, the server-side PHP script may use mySQL commands as discussed previously to update the device settings of the device ID associated with the user ID provided. In some implementations, the healthcare management server(s) may determine that a user device settings update is required based on metadata received from a user device (e.g., operating system version number and/or last update time, client applications version number and/or last update time, etc.) when the user sends a message to the MHM from the device. In some implementations, a combination of the above factors, and numerous other variants of user device settings update triggering may be utilized.

If the healthcare management server(s) determine that the device settings need to be updated, then the healthcare management server(s) may send a request 508 to the user device for information from the user and/or device towards performing the device settings update. The user and/or device (with or without the knowledge of the user) may respond to the request for device settings update information with a message including the requested information 509. Upon receiving the message including the requested information from the user and/or user device, the healthcare management server(s) may connect to the user profile database(s), and generate an updated record 510 associated with the user and/or device with the updated information provided by the user and/or device in response to the device settings update request.

In some implementations, the healthcare management server(s) may determine whether user preferences settings update needs to be performed 511. User preference settings may include, but not be limited to, preferred device ID, toggle indicating if GPS location sensing should be used, diet, language, media formats, inclusion in patient adherence programs, periodicity and/or timing of health reminders/communications, and/or the like. In some implementations, the healthcare management server(s) may determine that an update needs to be performed based on how much time has elapsed since the last update to the user preferences settings. In some implementations, the user may provide an explicit request for user preferences settings to be updated by sending a request including a user ID and user preferences settings that are required to be changed, along with values for the user preferences settings. In some implementations, the healthcare management server(s) may determine that a user device settings update is required based on keywords and/or metadata in messages received from the user, when the user sends a message to the MHM. In some implementations, the healthcare management server(s) may determine that an update to the user preferences settings is required based on the progress of the user towards their goals/milestones as stored in the goals/milestones database(s). For example, the MHM may obtain a goals/milestones XML data file stored in the database to analyze the user's progress. An exemplary XML data file illustrating substantive aspects of saving user goals/milestones is provided below:

```
<?XML version = “1.0” encoding = “UTF-8”?>
<user_id>johnpublic</user_id>
<ssn>832-77-6582</ssn>
<milestone>
        <name>diabetes_combat</name>
        <scale>short-term</scale>
        <type>active</type>
        <tutorial>www.mhm.com/watch?v=13ydsv2z&resource=
        secured</tutorial>
        <deadline>2010-05-01 23:59:59</deadline>
        <feedback>required</feedback>
        <priority>HIGH</priority>
        <adhere_type>iCalendar</adhere_type>
        <adhere_settings> www.mhm.com/adhere?id=johnpublic </
        adhere_settings>
</milestone>
```

For example, the healthcare management server(s) may secure access and obtain goals/milestones information from the goals/milestones database(s), and determine a rate of progress (e.g., number of milestones crossed per unit time) for the user. The user preferences settings may be made more demanding (e.g., more frequent reminders) if the number of milestones crossed per unit time is below a predetermined threshold. In some implementations, a combination of the above factors, and numerous other variants of user preferences settings update triggering may be utilized.

If the healthcare management server(s) determine that the user preferences settings need to be updated, then the healthcare management server(s) may send a request 512 to the user for information from the user towards performing the user preferences settings update. The user may respond to the request for user preferences settings update information with a message including the requested information 513. Upon receiving the message including the requested information from the user, the healthcare management server(s) may connect to the user profile database(s), and generate an updated record 514 associated with the user with the updated information provided by the user in response to the user preferences settings update request.

In some implementations, the healthcare management server(s) may determine whether user health-based user experience settings update needs to be performed 515. Health-based user preferences settings may include, but not be limited to, sensitivities (e.g., obesity), diet, allergies and/or the like. In some implementations, the healthcare management server(s) may determine that an update needs to be performed to the health-based user experience settings based on how much time has elapsed since the last update to the health-based user experience settings. In some implementations, the user may provide a request for health-based user experience settings to be updated, by sending a request including a user ID and information affecting the health-based user experience settings (e.g., providing information on a recent medical procedure and outcomes) that are required to be changed, along with values for the information affecting the health-based user experience settings. In some implementations, the healthcare management server(s) may determine that a health-based user experience settings update is required based on messages received by the MHM components from affiliated entities (e.g., insurance company, pharmacy provider, healthcare provider/professional/hospital, etc.) involved in providing coordinated patient management solutions. In some implementations, the healthcare management server(s) may determine that a health-based user experience settings update is required based on the progress of the user towards their goals/milestones as stored in the goals/milestones database(s). For example, the healthcare management server(s) may secure access and obtain goals/milestones information from the goals/milestones database(s), and determine a rate of progress (e.g., number of milestones crossed per unit time) for the user. The health-based user experience settings may be made more demanding (e.g., more frequent reminders) if the number of milestones crossed per unit time is below a predetermined threshold. In some implementations, a combination of the above factors, and numerous other variants of user preferences settings update triggering may be utilized.

If the healthcare management server(s) determines that the health-based user experience settings need to be updated, then the healthcare management server(s) may access the user's medical history in the medical records database(s) 517, and extract information 518 from the user's medical history records relevant to the health-based user experience settings. Upon receiving the information from the user's medical history records, the healthcare management server(s) may connect to the user profile database(s), and generate an updated record 519 associated with the user with the updated health-based user experience settings. The healthcare management server(s) may secure access 52o to the user profile database(s) upon generating the updated user experience settings record and update the user profile stored in the user profile database(s) 521 using the updates to the user experience settings based on the device settings, user preferences and health-based settings.

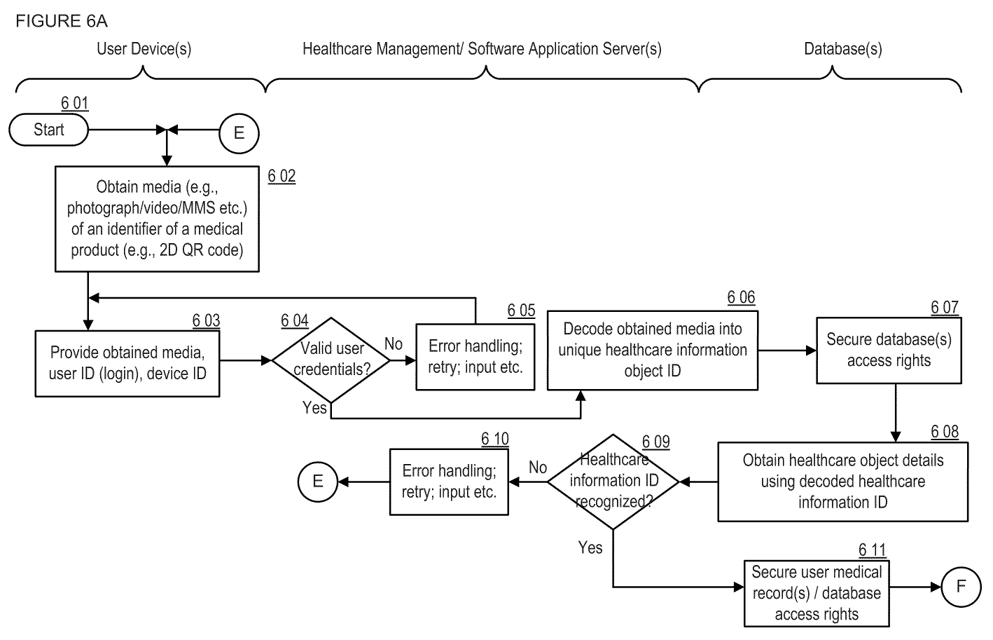

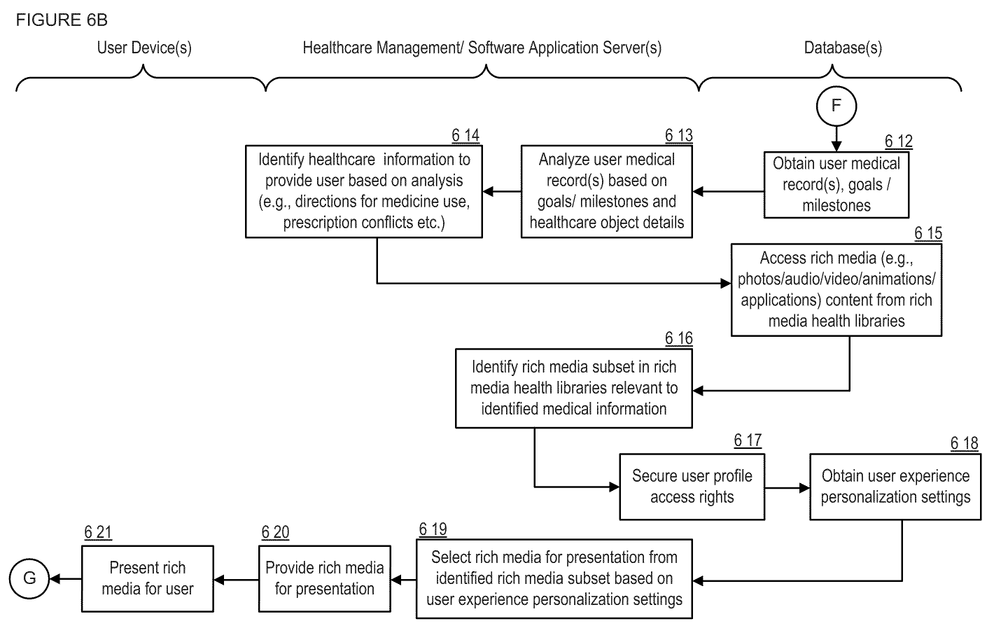

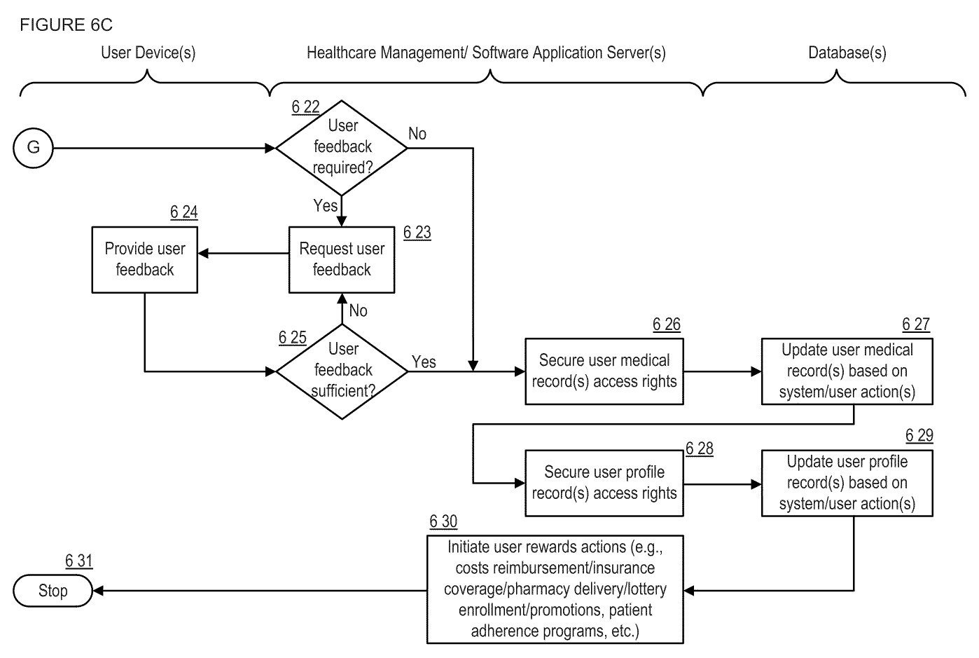

FIGS. 6A-C are of logic flow diagrams illustrating aspects of coordinated user management in some embodiments of the MHM. In some implementations of the MHM, a user may obtain a media object 602 embodying information about a coordinated patient management initiation trigger. For example, the user device may include a camera capable of capturing images and/or videos of the coordinated patient management initiation trigger. The application software working in conjunction with the user device hardware may facilitate uploading the images and/or videos to the healthcare management server(s). For example, the user may utilize a camera included in an Apple iPhone smartphone to obtain a photograph, video etc. of a QR code (e.g., printed onto a drug label, flyer, poster hanging in a store etc.). As another example, a user may be video calling via the FaceTime application on an iPhone 4® with the user's physician, and may utilize a front-facing camera of the iPhone 4® to provide a photograph, video file, streaming video, and/or the like, of the user's face, injury, identifying mark, and/or the like, and a rear-facing camera of the iPhone 4® to provide a photograph, video, streaming video and/or the like, of a label of a drug bottle. In some implementations, the user device and/or application software provided by the application server(s) may facilitate capture and transmission of the media object. Upon obtaining the media object, the user device may issue commands for creating a FTP(S) session, uploading one or more captured images and/or video files and/or streaming video, either individually or simultaneously in a batch, to the healthcare management server(s), and closing the FTP session. A non-limiting example of an FTP command illustrating substantive aspects of uploading a captured media object to the healthcare management server(s) is provided below:

ftp userID:password@prescriptions.MHM.com
mput *.jpg // transfer all JPEG image files in the current directory
mput trigger.mpg // transfer a video file
close

In some implementations, the user and/or device may provide 603 a user ID and/or device ID and password along with the captured media object. Upon receiving the user and/or device, the healthcare management server(s) may query the user profile database(s) to determine whether the provided credentials are valid 604. If the user and/or device credentials are not validated, the healthcare management server(s) may provide 605 an error message and may route the user and device to retry the login process. Validation credentials may include digital certificates, passwords, and/or the like. Once the user and/or device credentials have been validated, the healthcare management server(s) may decode 606 the obtained media into a unique healthcare information object ID. For example, in some implementations utilizing a 1D/2D barcode as a coordinated patient management initiation trigger, the healthcare management server(s) may utilize Google, Inc.'s Zebra Crossing (ZXing) open-source, multi-format 1D/2D barcode image processing library implemented in Java™. The healthcare management server(s) may secure access rights 607 to the mobile health label (MHLabel) database(s) and query 608 the MHLabel database(s) using the unique healthcare information object ID. In some implementations, the MHLabel database(s) stores information correlating the unique health information object IDs to actual names of healthcare information objects (e.g., pharmaceutical product names, medical device names, medical procedures diets, nutrition regimens etc.). In some implementations, the healthcare management server(s) may further query the healthcare information database(s) using the name of the healthcare information object and/or healthcare information object ID to obtain detailed information from the healthcare information database(s) on the healthcare information object. If the healthcare information object ID is not available in the healthcare information database(s) (609: option “No”), the healthcare management server(s) may execute an error handling routine 610 and may redirect the user to re-capture media embodying the coordinated patient management initiation trigger using the user device. Upon obtaining a valid healthcare information object ID (609: option “Yes”), the healthcare management server(s) may secure access to the medical records database(s) 611 and obtain information from the user's medical history record stored within the medical records database. For example, the healthcare management server(s) may obtain a medical history record stored as an XML data file in the medical records database. An example XML data listing illustrative substantive aspects of a medical data record is provided below:

```
<?XML version = “1.0” encoding = “UTF-8”?>
<medical_record>
        <patient_info>
            <mhm_id>jpdoe</mhm_id>
            <name>Jane P. Doe</name>
            <ssn>832-77-7811</ssn>
            <age>60</age>
            <sex>female</sex>
            <insurer>XYZ Insurance Co.</insurer>
            <policy_number>AFB123456</policy_number>
        </patient_info>
        <provider_info>
            <name>ABC Hospital</name>
            <physician>Dr. Med I. Cal, M.D.</physician>
        </provider_info>
        <record>
            <diagnosis>
                <date>2000-10-05</date>
                <item type=″primary″>
                    <name>Gastric Cancer</name>
                    <type>malignant</type>
                    <detail>Well differentiated adeno
carcinoma</detail>
                </item>
                <item type=″secondary″>Hyper tension</item>
            </diagnosis>
        </record>
</medical_record>
```

In some implementations, the healthcare management server(s) may obtain access to the goals/milestones database(s) 612 and obtain the user's goals/milestones by querying the goals/milestones database(s) using the user ID as a search term. In some implementations, the healthcare management server(s) may analyze the user's medical history records 613 by comparing the information in the user's medical history records to the goals/milestones provided for the user. As one illustrative, non-limiting example, the user's medical history records may store historical information on the blood pressure readings of the user. Corresponding to the historical blood pressure readings stored in the medical history record for the user, the goals/milestones database(s) may store information on the target systolic and diastolic pressure that the user was recommended to aim for during the course of coordinated patient management. By comparing the information in the user's medical history records to the goals/milestones, the healthcare management server(s) may determine that the user requires coaching on aspects of blood pressure and maintaining low blood pressure. The medical history records may comprise a plurality of fields related to various aspects of the user's health, and the healthcare management server(s) may examine each of the fields in relation to the corresponding entry in the goals/milestones table. A non-limiting example PHP/SQL command illustrating substantive aspects of analyzing a user medical record based on the user goals and milestones is provided below:

```
// Obtain User Goals/Milestones
mysql_connect(″GoalsMilestones.SQL″);) // connect to goals/milestones database
// retrieve entire user table of milestones, with 3 columns
$query = ″SELECT ms_name value deadline FROM ” + $userid + “_MilestonesTable”;
$N1 = mysql_num_rows($query); // total number of goals/milestones in user table
$gm_table = mysql_query($query); // perform the search query
mysql_close(″GoalsMilestones.SQL″); // close goals/milestones database
// Obtain User Medical History Record
mysql_connect(″MedicalHistory.SQL″);) // connect to goals/milestones database
// retrieve entire user medical history table, with 3 columns
$query = ″SELECT condition value date FROM ” + $userid + “_MedHistoryTable”;
$N2 = mysql_num_rows($query); // total number of goals/milestones in user table
$mh_table = mysql_query($query); // perform the search query
mysql_close(″MedicalHistory.SQL″); // close goals/milestones database
// Compare User Goals/Milestones with Medical History Record
M = min(N1,N2);FLAG = zeros(M,1); // variable to flag potential tutorial topics
for k = 1:1:M
  if (mh_table(k,3) > gm_table(k,3) // if date of condition is past deadline
  AND mh_table(k,2) < gm_table(k,2)) // if the milestone has not been reached
(FLAG(k,1) = 1;) // Flag this condition as a potential tutorial topic
loop
return FLAG
```

In some implementations, the healthcare management server(s) may correlate the user's medical history record to the details of the healthcare object for which the user provided the coordinated patient management initiation trigger. The healthcare management server(s) may secure access to and query the healthcare information database(s) using the healthcare object identifier name and/or healthcare object identifier ID. In some implementations, the healthcare management server(s) may compare keywords in the user's medical history record to the information obtained from the healthcare information database(s) to identify the topics within the information from the healthcare information database(s) to provide media prescriptions on for the user. Accordingly, in some implementations, it is contemplated that the healthcare management server(s) may identify healthcare information to provide the user based on the analysis 614 of the user's medical history record(s) in view of any/all of the information available to the healthcare management server(s), MHM components, and/or MHM-affiliated entities.

Upon identifying the healthcare information to provide for the user, the healthcare management server(s) may secure access to and query 615 the rich media health libraries based using the identified healthcare information topics/names/IDs as search terms. In some implementations, the rich media health libraries may provide in response to the search query the names and/or URLs of a vast subset array of media prescriptions 616 that may satisfy the criteria set forth by the search terms in the search query. In some implementations, the healthcare management server(s) may improve the specificity of the search for media prescriptions to provide for the user by including the user experience preferences settings stored in the user profile record(s) in the user profile database(s). In some implementations, the healthcare management server(s) may secure access 617 to and query 618 the user profile database(s) to obtain the user experience preferences settings for the user and/or user device. The healthcare management server(s) may further narrow the subset (and/or select one or more media prescriptions for delivery to the user) 619 of media prescriptions names and/or URLs provided by the rich media health libraries search query by excluding all media prescriptions that do not satisfy the user device preferences, user preferences and/or health-based user experience preferences settings. Upon identifying the media prescription(s) for delivery to the user, the healthcare management server(s) may provide the media prescriptions to the user device 620, and the user device may present the media prescriptions 621 to the user. For example, the healthcare management server(s) may provide media prescription(s) as Adobe Flash® (e.g., .flv and/or .swf file extensions), HTML5 (e.g., using MPEG4 H.264), and/or the like interactive movies upon being requested by the user device for the media prescriptions. A non-limiting example HTML/JavaScript™ command illustrating substantive aspects of delivering interactive rich media prescriptions via Adobe Flash® to the user device is provided below:

```
<html>
<div id=“MediaPrescription”>
  If you're seeing this, you don't have Flash Player installed.
</div>
<script type=“text/javascript”>
  var eduMedia= new SWFObject(swfpath, “Media”, “640”, “480”,
  “8”, “#000000”);
  eduMedia.addParam(“quality”, “high”);
  eduMedia.write(“MediaPrescription”);
</script>
</html>
```

In some implementations, the healthcare management server(s) may utilize platform and/or plugin-independent technologies to provide the media prescription(s), for example, via hypertext markup language 5 (“HTML5”) webpages. A non-limiting example HTML5 command illustrating substantive aspects of providing media prescription(s) to a user is provided below:

<html>
<video width=”1280” height=”720” controls>
<source src=”/media/pm1.mp4” type=’video/mp4; codecs=”avc1.42E01E,
mpa4.40.2”’>
</video>
</html>

In some implementations, the healthcare management server(s) may request feedback from the user in response to the provided media prescriptions. For example, the media prescriptions provided in Adobe Flash® (e.g., .flv and/or .swf file extensions) formats may include messages for the user to provide feedback to the healthcare management server(s). Such interactivity in the movies may be provided, for example, through use of Adobe ActionScript® and/or HTML 5 and/or JavaScript™ programming.

In some implementations, if the healthcare management server(s) determine 622 that PRO-Feedback and/or other user feedback is required, the healthcare management server(s) may provide a request 623 for user feedback. Upon receiving feedback from the user 624, the healthcare management server(s) may analyze the feedback 625 in view of the original request for user feedback to determine whether the user feedback provided satisfies the requirements of the original request for feedback. The healthcare management server(s) may repeatedly request the user for feedback until the healthcare management server(s) determines that the user feedback is sufficient (625, option “Yes”). Upon determining that the user has provided sufficient feedback, the healthcare management server(s) may secure access to the medical records database(s) 626, and update the user's medical history records 627 based on the healthcare information provided via the media prescriptions and/or the user feedback provided in response to the media prescriptions delivery. In some implementations, the healthcare management server(s) may secure access to the user profile database(s) 628 and update the user profile record(s) 629 of the user based on the provided media prescriptions and/or user feedback provided in response to the media prescriptions.

In some implementations, the healthcare management server(s) may initiate a number of user reward actions 630 to reward the user for successfully consuming the media prescription provided by the healthcare management server(s) and providing feedback to suffice the requirements of the healthcare management server(s). Such user reward actions may include, but not be limited to, facilitating, in conjunction with the various MHM components and/or affiliated entities, providing insurance co-pay systems/coupons, reimbursement of costs, providing (additional) insurance coverage, delivery of pharmacy products and/or healthcare services, coupons for free healthcare provider visits, lottery enrollments, enrollment in promotions, discount coupons, and/or the like. In some implementations, the MHM may provide patient adherence programs for the user. For example, the healthcare management server(s) may provider event reminders corresponding to actions the user should undertake as recommended by the MHM' coordinated patient management components and/or affiliated entities. The event reminders may be populated automatically into a calendar application included in at least one communication instrument(s) of the user. For example, the healthcare management server(s) may provide an iCalendar file (*.ics) used as a RFC 5545 standard for calendar data exchange to the user device via FTP, an e-mail/SMS/MMS/etc. message. Upon receipt, receiving applications may automatically instantiate the calendar events, which may in turn prompt users for further interaction and requests for compliance; e.g., a calendar event asking to “ACCEPT,” “REJECT,” “MAYBE” respond to a request to take medicine at a specified time would return this medicine taking compliance request to the MHM. In some implementations, the healthcare management server may provide a message to a medical prescriptions provider to re-fill and/or ship the user's medications for the user.

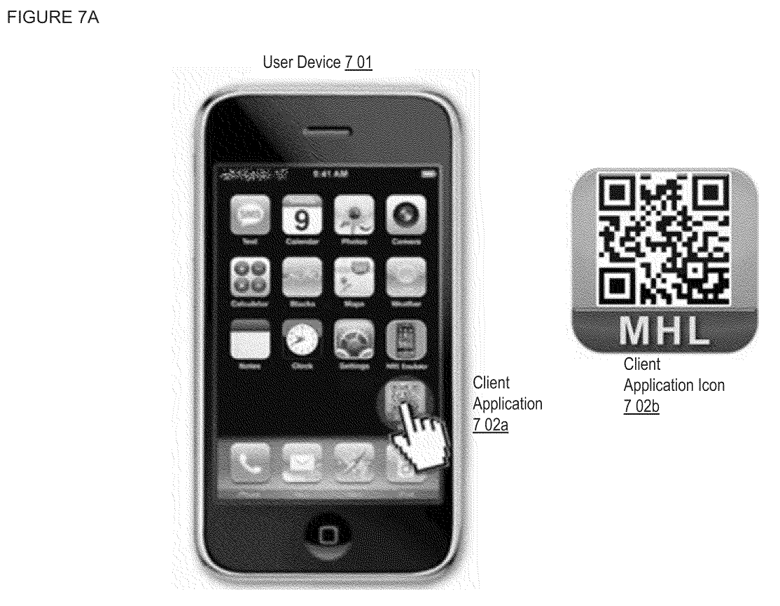

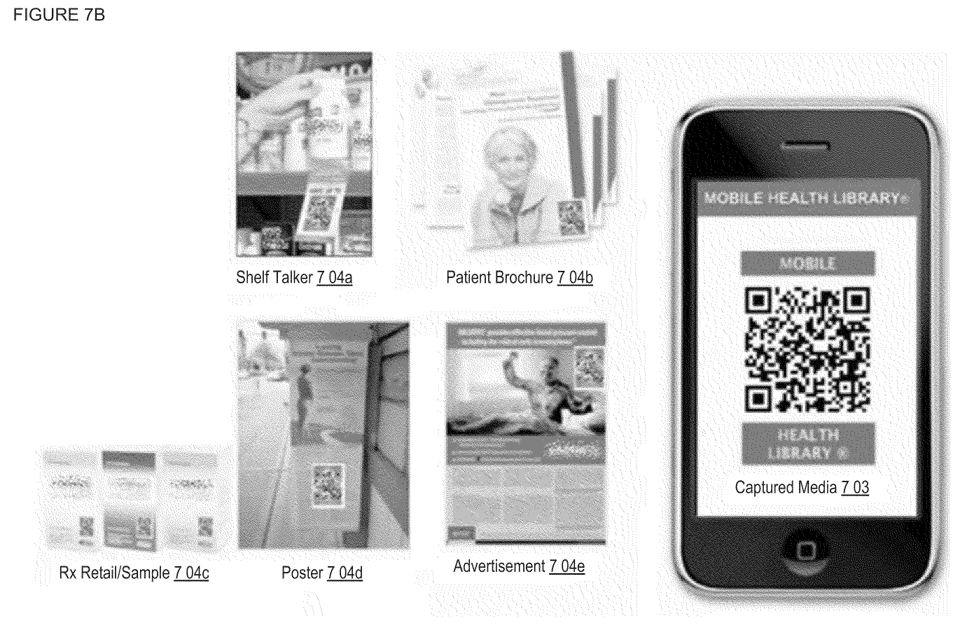

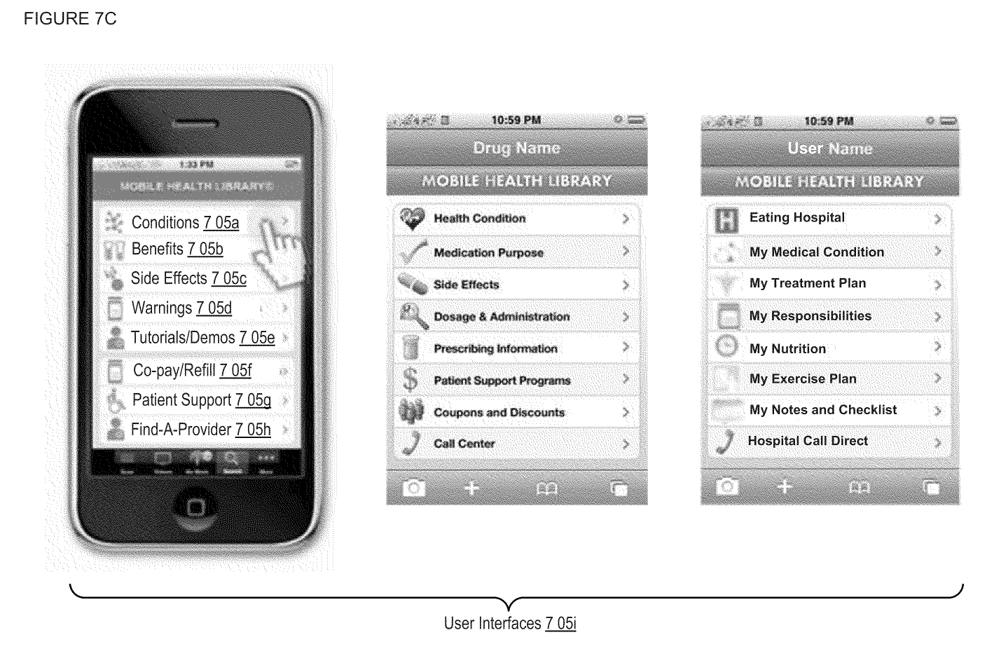

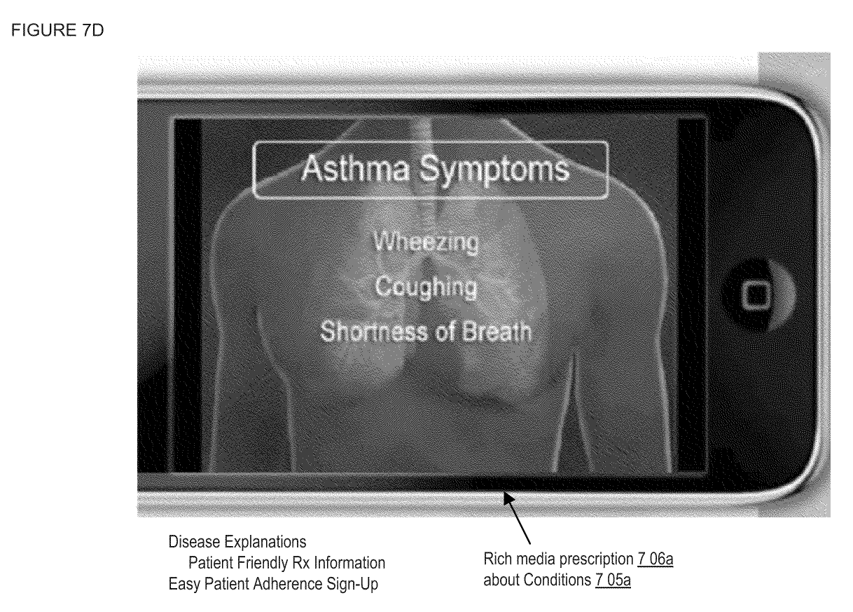

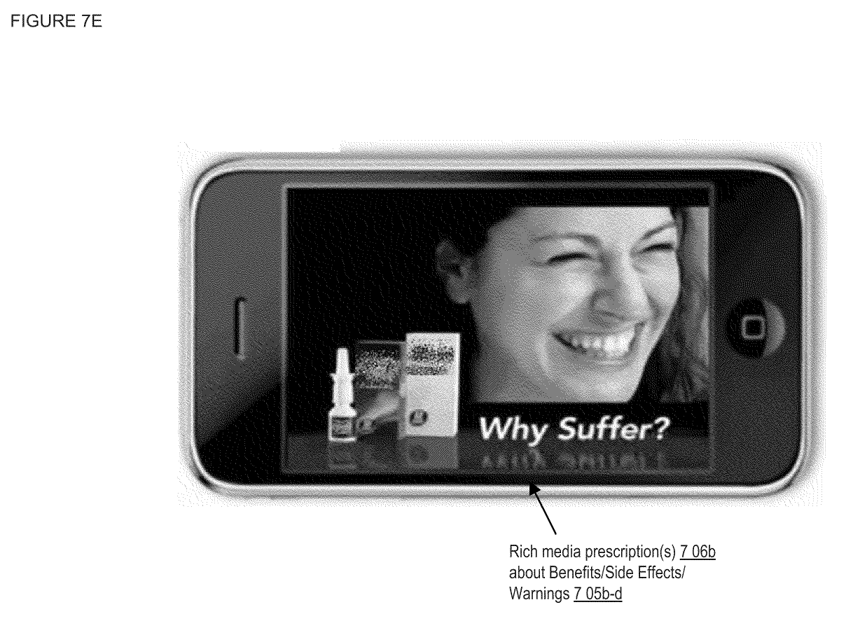

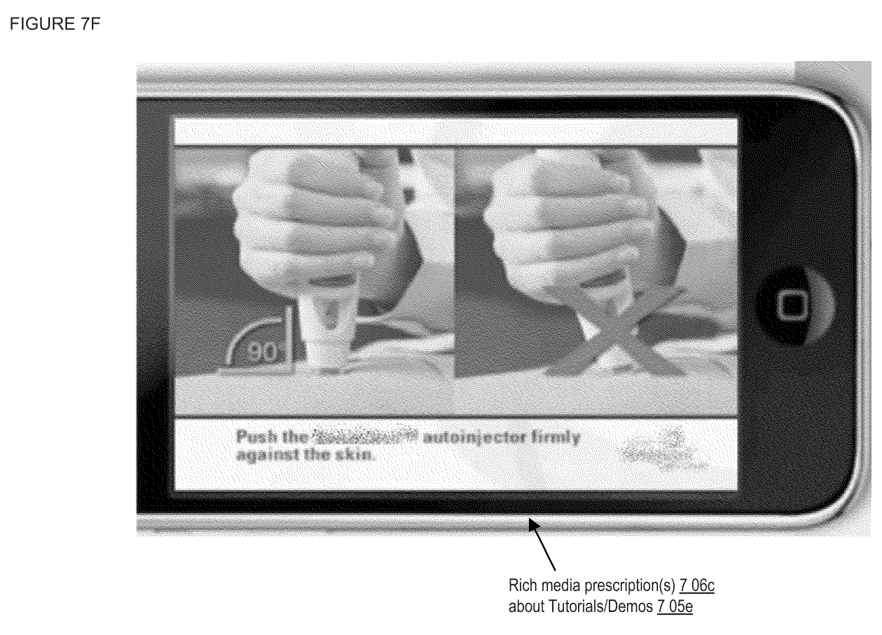

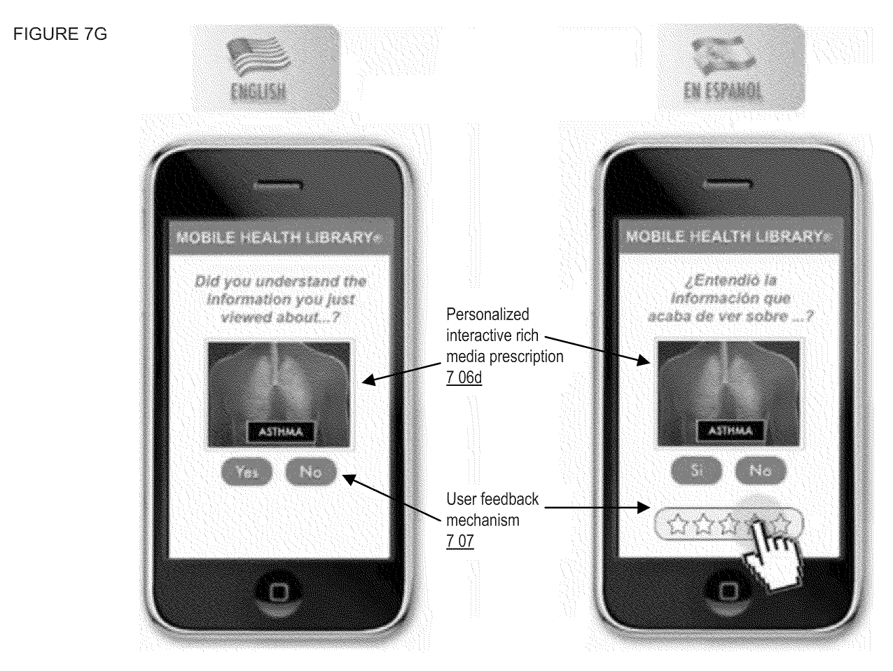

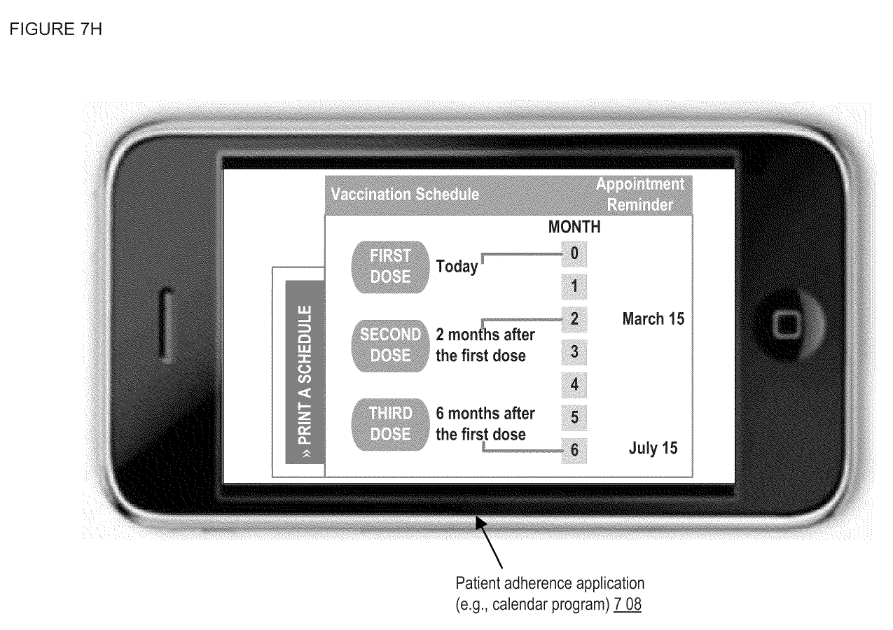

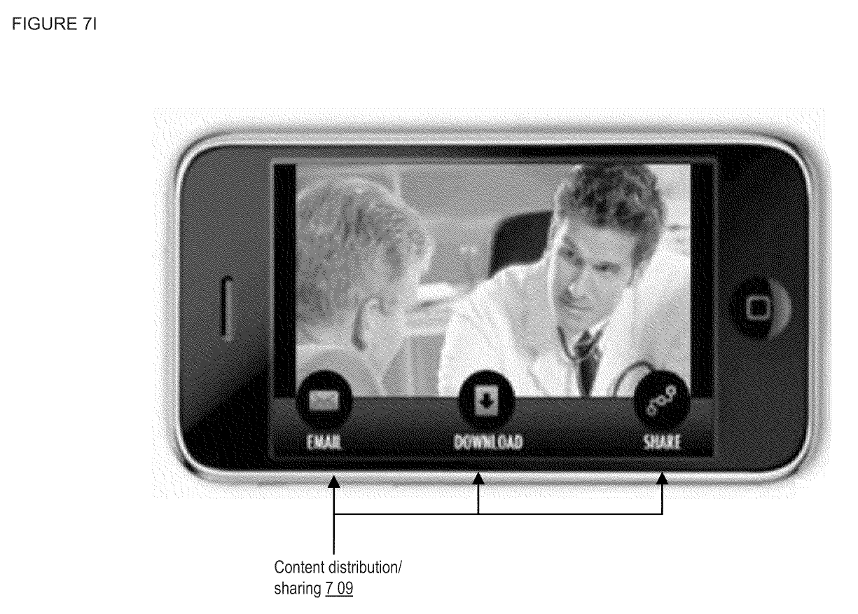

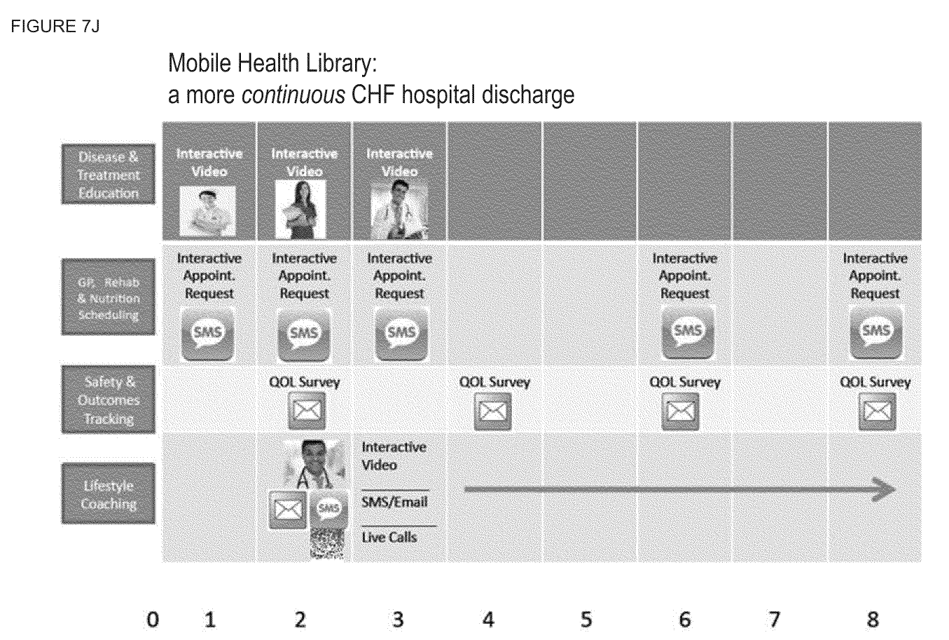

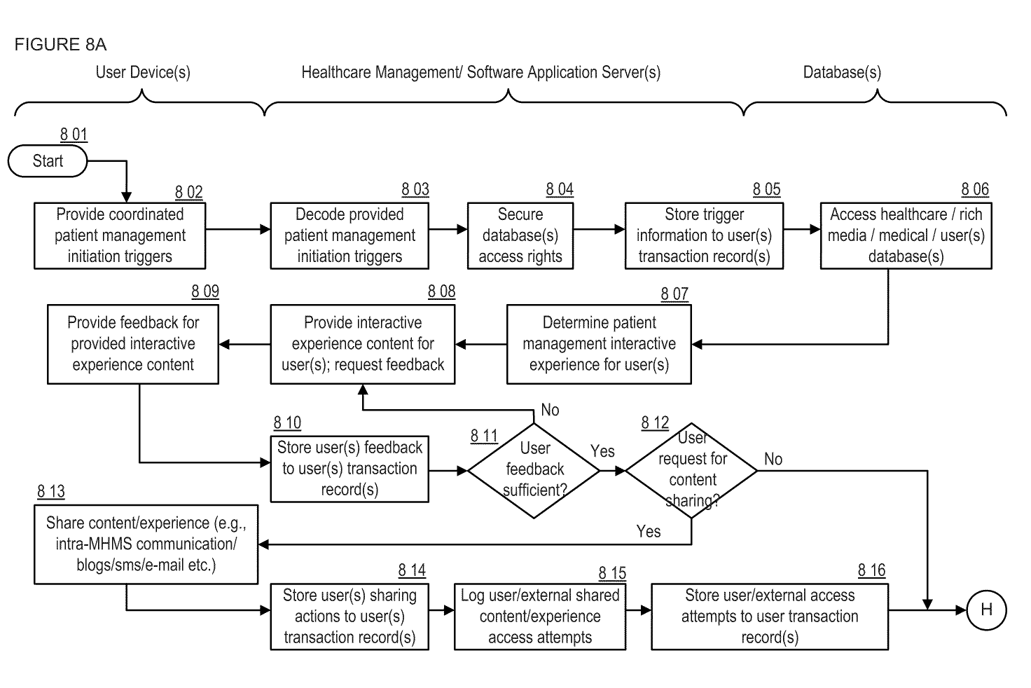

FIGS. 7A-J are of illustrations of various aspects of user interaction with the MHM in some embodiments of the MHM. In some implementations of the MHM, a user may utilize an electronic user device 701 to communicate with the healthcare management server(s). In some implementations, a client application 702a may be installed and/or available for execution on the user device. For example, an application icon 702b may be presented for the user on a display of the user device, which the user may activate (e.g., by mouse/trackpad click, touch, keyboard entry, voice activation, etc.) in order to access services provided by the MHM. In some implementations, such client applications may be developed in various programming languages and/or using software development kits (SDKs), such as iPhone SDK 3.2, Android SDK, Blackberry Application Platform, and/or the like. In some implementations, upon running the client application, the user may be able to capture and transmit to the healthcare management server(s) media 703 of a coordinated patient management trigger. Such coordinated patient management triggers may include, but not be limited to, shelf talkers 704a, patient brochures 704b, Rx retail/samples 704c, posters 704d, advertisements 704e, and/or the like. In some implementations, the client application may offer the user the ability to avail of a variety of services. Examples of such services may include, but not be limited to, learning about a heath condition 705a, learning about the benefits 705b, side effects 705c, related statutory and/or other warnings 705d for a healthcare product (e.g., medical device, drug, nutritional diet etc.), viewing tutorials and/or demonstrations 705e on a variety of health topics, requesting and/or ordering 705f insurance co-pays, reimbursements, discounts, re-filling of prescribed medications, over-the-counter products etc., enrolling in and/or requesting 705g technical support, ombudsman services, helpline, counseling, therapy, adherence programs etc. For example, the client application may provide a user interface (e.g., 705i) from which a user may be able to select from a variety of products, services, tutorials, and/or the like, relating to various topics including, but not limited to, health conditions, tutorials on the purpose of a medication, drug side effects, dosage and administration of doses, prescription information, patient helpline/support programs, coupons, specials, and/or discounts offerings, technical support/call center, nutrition advice, personalized medical records, treatment plan, patient responsibilities, personalized nutrition, personalized exercise regimen, personal notes/checklists, hospital calling applications, and/or the like.

In some implementations, the user may choose an option to learn about a health condition 705a. In such implementations, the healthcare management server(s) may stream rich media prescriptions 706a to the user device for presentation to the user. Such rich media prescriptions may provide, in a manner tailored to the specific preferences of the user and in a format easily understood by the user, disease explanations (e.g., risk factors, causes, symptoms, etc.) and information on possible treatments. In some implementations, the healthcare management server(s) may provide, either upon user request or otherwise, informational rich media presentations and/or advertisements 706b on medical products and/or services that may be relevant to the health condition of interest to the user. Such rich media presentations and/or advertisements may inform the user about the benefits, side effects, mechanism of action, statutory warnings, etc. of the medical products and/or services. In some implementations, the healthcare management server(s) may provide tutorials and/or demonstrations 706c related to the health condition, product and/or service. For example, the tutorial and/or demonstration may inform the user on topics including, but not limited to, how to perform a procedure, how a product works, how to take a test, how to use a product and/or service provided by the MHM and/or affiliated entities, and/or the like. In some implementations, the healthcare management server(s) may request user feedback 707 to the provided rich media prescriptions. The healthcare management server(s) may present the feedback requests in a format tailored 706d to the preferences of the user. For example, the media and user feedback requests may be provided in a language matching the user's language preferences saved on the user device. In some implementations, the user may be able to provide user feedback via user interface elements in the client application and/or via interactive content included in the provided rich media prescriptions. In some implementations, the user may request to enroll in patient support/adherence programs. In some such implementations, the healthcare management server(s) may populate a calendar program 708 with entries/milestones according to a prescription treatment plan for the user. The healthcare management server(s) may also coordinate user management with the affiliated entities to provide automatic re-fill/shipment services for treatments and/or other products required by the user. In some implementations, the client application may provide sharing/distribution facilities for users. In some implementations, the client application may allow the user to download and/or share a rich media prescription via a variety of methods including, but not limited to, e-mail, instant messenger, voice over internet protocol, teleconferencing, videoconferencing, file transfers, peer-to-peer file sharing, posting a link to a webpage and/or publishing a link to and/or embedding the media in a webpage, newsfeed, and/or the like.

In some implementations, a user and/or MHM-affiliated healthcare professional may request on-demand consultation services (e.g., “Find-A-Provider” 705h, Healthcare provider and/or consultant directory and/or search services) with healthcare consultants such as a healthcare product and/or service provider, practitioner with expertise in a healthcare discipline (e.g. physician expert, neurosurgeon, clinical trial statistician etc.), artificial intelligence (AI) expert system and/or the like. In some implementations, the MHM may include expert system(s) implemented on the healthcare management server(s) for providing on-demand consultation services that utilize the MHM knowledge base including, but not limited to, the healthcare information, goals/milestones, mobile health label, rich media health libraries, medical records, and user profile databases. For example, the healthcare management server(s) may utilize the C Language Integrated Production System (CLIPS) open-source software tool to build the expert system(s). In some implementations, the healthcare management server(s) may determine that consultation with a healthcare product and/or service provider is required for the user. For example, in an exemplary implementation, a user may capture media of a coordinated patient management trigger representing a pharmaceutical drug, and provide the media to the healthcare management server(s) along with a user ID (e.g., the users scans a barcode/QR code on a bottle of medicine). The healthcare management server(s) may extract/decode information about the coordinated patient management trigger from the media provided by the user. The healthcare management server(s) may query a medical history records database to obtain the user's medical history related to the coordinated patient management trigger using the user ID and the information about the coordinated patient management trigger. The healthcare management server(s) may also query the healthcare information database(s) to obtain information about the pharmaceutical drug using the information about the coordinated patient management trigger. In some implementations, the healthcare management server(s) may analyze the user's obtained medical history against the information about the pharmaceutical drug. In some implementations, the healthcare management server(s) may flag the pharmaceutical drug as being incompatible for the user, based on the user's medical history record and the information about the pharmaceutical drug. In such situations, the healthcare management server(s) may initiate a search for healthcare product and/or service providers for on-demand consultation with the user related to the source of the triggered items (e.g. a flagged incompatibility). Automatically with the trigger, and/or with the user-provided indication of desire for consultation, indicia of potential consultation opportunities may be sent to the MHM. In some implementations, the MHM may queue such consultation indicia requests for a plurality of users. In some implementations, the user may provide an on-demand request for consultation with a healthcare product and/or service provider.

In some implementations, the healthcare management server(s) may store, or have access to, calendars indicating availability of a plurality of providers for user consultations. In such implementations, the healthcare management server(s) may generate a list of providers available for user consultations using the calendars. In alternate implementations, the healthcare management server(s) may provide notifications of the consultation request to a plurality of healthcare product and/or service providers. For example, the healthcare management server(s) may publish the consultation request to a real-time private newsfeed on a secure website accessible by authenticated MHM-affiliated entities and/or send consultation request messages directly to the authorized affiliated entities. In some implementations, the healthcare product and/or service providers may respond to the published entry in the newsfeed or to the provided message by submitting bids to fulfill the consultation requests posted to the real-time newsfeed. The healthcare management server(s) may monitor responses from the MHM-affiliated entities and aggregate the bids for each consultation request along with information on the bidders for each of the consultation requests. In some implementations, the healthcare management server(s) may perform such monitoring and aggregation of received bids for a consultation requests until a condition is satisfied (e.g., a sufficient number of bids is obtained for the consultation request, a sufficient amount of time has elapsed since publishing the consultation request/sending consultation request messages, a sufficient number of user- and/or system-preferred healthcare product and/or service providers have responded to the consultation request etc.). In some implementations, upon a sufficient number of bids for the consultation request being received by the healthcare management server(s), the healthcare management server(s) may provide the user with a list of bidders to fulfill the consultation request of the user. The user may study the provided bidding list, request further information from the healthcare management server(s) on any of the listed healthcare product and/or service providers if needed, and select one or more providers from the bidding list to fulfill the consultation request. Upon receiving the user selection of provider(s) to fulfill the consultation request, the healthcare management server(s) may provide to the user-selected provider(s) relevant portions of the user's medical history record (in accordance with any privacy requirements provided by applicable regulatory standards, such as, for example, HIPAA). The healthcare management server(s) may also provide information about the coordinated patient management trigger and the associated healthcare information object to the user and/or user-selected provider(s) (e.g., medicines incompatible with the scanned medicine bottle). In some implementations, the healthcare management server(s) may provide a notification to the user and/or the user-selected provider(s) to establish communication link(s) with each other. In some such implementations, the healthcare management server(s) may provide application software for the user and/or user-selected provider(s) and infrastructure for the communication link. For example, the healthcare management server(s) may utilize the Ekiga (formerly GnomeMeeting) open-source softphone, video conferencing, and instant messenger application to provide simultaneous communication links between the user and all the user-selected provider(s). In another example, Apple's open-source FaceTime application, Skype, and/or other application and/or protocol may be employed. The application may be launched with a parameter supplied indicative of the selected winning bidders' contact information (e.g., the number being auto-dialed upon launching of the application). In some implementations, the healthcare management server(s) may configure the communications between the user and user-selected provider(s) such that the communications are sponsored by relevant advertisements placed in the interfaces provided for the user and user-selected provider(s). In some implementations, the communications links between the user and user-selected providers may be monitored for length of time, number of packets transmitted, etc., and performance reports may be generated (e.g., for billing purposes) based on the monitored metrics. In some implementations, the user and/or user-selected provider(s) may request rich media prescriptions from the healthcare management server(s) for providing to the user during the ongoing on-demand consultation. In response to receiving such a request, the healthcare management server(s) may provide the requested rich media prescriptions for the user. In some implementations, the healthcare management server(s) may require user feedback to the provided rich media prescriptions. In some such implementations, the healthcare management server(s) may configure the on-demand consultation and/or communication links to be maintained as long as the user has still not provided the required feedback to the provided rich media prescriptions. In some implementations, other advantageous services may be provided by the healthcare management server(s) during an on-going on-demand consultation. For example, media related to medication recommended by the user-selected provider may be provided for the user; the healthcare management server(s) may determine which medications are covered by the user's insurance policies and/or if any alternative medicines are available that are covered by the user's insurance policies); the healthcare management server(s) may provide the user with an option for one-click home delivery of required medications per the consultation, etc.

In some implementations, standardized instructional protocols, user PRO feedback, quality of life (“QOL”) surveys and/or other user feedback, and/or reminder mechanisms may be launched in a coordinated manner by the MHM for post-discharge patient management. As one example, a user/patient may be discharged from a hospital following treatment for congestive heart failure (“CHF”). In such an example, the MHM may provide the user with interactive prescriptions on disease and treatment education relating to the patient's CHF condition, personalized for the user according to the user's health needs, user preferences, and/or user device settings. In some implementations, the MHM may supplement such prescriptions with interactive appointment scheduling. The MHM may send, e.g., short messaging service (“SMS”) messages including reminders about rehabilitation training schedules, nutrition schedules, appointment reminders with physicians/therapists, etc. In some implementations, the MHM may interactively request appointments with the user, and populate the user's calendar with appointment schedules for disease and treatment education sessions, QOL surveys, lifestyle coaching sessions, etc. The MHM may periodically request feedback from the user, including QOL surveys, e.g., for safety and/or patient outcomes tracking. In some implementations, the MHM may provide on-demand (e.g., live video/chat/SMS/e-mail etc.) consultation with a healthcare professional/provider (e.g., therapist/physician), and may provide the QOL surveys, rehabilitation/nutrition scheduling, user profile and/or other data for the healthcare professional/provider for the consultation. Accordingly, in some implementations, the MHM may provide a continuous hospital discharge experience that manages post-discharge patient activities for improved adherence to hospital discharge instructions and patient reported outcomes. In some implementations, the MHM may advantageously utilize prescription delivery, user feedback surveys, patient adherence/appointment scheduling, video consultation and/or other various aspects included in embodiments of the MHM for clinical trial testing. For example, a clinical trial may require a set of requirements to be completed for each clinical subject included in the clinical trial, e.g., periodic education of/informing the subject about the clinical trial, validating the clinical subject's understanding of the clinical trial, obtaining informed consent from the clinical subject as needed through various stages of the clinical trial, providing a treatment/dosage schedule for the clinical subject to follow, ensuring adherence of the clinical subject to the treatment/dosage schedule, obtaining subject PRO feedback, case report forms, diary/journal audio/video/textual entries, scheduling appointments for in-person surveys/general health check-ups/diagnostic and/or other testing of the clinical subject, documentation of progress/prognosis of the clinical subject, obtaining new supplies for the clinical subjects to aid in the clinical trial, video consultation with clinical physicians/statistician associated with the clinical trial, and/or the like.

FIGS. 8A-E are of logic flow diagrams illustrating aspects of coordinated user management and management of affiliated entities in some embodiments of the MHM. In some implementations of the MHM, the healthcare management server(s) may mine the interactions of the MHM with a single user or a group of users to generate incentives structures for the various MHM components and/or affiliated entities involved in coordinated user management. In some implementations, a user may provide a coordinated patient management initiation trigger for the healthcare management server(s) 802. The healthcare management server(s) may decode the provided patient management initiation trigger 803, secure access 804 to user profile database(s) and/or medical history record(s) database(s), and store the user-provided coordinated patient management initiation trigger to user transaction record(s) 805. The healthcare management server(s) may continue with processing of the provided coordinated patient management initiation trigger by securing access 806 to the various database(s) in the MHM to determine 807 media prescriptions and/or other patient management interactive experiences to provide for the users, as discussed previously. The healthcare management server(s) may provide 808 selected media prescriptions for the user via the user device. The user may, in response to the provided media prescription and/or other patient management interactive experiences, provide user feedback 809, which the healthcare management server(s) may store Bio in a user feedback record(s) in the user profile database(s) and/or medical history record(s) database(s). For example, the user may fill out a HTML form on a webpage provided by the healthcare management server(s) include a submit button to send a HTTP POST message with the user feedback as XML data in the message body of the HTTP POST message. An example HTTP POST message illustrating substantive aspects of providing the user feedback in the form of XML-encoded data is provided below:

```
POST /users/feedback.php HTTP/1.1
Host: www.mhm.com
User-Agent: Mozilla/4.0
Content-Type: Application/XML
Content-Length: 441
<?XML version = “1.0” encoding = “UTF-8”?>
<user_feedback>
        <mhm_id>jpdoe</mhm_id>
        <timestamp>2010-05-23 21:44:12</timestamp>
        <user_md5_auth>bb311b03062d60eccb0dec7c7863d991</
        user_md5_auth>
        <tutorial_id>ANJCDU3</tutorial_id>
        <multiple_choice_response>a e d a
        b</multiple_choice_response>
        <symptom>
            <category>improvement</category>
            <detail_form>The pain in my shin seems to have
reduced considerably since last week's test</detail_form>
</user_feedback>
```

The healthcare management server(s) may repeatedly request user feedback 811 until the healthcare management server(s) determines that sufficient user feedback has been provided.

In some implementations, the healthcare management server(s) may provide the user with the ability to share content 813 that the user may have been exposed to due to the user's interaction with the MHM. For example, the MHM may provide the user with a URL and/or code snippet which the user may incorporate into a website, social networking application, blog, content sharing site, peer-to-peer sharing application, file hosting site, RSS and/or other newsfeed etc., to embed a media prescription object, healthcare information topic detail, MHM affiliated entity advertisement, and/or the like, into the user's desired location. In some implementations, the healthcare management server(s) may determine whether the user provided a request for content sharing abilities 812 and/or may determine whether such content sharing abilities may be provided for the user. In some implementations, the healthcare management server(s) may determine that the user may be granted such privileges. In such implementations, the user may publish MHM related-content 813 (e.g., media prescriptions, healthcare information topics, affiliated entity advertisements etc.). In some implementations, the healthcare management server(s) may store 814 the user sharing actions to a user transaction record in the user profile database(s). The healthcare management server(s) may, for example, use the user transaction record(s) to determine reward actions to initiate for the user. In some implementations, the healthcare management server(s) may log 815 the number and types of access attempts (e.g., number of times a media prescription object was viewed, (anonymous) user feedback obtained from such external use of MHM media prescription objects, number of clicks on a MHM affiliated-entity advertisement etc.) made on user-distributed MHM-related content, store the data in the user transaction record(s) 816, and incorporate the data into determining user reward actions.

In some implementations, the healthcare management server(s) may implement monetization models based on providing coordinated user management services and/or user-distribution of MHM-related media, prescriptions, healthcare information topics and/or MHM affiliated-entity advertisements. In some implementations, the healthcare management server(s) may initiate 817 generation of third-party billing reports periodically, on-demand by a user, MHM component and/or MHM affiliated entity, and/or triggered by an event (e.g., initial public offering, quarterly results announcement etc. of an MHM component and/or affiliated entity). Upon initiation of the reporting process, the healthcare management server(s) may obtain the parameters for report generation. For example, the healthcare management server(s) may obtain the name of a MHM-affiliated third-party entities 818 and users 819 related to whom report generation needs to be performed, and user behavior types 820 (e.g., number of times a QR code and/or other coordinated patient management initiation trigger specific to the product/service/procedure/device/provider was scanned by user(s) and/or sent to the healthcare management server(s), use of third-party products and/or services, distribution of third-party related media prescriptions and/or advertisements, etc.) on which report generation needs to be performed. The healthcare management server(s) may secure access to and query 821 the user profile database(s) and/or medical records database(s), and aggregate 822 data on user-provided coordinated patient management initiation triggers, media prescriptions consumed, user feedback provided in response to the consumed media prescriptions, user content/experience sharing actions, rewards actions performed for the users, and/or the like. In some implementations, the healthcare management server(s) may analyze the aggregated data across multiple users to determine statistical trends in the user data. For example, the healthcare management server(s) may determine which and/or how many times advertisements/banners/QR codes/other identifiers of objects of information were scanned by user(s) and/or sent to the healthcare management server(s). As another example, the healthcare management server(s) may determine which media prescriptions receive the highest quality and/or amount of user feedback and/or facilitate users to achieve their goals/milestones faster or with minimum amount of intervention by the MHM components, which interaction methods (e.g., button clicking, speech, touch screen interactions, etc.) yield the most amount of data, which third-party websites and/or applications to which MHM related content is published yield the maximum number of hits, etc. The healthcare management server(s) may, for example, utilize the OpenEpi freeware, web-based, open source, operating system-independent statistical analysis package developed in HTML and JavaScript™ to statistically analyze the aggregated data. In some implementations, the healthcare management server(s) may generate reports on user behavior, usage of affiliated-entity media prescriptions, products and/or services, user progression towards their goals/milestones after interaction with affiliated-entity products and/or services, and/or the like.

In some implementations, the healthcare management server(s) may provide the results of the statistical analysis results for a single user and/or a group of user to the third-party MHM-affiliated entities for review. In some implementations, the third-party MHM-affiliated entities may generate requests 825 to update user(s)/MHM-component/third-party MHM-affiliated entities' goals and/or milestone(s) based on the reports provided by the healthcare management server(s) on user behavioral patterns and/or usage statistics, as discussed further below. In some implementations, the healthcare management server(s) may generate third-party billing reports based on the user transaction records, user feedback, user content/media sharing/distribution actions related to the third-party products and/or services. For example, the healthcare management server(s) may obtain from a MHM database information on “pay-for-performance” parameters as agreed on by the third-party MHM affiliates including, but not limited to, parameters determining billing (e.g., number of scans/requests for information, amount of usage, reviews of products/services based on user feedback, progress of users towards their goals/milestones, difficulty slope of goals/milestones etc.), equations to be used for billing and/or the like. The healthcare management server(s) may generate the billing reports 826 in accordance with the “pay-for-performance” parameters and terms of the agreements with the third-party MHM affiliates, store the third-party billing reports 827 in a MHM billing database, and provide the reports to the third-party MHM affiliates 828. The third-party affiliates may provide payments 829 to the MHM in response to receiving the third-party billing reports from the healthcare management server(s).

The processing of MHM-affiliated entity-generated requests to update user(s) goals and/or milestone(s) based on the reports provided by the healthcare management server(s) on user behavioral patterns and/or usage statistics is discussed further below with reference to FIGS. 8C-E. In some implementations, a third-party MHM-affiliated entity (hereinafter “affiliate”), including but not limited to, an insurance company, pharmaceutical company, pharmacy, healthcare provider/professional/hospital, regulatory/governmental agency, and/or the like, may specify user(s)/affiliate(s)/MHM-component(s) for whom the affiliate may wish to update goal(s)/milestone(s) (hereinafter “milestone”), and specify a new goal/milestone target for the user(s) 831. The affiliate may generate a request 832 for the MHM to incorporate the new milestone for the user(s)/affiliate(s)/MHM-component(s). Upon receiving the milestone request, the healthcare management server(s) may verify the origin of the milestone request 833, and that the origin has authorization to request a milestone update. For example, the healthcare management server(s) may obtain milestone source credentials from the requestor and/or the billing database(s) 834, and compare the credentials 835 provided by the requestor against the credentials stored in the billing database(s). If the affiliate credentials are not verified, the healthcare management server(s) may request the affiliate to reattempt authorization procedures prior to progressing forward with the milestone request processing. Once the affiliate credentials have been verified by the healthcare management server(s), the healthcare management server(s) may determine whether the milestone is an active or a passive milestone 836. An active milestone, may, for example, be a milestone that requires that the target perform some activity and/or provide feedback before the milestone can be achieved. A passive milestone, may, for example, be a milestone that may not require the user(s)/target(s) to perform a specific activity, but instead may be achieved as the user(s)/target(s) continues about their routine activities within and outside the MHM system. Accordingly, in some implementations, a passive milestone may not require any specific actions and/or feedback from the target of the milestone. In some implementations, if the healthcare management server(s) determines 836 that the milestone is a passive milestone, the healthcare management server(s) may store the milestone to the profile of the target(s) 837. In implementations where the healthcare management server(s) determines 836 that the milestone is an active milestone, the healthcare management server(s) may enqueue the milestone activity 838 in an activity queue for the user(s)/target(s) to perform before the milestone may be achieved.

In some implementations, the healthcare management server(s) may process enqueued milestone target requests (hereinafter “target requests”) on a periodic, on-demand and/or on-trigger basis, and may account for the priority of a target request in determining which target request to process first. In some implementations, upon receiving a target request 839 the healthcare management server(s) may enqueue 840 the target request in target request queue(s). The healthcare management server(s) may continuously check for new incoming target requests 841 and enqueue them in target request queue(s) as they arrive.

In some implementations, the healthcare management server(s) may initiate 843-845 processing of target requests periodically, on-demand by a user, MHM component and/or MHM affiliated entity, and/or triggered by an event (e.g., initial public offering, quarterly results announcement, etc. of an MHM component and/or affiliated entity, etc.). Upon initiation of target request processing, the healthcare management server(s) may select a target request from the queue and dequeue 846 the target request from the queue, as discussed further below. The healthcare management server(s) may extract information on the milestone target(s) 847 from the target request, and secure access to the appropriate database (e.g., user profile database(s), if the target of the target request is a user). The healthcare management server(s) may, in some implementations, also secure access to the transactions database(s), and update 848 the milestone information in the profile database(s) of the target based on the transactions listed in the transactions record of the target present in the transactions database(s). The healthcare management server(s) may query the profile database(s) of the target based on the milestone request 849, and determine 850 whether the milestone was achieved based on the user profile record(s) retrieved from the database(s) associated with the target(s). If any milestone(s) pending are determined to be achieved by the healthcare management server(s), the healthcare management server(s) may store 851 the achievement of the milestone in the profile record(s) of the target(s). The healthcare management server(s) may determine 852 whether any activities were required to have been performed (e.g., in the case of an active target request), and dequeue the activities completed 853 from the activity queue. In some implementations, healthcare management server(s) may determine 854 whether any new milestones need to be added for the target being processed. For example, the healthcare management server(s) may provide a request for the third-party MHM-affiliated entities to generate requests to update user(s)/MHM-component/third-party MHM-affiliated entities' goals and/or milestone(s). If any new milestones for the target are identified 855, the healthcare management server(s) may update 856 the profile record(s) of the target(s) to include the new milestones. The healthcare management server(s) may continuously check whether new milestone requests arriving from other sources need to be enqueued 857, and may enqueue the incoming target requests as they arrive into the MHM.

In some implementation, the healthcare management server(s) may select the next target request to be processed according to a priority queuing process. In some implementations, the healthcare management server(s) may determine the next target request to process based on the order in which the target requests entered the queue and a priority value assigned to each of the target requests. In some implementations, each target request in a target request queue may be assigned a queue number indicative of the order in which the target requests entered the queue and a priority value indicative of the importance attached to processing the target request. In some implementations, the healthcare management server(s) may determine the target request priority values based on a number of factors including, but not limited to, target ID, target requestor ID, milestones included in the target request(s), whether the requests include active and/or passive milestone(s), a current progress of a target towards existing milestone(s) yet to be achieved according to profile record(s) of the target, and/or the like. In some implementations, the healthcare management server(s) may assign relative importance to the order in which target requests entered the queue and the priority value assigned to any particular target requests using position weights and/or priority weights. For example, a net priority value of a target request in a queue may be determined by the healthcare management server(s) as the weighted sum of the queue position and the target request priority, wherein the weights are the position weight and the priority weight, as illustrated in FIG. 8E:

Net Target Request Priority Value=Request Queue Position*Position Weight+Request Priority*Priority Weight;

In such a non-limiting exemplary implementation, the target request next selected for processing by the healthcare management server(s) may be identified as the target request having the highest net target request priority value. In some implementations, the healthcare management server(s) may utilize multiple queues for target requests, such as the non-limiting exemplary illustration in FIG. 8F. In some implementations, each queue may be assigned a queue priority weight relative to the other queues for target requests. In some such implementations, the net priority value of a target request may be weighted by the weight assigned to its target request queue:

Net Target Request Priority Value=(Request Queue Position*Position Weight+Request Priority*Priority Weight)*Queue Priority Weight;

In some such implementations, the next target request selected by the healthcare management server(s) for processing among the target requests in all the target request queues may be the target request having the highest net target request priority value, including the weighting assigned to each of the target request queues.

### MHM Controller

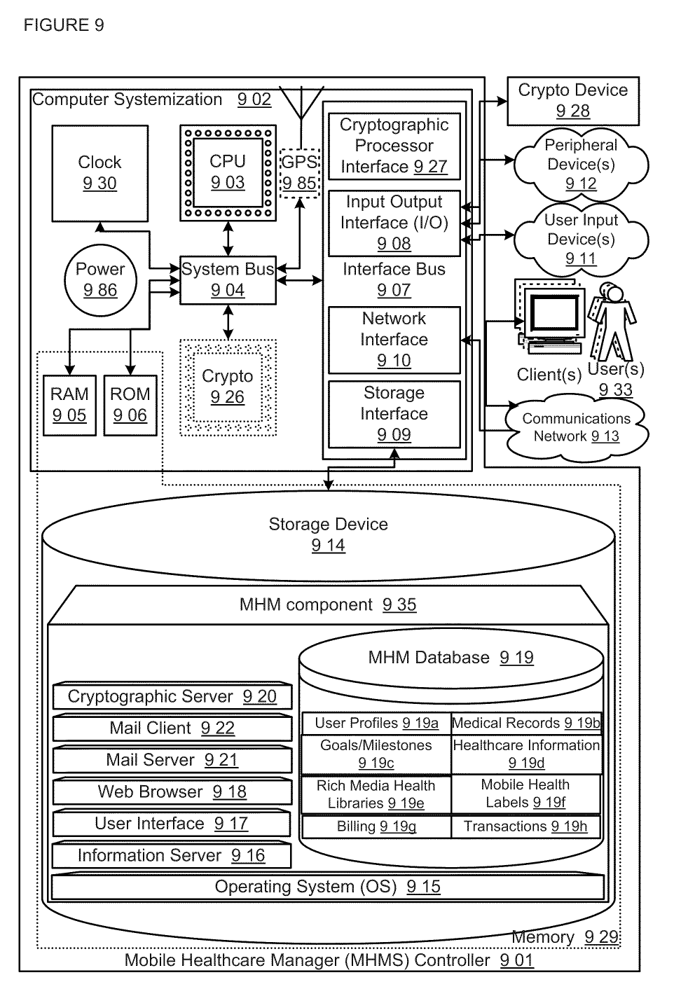

FIG. 9 illustrates inventive aspects of a MHM controller 901 in a block diagram. In this embodiment, the MHM controller 901 may serve to aggregate, process, store, search, serve, identify, instruct, generate, match, and/or facilitate interactions with a computer through enterprise and human resource management technologies, and/or other related data.

Typically, users, which may be people and/or other systems, may engage information technology systems (e.g., computers) to facilitate information processing. In turn, computers employ processors to process information; such processors 903 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 929 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MHM controller 901 may be connected to and/or communicate with entities such as, but not limited to: one or more users from user input devices 911; peripheral devices 912; an optional cryptographic processor device 928; and/or a communications network 913. For example, the MHM controller 801 may be connected to and/or communicate with users operating communication instrument(s) including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™ etc.), eBook reader(s) (e.g., Amazon Kindle™ etc.), laptop computer(s), notebook(s), netbook(s), gaming console(s) (e.g., Nintendo® DS etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MHM controller 901 may be based on computer systems that may comprise, but are not limited to, components such as: a computer systemization 902 connected to memory 929.

### Computer Systemization

computer systemization 902 may comprise a clock 930, central processing unit (“CPU(s)” and/or “processor(s)” (these terms are used interchangeable throughout the disclosure unless noted to the contrary)) 903, a memory 929 (e.g., a read only memory (ROM) 906, a random access memory (RAM) 905, etc.), and/or an interface bus 907, and most frequently, although not necessarily, are all interconnected and/or communicating through a system bus 904 on one or more (mother)board(s) 902 having conductive and/or otherwise transportive circuit pathways through which instructions (e.g., binary encoded signals) may travel to effect communications, operations, storage, etc. Optionally, the computer systemization may be connected to an internal power source 986. Optionally, a cryptographic processor 926 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the MHM controller and beyond through various interfaces. Should processing requirements dictate a greater amount speed and/or capacity, distributed processors (e.g., Distributed MHM), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the MHM may be achieved by implementing a microcontroller such as CAST's R8051XC2 microcontroller; Intel's MCS 51 (i.e., 8051 microcontroller); and/or the like. Also, to implement certain features of the MHM, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MHM component collection (distributed or otherwise) and/or features may be implemented via the microprocessor and/or via embedded components; e.g., via ASIC, coprocessor, DSP, FPGA, and/or the like. Alternately, some implementations of the MHM may be implemented with embedded components that are configured and used to achieve a variety of features or signal processing.

Depending on the particular implementation, the embedded components may include software solutions, hardware solutions, and/or some combination of both hardware/software solutions. For example, MHM features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MHM features. A hierarchy of programmable interconnects allow logic blocks to be interconnected as needed by the MHM system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the MHM may be developed on regular FPGAs and then migrated into a fixed version that more resembles ASIC implementations. Alternate or coordinating implementations may migrate MHM controller features to a final ASIC instead of or in addition to FPGAs. Depending on the implementation all of the aforementioned embedded components and microprocessors may be considered the “CPU” and/or “processor” for the MHM.

### Power Source

The power source 986 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 986 is connected to at least one of the interconnected subsequent components of the MHM thereby providing an electric current to all subsequent components. In one example, the power source 986 is connected to the system bus component 904. In an alternative embodiment, an outside power source 986 is provided through a connection across the I/O 908 interface. For example, a USB and/or IEEE 1394 connection carries both data and power across the connection and is therefore a suitable source of power.

### Interface Adapters

Interface bus(ses) 907 may accept, connect, and/or communicate to a number of interface adapters, conventionally although not necessarily in the form of adapter cards, such as but not limited to: input output interfaces (I/O) 908, storage interfaces 909, network interfaces 910, and/or the like. Optionally, cryptographic processor interfaces 927 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 909 may accept, communicate, and/or connect to a number of storage devices such as, but not limited to: storage devices 914, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 910 may accept, communicate, and/or connect to a communications network 913. Through a communications network 913, the MHM controller is accessible through remote clients 933b (e.g., computers with web browsers) by users 933a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MHM), architectures may similarly be employed to pool, load balance, and/or otherwise increase the communicative bandwidth required by the MHM controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 910 may be used to engage with various communications network types 913. For example, multiple network interfaces may be employed to allow for the communication over broadcast, multicast, and/or unicast networks.

Input Output interfaces (I/O) 908 may accept, communicate, and/or connect to user input devices 911, peripheral devices 912, cryptographic processor devices 928, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 911 may be card readers, dongles, finger print readers, gloves, graphics tablets, joysticks, keyboards, mouse (mice), remote controls, retina readers, trackballs, trackpads, and/or the like.

Peripheral devices 912 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the MHM controller may be embodied as an embedded, dedicated, and/or monitor-less (i.e., headless) device, wherein access would be provided over a network interface connection.

Cryptographic units such as, but not limited to, microcontrollers, processors 926, interfaces 927, and/or devices 928 may be attached, and/or communicate with the MHM controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 929. However, memory is a fungible technology and resource, thus, any number of memory embodiments may be employed in lieu of or in concert with one another. It is to be understood that the MHM controller and/or a computer systemization may employ various forms of memory 929. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 929 will include ROM 906, RAM 905, and a storage device 914. A storage device 914 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 929 may contain a collection of program and/or database components and/or data such as, but not limited to: operating system component(s) 915 (operating system); information server component(s) 916 (information server); user interface component(s) 917 (user interface); Web browser component(s) 918 (Web browser); database(s) 919; mail server component(s) 921; mail client component(s) 922; cryptographic server component(s) 920 (cryptographic server); the MHM component(s) 935; and/or the like (i.e., collectively a component collection). These components may be stored and accessed from the storage devices and/or from storage devices accessible through an interface bus. Although non-conventional program components such as those in the component collection, typically, are stored in a local storage device 914, they may also be loaded and/or stored in memory such as: peripheral devices, RAM, remote storage facilities through a communications network, ROM, various forms of memory, and/or the like.

### Operating System

The operating system component 915 is an executable program component facilitating the operation of the MHM controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MHM controller to communicate with other entities through a communications network 913. Various communication protocols may be used by the MHM controller as a subcarrier transport mechanism for interaction, such as, but not limited to: multicast, TCP/IP, UDP, unicast, and/or the like.

### Information Server

An information server component 916 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MHM controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MHM database 919, operating systems, other program components, user interfaces, Web browsers, and/or the like.

Access to the MHM database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MHM. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MHM as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 917 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 918 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the MHM enabled nodes. The combined application may be nugatory on systems employing standard Web browsers.

### Mail Server

A mail server component 921 is a stored program component that is executed by a CPU 903. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MHM.

Access to the MHM mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 922 is a stored program component that is executed by a CPU 903. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 920 is a stored program component that is executed by a CPU 903, cryptographic processor 926, cryptographic processor interface 927, cryptographic processor device 928, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MHM may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MHM component to engage in secure transactions if so desired. The cryptographic component facilitates the secure accessing of resources on the MHM and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MHM Database

The MHM database component 919 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MHM database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the MHM database is implemented as a data-structure, the use of the MHM database 919 may be integrated into another component such as the MHM component 935. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 919 includes several tables 919a-h. A UserProfiles table 919a may include fields such as, but not limited to: user_ID, ssn, first_name, last_name, middle_name, suffix, prefix, address_first_line, address_second_line, city, state, zipcode, country, birth_date, gender, device_ID_list, device_name_list, device_type_list, hardware_configuration_list, software_apps_list, device_IP_list, device_MAC_list, device_preferences_list, media_resolution, media_type, media_format, language, cuisine, diet, GPS_enable, longitude_latitude, contact_method_preference, contact_information, language_preference, user_char_list, risk_factor_list, cultural_preference_list, cuisine_preference, and/or the like, gender, age, weight, preferred healthcare provider, health insurance provider, and pharmacy, store, and/or the like. A MedicalRecords 919b may include fields such as, but not limited to: user_ID, ssn, age, weight, body_mass_index, conditions_list, conditions_history_list, risk_factors_list, allergies_list, activities_list, current_medications_list, past_medications_list, medical_procedures_list, insurance_providers_list, healthcare_providers_list, healthcare_professionals_list, and/or the like. A GoalsMilestones table 919c may include fields such as, but not limited to: user_ID, ssn, milestones_list, milestones_timestamps, milestones_values, and/or the like. A HealthcareInformation table 919d may include fields such as, but not limited to: medical_devices_list, medical_procedures_list, prescription_drugs_list, generic_drugs_list, nutrition_list, medical_devices_detail, medical_procedures_detail, prescription_drugs_detail, generic_drugs_detail, nutrition_detail, cross_references_list and/or the like. A RichMediaHealthLibraries table 919e may include fields such as, but not limited to: media_ID, media_name, media_type, media_format, media_content_list, media_keywords_list, interactive_toggle and/or the like. A MobileHealthLabels table 919f may include fields such as, but not limited to: label_ID, label_name, product_name, procedure_name, medical_device_name, medical_device_ID, diet_name, nutriant_name, and/or the like. A Billing table 919g may include fields such as, but not limited to: affiliate_ID, affiliate_name, affiliate_terms, charge_per_click, charge_per_share, charge_milestone_per_time, charge_milestones, and/or the like. A Transactions table 919h may include fields such as, but not limited to: user_ID, ssn, number_clicks, number_shares, number_feedback, feedback_avg_quality, and/or the like. One or more of the tables discussed above may support and/or track multiple entity accounts on a MHM.

In one embodiment, the MHM database may interact with other database systems. For example, employing a distributed database system, queries and data access by search MHM component may treat the combination of the MHM database, an integrated data security layer database as a single database entity.

In one embodiment, user programs may contain various user interface primitives, which may serve to update the MHM. Also, various accounts may require custom database tables depending upon the environments and the types of clients the MHM may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 919a-s. The MHM may be configured to keep track of various settings, inputs, and parameters via database controllers.

The MHM database may communicate to and/or with other components in a component collection, including itself, and/or facilities of the like. Most frequently, the MHM database communicates with the MHM component, other program components, and/or the like. The database may contain, retain, and provide information regarding other nodes and data.

### The MHMs

The MHM component 935 is a stored program component that is executed by a CPU. In one embodiment, the MHM component incorporates any and/or all combinations of the aspects of the MHM that was discussed in the previous figures. As such, the MHM affects accessing, obtaining and the provision of information, services, transactions, and/or the like across various communications networks.

The MHM component enables an elegant and consistent multimedia interactive reference standard to maximize personal understanding of health information and coach individuals toward better health outcomes, and/or the like and use of the MHM.

The MHM component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MHM server employs a cryptographic server to encrypt and decrypt communications. The MHM component may communicate to and/or with other components in a component collection, including itself, and/or facilities of the like. Most frequently, the MHM component communicates with the MHM database, operating systems, other program components, and/or the like. The MHM may contain, communicate, generate, obtain, and/or provide program component, system, user, and/or data communications, requests, and/or responses.

### Distributed MHMs

The structure and/or operation of any of the MHM node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques. For example, MHM server(s) and database(s) may all be localized within a single computing terminal. As another example, the MHM components may be localized within one or more entities (e.g., hospitals, pharmaceutical companies etc.) involved in coordinated patient management.

The configuration of the MHM controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse communications data. Further, the parsing grammar may be used beyond message parsing, but may also be used to parse: databases, data collections, data stores, structured data, and/or the like. Again, the desired configuration will depend upon the context, environment, and requirements of system deployment.

Non-limiting exemplary embodiments highlighting numerous further advantageous aspects include:

A1. A prescription media delivery processor-implemented method embodiment, comprising:
obtaining a trigger media object including information on a trigger for coordinated patient management for a user;
decoding a healthcare information object identifier from the obtained trigger media object;
identifying via a processor a prescription media object to provide for the user based on the healthcare information object identifier; and
providing the identified prescription media object for the user.

A2. The method of embodiment A1, further comprising:
obtaining user preferences on attributes of the prescription media object;
wherein identifying the prescription media object to provide for the user is further based on the obtained user preferences on attributes of the prescription media object.

A3. The method of embodiment A1, further comprising:
obtaining a device attribute of a device associated with the user;
wherein identifying the prescription media object to provide for the user is further based on the obtained device attribute of the device associated with the user.

A4. The method of embodiment A1, further comprising:
obtaining a medical history record of the user; and
extracting health information from the medical history record of the user;
wherein identifying the prescription media object to provide for the user is further based on the health information extracted from the medical history record of the user.

A5. The method of embodiment A1, wherein the provided prescription media object includes user-interactive content.

A6. The method of embodiment A1, wherein the prescription media object includes at least one of: an informational; a tutorial; a demonstration; and a newsfeed.

A7. The method of embodiment A1, wherein the prescription media object includes content on at least one of: a health condition; a medical procedure; a medical device; a pharmaceutical product; and a nutrient.

A8. The method of embodiment A1, wherein the identified prescription media object includes content related to compliance with a regulatory requirement.

A9. A prescription media delivery system embodiment, comprising:
a processor; and
a memory disposed in communication with the processor and storing processor-executable instructions, the instructions comprising instructions to:
   obtain a trigger media object including information on a trigger for coordinated patient management for a user;
   decode a healthcare information object identifier from the obtained trigger media object;
   identify a prescription media object to provide for the user based on the healthcare information object identifier; and
   provide the identified prescription media object for the user.

A10. The system of embodiment A9, the instructions further comprising instructions to:
obtain user preferences on attributes of the prescription media object;
wherein identifying the prescription media object to provide for the user is further based on the obtained user preferences on attributes of the prescription media object.

A11. The system of embodiment A9, the instructions further comprising instructions to:
obtain a device attribute of a device associated with the user;
wherein identifying the prescription media object to provide for the user is further based on the obtained device attribute of the device associated with the user.

A12. The system of embodiment A9, the instructions further comprising instructions to:
obtain a medical history record of the user; and
extract health information from the medical history record of the user;
wherein identifying the prescription media object to provide for the user is further based on the health information extracted from the medical history record of the user.

A13. The system of embodiment A9, wherein the provided prescription media object includes user-interactive content.

A14. The system of embodiment A9, wherein the prescription media object includes at least one of: an informational; a tutorial; a demonstration; and a newsfeed.

A15. The system of embodiment A9, wherein the prescription media object includes content on at least one of: a health condition; a medical procedure; a medical device; a pharmaceutical product; and a nutrient.

A16. The system of embodiment A9, wherein the identified prescription media object includes content related to compliance with a regulatory requirement.

A17. A processor-readable medium embodiment storing processor-executable prescription media delivery instructions, the instructions comprising instructions to:
obtain a trigger media object including information on a trigger for coordinated patient management for a user;
decode a healthcare information object identifier from the obtained trigger media object;
identify a prescription media object to provide for the user based on the healthcare information object identifier; and
provide the identified prescription media object for the user.

A18. The medium of embodiment A17, the instructions further comprising instructions to:
obtain user preferences on attributes of the prescription media object;
wherein identifying the prescription media object to provide for the user is further based on the obtained user preferences on attributes of the prescription media object.

A19. The medium of embodiment A17, the instructions further comprising instructions to:
obtain a device attribute of a device associated with the user;
wherein identifying the prescription media object to provide for the user is further based on the obtained device attribute of the device associated with the user.

A20. The medium of embodiment A17, the instructions further comprising instructions to:
obtain a medical history record of the user; and
extract health information from the medical history record of the user;
wherein identifying the prescription media object to provide for the user is further based on the health information extracted from the medical history record of the user.

A21. The medium of embodiment A17, wherein the provided prescription media object includes user-interactive content.

A22. The medium of embodiment A17, wherein the prescription media object includes at least one of: an informational; a tutorial; a demonstration; and a newsfeed.

A23. The medium of embodiment A17, wherein the prescription media object includes content on at least one of: a health condition; a medical procedure; a medical device; a pharmaceutical product; and a nutrient.

A24. The medium of embodiment A17, wherein the identified prescription media object includes content related to compliance with a regulatory requirement.

A25. A prescription media request processor-implemented method embodiment, comprising:
generating via a processor a trigger media object including information on a trigger for coordinated patient management for a user;
providing the trigger media object;
obtaining a prescription media object including health information in response to providing the trigger media object; and
presenting the prescription media object for the user.

A26. The method of embodiment A25, further comprising:
providing a user preference for an attribute of the prescription media object;
wherein the attribute of the prescription media object obtained in response to providing the trigger media object matches the provided user preference for the attribute of the prescription media object.

A27. The method of embodiment A25, further comprising:
providing a device attribute of a device associated with the user;
wherein an attribute of the obtained prescription media object corresponding to the provided device attribute of the device matches the device attribute.

A28. The method of embodiment A25, further comprising:
providing health information of the user;
wherein an attribute of the obtained prescription media object is based on the provided health information of the user.

A29. The method of embodiment A25, wherein the obtained prescription media object includes user-interactive content.

A30. The method of embodiment A25, wherein the obtained prescription media object includes at least one of: an informational; a tutorial; a demonstration; and a newsfeed.

A31. The method of embodiment A25, wherein the obtained prescription media object includes content on at least one of: a health condition; a medical procedure; a medical device; a pharmaceutical product; and a nutrient.

A32. The method of embodiment A25, wherein the obtained prescription media object includes content related to compliance with a regulatory requirement.

A33. A prescription media request apparatus embodiment, comprising:
a processor; and
a memory disposed in communication with the processor and storing processor-executable instructions, the instructions comprising instructions to:
   generate a trigger media object including information on a trigger for coordinated patient management for a user;
   provide the trigger media object;
   obtain a prescription media object including health information in response to providing the trigger media object; and
   present the prescription media object for the user.

A34. The apparatus of embodiment A33, the instructions further comprising instructions to:
provide a user preference for an attribute of the prescription media object;
wherein the attribute of the prescription media object obtained in response to providing the trigger media object matches the provided user preference for the attribute of the prescription media object.

A35. The apparatus of embodiment A33, the instructions further comprising instructions to:
provide a device attribute of a device associated with the user;
wherein an attribute of the obtained prescription media object corresponding to the provided device attribute of the device matches the device attribute.

A36. The apparatus of embodiment A33, the instructions further comprising instructions to:
provide health information of the user;
wherein an attribute of the obtained prescription media object is based on the provided health information of the user.

A37. The apparatus of embodiment A33, wherein the obtained prescription media object includes user-interactive content.

A38. The apparatus of embodiment A33, wherein the obtained prescription media object includes at least one of: an informational; a tutorial; a demonstration; and a newsfeed.

A39. The apparatus of embodiment A33, wherein the obtained prescription media object includes content on at least one of: a health condition; a medical procedure; a medical device; a pharmaceutical product; and a nutrient.

A40. The apparatus of embodiment A33, wherein the obtained prescription media object includes content related to compliance with a regulatory requirement.

A41. A processor-readable medium embodiment storing processor-executable prescription media request instructions, the instructions comprising instructions to:
generate a trigger media object including information on a trigger for coordinated patient management for a user;
provide the trigger media object;
obtain a prescription media object including health information in response to providing the trigger media object; and
present the prescription media object for the user.

A42. The medium of embodiment A41, the instructions further comprising instructions to:
provide a user preference for an attribute of the prescription media object;
wherein the attribute of the prescription media object obtained in response to providing the trigger media object matches the provided user preference for the attribute of the prescription media object.

A43. The medium of embodiment A41, the instructions further comprising instructions to:
provide a device attribute of a device associated with the user;
wherein an attribute of the obtained prescription media object corresponding to the provided device attribute of the device matches the device attribute.

A44. The medium of embodiment A41, the instructions further comprising instructions to:
provide health information of the user;
wherein an attribute of the obtained prescription media object is based on the provided health information of the user.

A45. The medium of embodiment A41, wherein the obtained prescription media object includes user-interactive content.

A46. The medium of embodiment A41, wherein the obtained prescription media object includes at least one of: an informational; a tutorial; a demonstration; and a newsfeed.

A47. The medium of embodiment A41, wherein the obtained prescription media object includes content on at least one of: a health condition; a medical procedure; a medical device; a pharmaceutical product; and a nutrient.

A48. The medium of embodiment A41, wherein the obtained prescription media object includes content related to compliance with a regulatory requirement.

B1. A prescription comprehension validation processor-implemented method embodiment, comprising:
obtaining a coordinated patient management trigger;
identifying via a processor a prescription media object to provide for a user based on the obtained trigger;
providing the identified prescription media object for the user;
providing a request for user feedback to the provided prescription media object; and
obtaining the user feedback to the provided prescription media object.

B2. The method of embodiment B1, wherein:
the provided prescription media object includes user-interactive content; and
the user feedback to the provided prescription media object is obtained via the user-interactive content included in the prescription media object.

B3. The method of embodiment B1, further comprising:
analyzing the obtained user feedback to the provided prescription media object; and
validating, based on the analysis, user comprehension of information included in the provided prescription media object based on the obtained user feedback to the provided prescription media object.

B4. The method of embodiment B3, further comprising:
providing an indication of a financial reward for the user, upon validating user comprehension of the information included in the provided prescription media object.

B5. The method of embodiment B3, further comprising:
providing an indication that a healthcare service provider will provide a healthcare service for the user, upon validating user comprehension of the information included in the provided prescription media object.

B6. The method of embodiment B1, wherein the prescription media object is provided to a mobile electronic device of the user.

B7. The method of embodiment B1, wherein the request for user feedback includes a request for a patient reported outcome.

B8. A prescription comprehension validation system embodiment, comprising:
a processor; and
a memory disposed in communication with the processor and storing processor-executable instructions, the instructions comprising instructions to:
   obtain a coordinated patient management trigger;
   identify a prescription media object to provide for a user based on the obtained trigger;
   provide the identified prescription media object for the user;
   provide a request for user feedback to the provided prescription media object; and
   obtain the user feedback to the provided prescription media object.

B9. The system of embodiment B8, wherein:
the provided prescription media object includes user-interactive content; and
the user feedback to the provided prescription media object is obtained via the user-interactive content included in the prescription media object.

B10. The system of embodiment B8, the instructions further comprising instructions to:
analyze the obtained user feedback to the provided prescription media object; and
validate, based on the analysis, user comprehension of information included in the provided prescription media object based on the obtained user feedback to the provided prescription media object.

B11. The system of embodiment B10, the instructions further comprising instructions to:
provide an indication of a financial reward for the user, upon validating user comprehension of the information included in the provided prescription media object.

B12. The system of embodiment B10, the instructions further comprising instructions to:
provide an indication that a healthcare service provider will provide a healthcare service for the user, upon validating user comprehension of the information included in the provided prescription media object.

B13. The system of embodiment B8, wherein the prescription media object is provided to a mobile electronic device of the user.

B14. The system of embodiment B8, wherein the request for user feedback includes a request for a patient reported outcome.

B15. A processor-readable medium embodiment storing processor-executable prescription comprehension validation instructions, the instructions comprising instructions to:
obtain a coordinated patient management trigger;
identify a prescription media object to provide for a user based on the obtained trigger;
provide the identified prescription media object for the user;
provide a request for user feedback to the provided prescription media object; and
obtain the user feedback to the provided prescription media object.

B16. The medium of embodiment B15, wherein:
the provided prescription media object includes user-interactive content; and
the user feedback to the provided prescription media object is obtained via the user-interactive content included in the prescription media object.

B17. The medium of embodiment B15, the instructions further comprising instructions to:
analyze the obtained user feedback to the provided prescription media object; and
validate, based on the analysis, user comprehension of information included in the provided prescription media object based on the obtained user feedback to the provided prescription media object.

B18. The medium of embodiment B17, the instructions further comprising instructions to:
provide an indication of a financial reward for the user, upon validating user comprehension of the information included in the provided prescription media object.

B19. The medium of embodiment B17, the instructions further comprising instructions to:
provide an indication that a healthcare service provider will provide a healthcare service for the user, upon validating user comprehension of the information included in the provided prescription media object.

B20. The medium of embodiment B15, wherein the prescription media object is provided to a mobile electronic device of the user.

B21. The medium of embodiment B15, wherein the request for user feedback includes a request for a patient reported outcome.

B22. A prescription comprehension confirmation processor-implemented method embodiment, comprising:
generating via a processor a coordinated patient management trigger;
providing the coordinated patient management trigger;
obtaining a prescription media object in response to providing the coordinated patient management trigger;
presenting the obtained prescription media object for the user;
obtaining a request for user feedback to the obtained prescription media object; and
providing the user feedback to the obtained prescription media object.

B23. The method of embodiment B22, wherein:
the obtained prescription media object includes user-interactive content; and
the user feedback to the obtained prescription media object is provided via the user-interactive content included in the prescription media object.

B24. The method of embodiment B22, further comprising:
obtaining an indication of validation of user comprehension of information in the obtained prescription media object, in response to providing the user feedback to the obtained prescription media object.

B25. The method of embodiment B22, further comprising:
obtaining an indication of a financial reward for the user, in response to providing the user feedback to the obtained prescription media object.

B26. The method of embodiment B22, further comprising:
obtaining an indication that a healthcare service provider will provide a healthcare service for the user, in response to providing the user feedback to the obtained prescription media object.

B27. The method of embodiment B22, wherein the processor is included within a mobile electronic device.

B28. The method of embodiment B22, wherein providing the user feedback to the obtained prescription media object includes providing a patient reported outcome.

B29. A prescription comprehension confirmation apparatus embodiment, comprising:
a processor; and
a memory disposed in communication with the processor and storing processor-executable instructions, the instructions comprising instructions to:
   generate a coordinated patient management trigger;
   provide the coordinated patient management trigger;
   obtain a prescription media object in response to providing the coordinated patient management trigger;
   present the obtained prescription media object for the user;
   obtain a request for user feedback to the obtained prescription media object; and
   provide the user feedback to the obtained prescription media object.

B30. The apparatus of embodiment B29, wherein:
the obtained prescription media object includes user-interactive content; and
the user feedback to the obtained prescription media object is provided via the user-interactive content included in the prescription media object.

B31. The apparatus of embodiment B29, the instructions further comprising instructions to:
obtain an indication of validation of user comprehension of information in the obtained prescription media object, in response to providing the user feedback to the obtained prescription media object.

B32. The apparatus of embodiment B29, the instructions further comprising instructions to:
obtain an indication of a financial reward for the user, in response to providing the user feedback to the obtained prescription media object.

B33. The apparatus of embodiment B29, the instructions further comprising instructions to:
obtain an indication that a healthcare service provider will provide a healthcare service for the user, in response to providing the user feedback to the obtained prescription media object.

B34. The apparatus of embodiment B29, wherein the processor is included within a mobile electronic device.

B35. The apparatus of embodiment B29, wherein providing the user feedback to the obtained prescription media object includes providing a patient reported outcome.

B36. A processor-readable medium embodiment storing processor-executable prescription comprehension confirmation instructions, the instructions comprising instructions to:
generate a coordinated patient management trigger;
provide the coordinated patient management trigger;
obtain a prescription media object in response to providing the coordinated patient management trigger;
present the obtained prescription media object for the user;
obtain a request for user feedback to the obtained prescription media object; and
provide the user feedback to the obtained prescription media object.

B37. The medium of embodiment B36, wherein:
the obtained prescription media object includes user-interactive content; and
the user feedback to the obtained prescription media object is provided via the user-interactive content included in the prescription media object.

B38. The medium of embodiment B36, the instructions further comprising instructions to:
obtain an indication of validation of user comprehension of information in the obtained prescription media object, in response to providing the user feedback to the obtained prescription media object.

B39. The medium of embodiment B36, the instructions further comprising instructions to:
obtain an indication of a financial reward for the user, in response to providing the user feedback to the obtained prescription media object.

B40. The medium of embodiment B36, the instructions further comprising instructions to:
obtain an indication that a healthcare service provider will provide a healthcare service for the user, in response to providing the user feedback to the obtained prescription media object.

B41. The medium of embodiment B36, wherein the medium is included within a mobile electronic device.

B42. The medium of embodiment B36, wherein providing the user feedback to the obtained prescription media object includes providing a patient reported outcome.

C1. A prescription optimization processor-implemented method embodiment, comprising:
obtaining a coordinated patient management trigger for a user;
obtaining a medical history record of the user using the obtained trigger;
analyzing, via a processor, the obtained medical history record of the user;
identifying, based on the analysis of the medical history record, a current treatment plan for the user;
generating a user feedback request based on the identified current treatment plan; and
providing the user feedback request to a user device of the user.

C2. The method of embodiment C1, further comprising:
obtaining user feedback in response to providing the user feedback request;
analyzing the obtained user feedback based on the current treatment plan for the user;
generating a modified treatment plan for the user based on the analysis of the obtained user feedback; and
providing the modified treatment plan for the user.

C3. The method of embodiment C2, further comprising:
providing a request for acknowledgment of the modified treatment plan to the user device of the user; and
obtaining acknowledgment of the modified treatment plan in response to providing the request for acknowledgment.

C4. The method of embodiment C1, wherein the user feedback request includes a request for a patient reported outcome.

C5. The method of embodiment C1, wherein the user feedback request includes a request for acknowledgment that the user administered a prescribed dosage of a treatment included in the current treatment plan.

C6. The method of embodiment C1, wherein the user feedback request includes a request for a media object capturing information related to a medical condition of the user.

C7. The method of embodiment C1, wherein the user device is a mobile electronic device.

C8. A prescription optimization system embodiment, comprising:
a processor; and
a memory disposed in communication with the processor and storing processor-executable instructions, the instructions comprising instructions to:
   obtain a coordinated patient management trigger for a user;
   obtain a medical history record of the user using the obtained trigger;
   analyze the obtained medical history record of the user;
   identify, based on the analysis of the medical history record, a current treatment plan for the user;
   generate a user feedback request based on the identified current treatment plan; and
   provide the user feedback request to a user device of the user.

C9. The system of embodiment C8, the instructions further comprising instructions to:
obtain user feedback in response to providing the user feedback request;
analyze the obtained user feedback based on the current treatment plan for the user;
generate a modified treatment plan for the user based on the analysis of the obtained user feedback; and
provide the modified treatment plan for the user.

C10. The system of embodiment C9, the instructions further comprising instructions to:
provide a request for acknowledgment of the modified treatment plan to the user device of the user; and
obtain acknowledgment of the modified treatment plan in response to providing the request for acknowledgment.

C11. The system of embodiment C8, wherein the user feedback request includes a request for a patient reported outcome.

C12. The system of embodiment C8, wherein the user feedback request includes a request for acknowledgment that the user administered a prescribed dosage of a treatment included in the current treatment plan.

C13. The system of embodiment C8, wherein the user feedback request includes a request for a media object capturing information related to a medical condition of the user.

C14. The system of embodiment C8, wherein the user device is a mobile electronic device.

C15. A processor-readable medium embodiment storing processor-executable prescription optimization instructions, the instructions comprising instructions to:
obtain a coordinated patient management trigger for a user;
obtain a medical history record of the user using the obtained trigger;
analyze the obtained medical history record of the user;
identify, based on the analysis of the medical history record, a current treatment plan for the user;
generate a user feedback request based on the identified current treatment plan; and
provide the user feedback request to a user device of the user.

C16. The medium of embodiment C15, the instructions further comprising instructions to:
obtain user feedback in response to providing the user feedback request;
analyze the obtained user feedback based on the current treatment plan for the user;
generate a modified treatment plan for the user based on the analysis of the obtained user feedback; and
provide the modified treatment plan for the user.

C17. The medium of embodiment C16, the instructions further comprising instructions to:
provide a request for acknowledgment of the modified treatment plan to the user device of the user; and
obtain acknowledgment of the modified treatment plan in response to providing the request for acknowledgment.

C18. The medium of embodiment C15, wherein the user feedback request includes a request for a patient reported outcome.

C19. The medium of embodiment C15, wherein the user feedback request includes a request for acknowledgment that the user administered a prescribed dosage of a treatment included in the current treatment plan.

C20. The medium of embodiment C15, wherein the user feedback request includes a request for a media object capturing information related to a medical condition of the user.

C21. The medium of embodiment C15, wherein the user device is a mobile electronic device.

C22. A treatment progress reporting processor-implemented method embodiment, comprising:
generating a coordinated patient management trigger for a user;
providing the coordinated patient management trigger;
obtaining a request for user feedback on a current treatment plan;
generating, via a processor, the user feedback on the current treatment plan, upon obtaining the request for user feedback; and
providing the generated user feedback on the current treatment plan.

C23. The method of embodiment C22, further comprising:
obtaining a modified treatment plan for the user, upon providing the generated user feedback on the current treatment plan;
obtaining a request for acknowledgment of the modified treatment plan for the user; and
providing the acknowledgment of the modified treatment plan for the user.

C24. The method of embodiment C23, further comprising:
obtaining a request for user feedback on the modified treatment plan, upon providing the acknowledgment of the modified treatment plan for the user;
generating the user feedback on the modified treatment plan, upon obtaining the request for user feedback on the modified treatment plan; and
providing the generated user feedback on the modified treatment plan.

C25. The method of embodiment C22, wherein the user feedback includes a patient reported outcome.

C26. The method of embodiment C22, wherein the user feedback includes an acknowledgment that the user administered a prescribed dosage of a treatment included in the current treatment plan.

C27. The method of embodiment C22, wherein the user feedback includes a media object capturing information related to a medical condition of the user.

C28. The method of embodiment C22, wherein the processor is included within a mobile electronic device.

C29. A treatment progress reporting apparatus embodiment, comprising:
a processor; and
a memory disposed in communication with the processor and storing processor-executable instructions, the instructions comprising instructions to:
   generate a coordinated patient management trigger for a user;
   provide the coordinated patient management trigger;
   obtain a request for user feedback on a current treatment plan;
   generate the user feedback on the current treatment plan, upon obtaining the request for user feedback; and
   provide the generated user feedback on the current treatment plan.

C30. The apparatus of embodiment C29, the instructions further comprising instructions to:
obtain a modified treatment plan for the user, upon providing the generated user feedback on the current treatment plan;
obtain a request for acknowledgment of the modified treatment plan for the user; and
provide the acknowledgment of the modified treatment plan for the user.

C31. The apparatus of embodiment C30, the instructions further comprising instructions to:
obtain a request for user feedback on the modified treatment plan, upon providing the acknowledgment of the modified treatment plan for the user;
generate the user feedback on the modified treatment plan, upon obtaining the request for user feedback on the modified treatment plan; and
provide the generated user feedback on the modified treatment plan.

C32. The apparatus of embodiment C29, wherein the user feedback includes a patient reported outcome.

C33. The apparatus of embodiment C29, wherein the user feedback includes an acknowledgment that the user administered a prescribed dosage of a treatment included in the current treatment plan.

C34. The apparatus of embodiment C29, wherein the user feedback includes a media object capturing information related to a medical condition of the user.

C35. The apparatus of embodiment C29, wherein the processor is included within a mobile electronic device.

C36. A processor-readable medium embodiment storing processor-executable treatment progress reporting instructions, the instructions comprising instructions to:
generate a coordinated patient management trigger for a user;
provide the coordinated patient management trigger;
obtain a request for user feedback on a current treatment plan;
generate the user feedback on the current treatment plan, upon obtaining the request for user feedback; and
provide the generated user feedback on the current treatment plan.

C37. The medium of embodiment C36, the instructions further comprising instructions to:
obtain a modified treatment plan for the user, upon providing the generated user feedback on the current treatment plan;
obtain a request for acknowledgment of the modified treatment plan for the user; and
provide the acknowledgment of the modified treatment plan for the user.

C38. The medium of embodiment C37, the instructions further comprising instructions to:
obtain a request for user feedback on the modified treatment plan, upon providing the acknowledgment of the modified treatment plan for the user;
generate the user feedback on the modified treatment plan, upon obtaining the request for user feedback on the modified treatment plan; and
provide the generated user feedback on the modified treatment plan.

C39. The medium of embodiment C36, wherein the user feedback includes a patient reported outcome.

C40. The medium of embodiment C36, wherein the user feedback includes an acknowledgment that the user administered a prescribed dosage of a treatment included in the current treatment plan.

C41. The medium of embodiment C36, wherein the user feedback includes a media object capturing information related to a medical condition of the user.

C42. The medium of embodiment C36, wherein the medium is included within a mobile electronic device.

D1. A patient adherence processor-implemented method embodiment, comprising:
obtaining a user identification of a user;
obtaining a medical history record of the user using the obtained user identification;
analyzing the obtained medical history record of the user;
identifying, based on the analysis of the medical history record, a treatment plan for the user;
analyzing, via a processor, the treatment plan for the user; and
identifying, based on the analysis of the treatment plan for the user, milestones included in the treatment plan for the user.

D2. The method of embodiment D1, further comprising:
providing a request to enroll the user in a patient adherence program;
obtaining an indication of acceptance to enroll the user in a patient adherence program; and
updating a user profile of the user to indicate enrollment of the user in the patient adherence program.

D3. The method of embodiment D1, further comprising:
determining progress of the user towards one of the milestones included in the treatment plan for the user based on analyzing the obtained medical history record of the user;
identifying a media prescription object to provide for the user based on the determined progress of the user towards the milestone; and
providing the identified media prescription object for the user.

D4. The method of embodiment D1, further comprising:
providing a user feedback request;
obtaining user feedback in response to providing the user feedback request;
analyzing the obtained user feedback; and
determining whether one of the milestones included in the treatment plan for the user has been achieved based on analyzing the obtained user feedback.

D5. The method of embodiment D4, further comprising:
obtaining an indication that the milestone included in the treatment plan for the user has been achieved;
determining whether a new milestone should be included in the treatment plan for the user;
generating a new milestone for inclusion in the treatment plan for the user, upon determining that the new milestone should be included in the treatment plan for the user;
generating a modified treatment plan for the user based on the new milestone and the achieved milestone; and
updating the medical history record of the user based on the modified treatment plan.

D6. The method of embodiment D1, further comprising:
populating a calendar stored on a user device of the user with reminders corresponding to the milestones included in the treatment plan for the user.

D7. The method of embodiment D1, further comprising:
providing a request for refilling medical prescriptions for the user based on the milestones included in the treatment plan for the user.

D8. The method of embodiment D1, wherein one of the milestones included in the treatment plan for the user is related to discharge of the user from a healthcare facility.

D9. A patient adherence system embodiment, comprising:
a processor; and
a memory disposed in communication with the processor and storing processor-executable instructions, the instructions comprising instructions to:
   obtain a user identification of a user;
   obtain a medical history record of the user using the obtained user identification;
   analyze the obtained medical history record of the user;
   identify, based on the analysis of the medical history record, a treatment plan for the user;
   analyze the treatment plan for the user; and
   identify, based on the analysis of the treatment plan for the user, milestones included in the treatment plan for the user.

D10. The system of embodiment D9, the instructions further comprising instructions to:
provide a request to enroll the user in a patient adherence program;
obtain an indication of acceptance to enroll the user in a patient adherence program; and
update a user profile of the user to indicate enrollment of the user in the patient adherence program.

D11. The system of embodiment D9, the instructions further comprising instructions to:
determine progress of the user towards one of the milestones included in the treatment plan for the user based on analyzing the obtained medical history record of the user;
identify a media prescription object to provide for the user based on the determined progress of the user towards the milestone; and
provide the identified media prescription object for the user.

D12. The system of embodiment D9, the instructions further comprising instructions to:
provide a user feedback request;
obtain user feedback in response to providing the user feedback request;
analyze the obtained user feedback; and
determine whether one of the milestones included in the treatment plan for the user has been achieved based on analyzing the obtained user feedback.

D13. The system of embodiment D12, the instructions further comprising instructions to:
obtain an indication that the milestone included in the treatment plan for the user has been achieved;
determine whether a new milestone should be included in the treatment plan for the user;
generate a new milestone for inclusion in the treatment plan for the user, upon determining that the new milestone should be included in the treatment plan for the user;
generate a modified treatment plan for the user based on the new milestone and the achieved milestone; and
update the medical history record of the user based on the modified treatment plan.

D14. The system of embodiment D9, the instructions further comprising instructions to:
populate a calendar stored on a user device of the user with reminders corresponding to the milestones included in the treatment plan for the user.

D15. The system of embodiment D9, the instructions further comprising instructions to:
provide a request for refilling medical prescriptions for the user based on the milestones included in the treatment plan for the user.

D16. The system of embodiment D10, wherein one of the milestones included in the treatment plan for the user is related to discharge of the user from a healthcare facility.

D17. A processor-readable medium embodiment storing processor-executable patient adherence instructions, the instructions comprising instructions to:
obtain a user identification of a user;
obtain a medical history record of the user using the obtained user identification;
analyze the obtained medical history record of the user;
identify, based on the analysis of the medical history record, a treatment plan for the user;
analyze the treatment plan for the user; and
identify, based on the analysis of the treatment plan for the user, milestones included in the treatment plan for the user.

D18. The medium of embodiment D17, the instructions further comprising instructions to:
provide a request to enroll the user in a patient adherence program;
obtain an indication of acceptance to enroll the user in a patient adherence program; and
update a user profile of the user to indicate enrollment of the user in the patient adherence program.

D19. The medium of embodiment D17, the instructions further comprising instructions to:
determine progress of the user towards one of the milestones included in the treatment plan for the user based on analyzing the obtained medical history record of the user;
identify a media prescription object to provide for the user based on the determined progress of the user towards the milestone; and
provide the identified media prescription object for the user.

D20. The medium of embodiment D17, the instructions further comprising instructions to:
provide a user feedback request;
obtain user feedback in response to providing the user feedback request;
analyze the obtained user feedback; and
determine whether one of the milestones included in the treatment plan for the user has been achieved based on analyzing the obtained user feedback.

D21. The medium of embodiment D20, the instructions further comprising instructions to:
obtain an indication that the milestone included in the treatment plan for the user has been achieved;
determine whether a new milestone should be included in the treatment plan for the user;
generate a new milestone for inclusion in the treatment plan for the user, upon determining that the new milestone should be included in the treatment plan for the user;
generate a modified treatment plan for the user based on the new milestone and the achieved milestone; and
update the medical history record of the user based on the modified treatment plan.

D22. The medium of embodiment D17, the instructions further comprising instructions to:
populate a calendar stored on a user device of the user with reminders corresponding to the milestones included in the treatment plan for the user.

D23. The medium of embodiment D17, the instructions further comprising instructions to:
provide a request for refilling medical prescriptions for the user based on the milestones included in the treatment plan for the user.

D24. The medium of embodiment D17, wherein one of the milestones included in the treatment plan for the user is related to discharge of the user from a healthcare facility.

E1. A healthcare service provider performance incentivisation processor-implemented method embodiment, comprising:
providing prescription media objects for a plurality of users, wherein the prescription media objects are associated with a plurality of healthcare service providers;
obtaining usage feedback on the provided prescription media objects from the plurality of users;
aggregating the obtained usage feedback from the plurality of users; and
analyzing via a processor the aggregated usage feedback from the plurality of users.

E2. The method of embodiment E1, further comprising:
identifying a user trend based on the analysis of the aggregated usage feedback; and
generating a performance report for one of the healthcare service providers based on the identified user trend.

E3. The method of embodiment E2, wherein the identified user trend includes numbers of times the prescription media objects are provided for the plurality of users.

E4. The method of embodiment E2, further comprising:
wherein the usage feedback includes user feedback to the provided prescription media objects;
determining, for the plurality of users, percentages of user comprehension of information included in the provided prescription media objects based on the obtained user feedback to the provided prescription media objects; and
wherein generating the performance report for the healthcare service provider is based on the determination of the percentages of user comprehension of the information included in the provided prescription media objects.

E5. The method of embodiment E1, wherein:
the provided prescription media objects include user-interactive content; and
the usage feedback is obtained via the user-interactive content included in the provided prescription media objects.

E6. The method of embodiment E1, wherein the prescription media objects are provided to mobile electronic devices of the plurality of users.

E7. The method of embodiment E1, further comprising:
providing an indication of a financial reward for one of the users providing user feedback to the provided prescription media object.

E8. A healthcare service provider performance incentivisation system embodiment, comprising:
a processor; and
a memory disposed in communication with the processor and storing processor-executable instructions, the instructions comprising instructions to:
   provide prescription media objects for a plurality of users, wherein the prescription media objects are associated with a plurality of healthcare service providers;
   obtain usage feedback on the provided prescription media objects from the plurality of users;
   aggregate the obtained usage feedback from the plurality of users; and
   analyze the aggregated usage feedback from the plurality of users.

E9. The system of embodiment E8, the instructions further comprising instructions to:
identify a user trend based on the analysis of the aggregated usage feedback; and
generate a performance report for one of the healthcare service providers based on the identified user trend.

E10. The system of embodiment E9, wherein the identified user trend includes numbers of times the prescription media objects are provided for the plurality of users.

E11. The system of embodiment E9, the instructions further comprising instructions to:
wherein the usage feedback includes user feedback to the provided prescription media objects;
determine, for the plurality of users, percentages of user comprehension of information included in the provided prescription media objects based on the obtained user feedback to the provided prescription media objects; and
wherein generating the performance report for the healthcare service provider is based on the determination of the percentages of user comprehension of the information included in the provided prescription media objects.

E12. The system of embodiment E8, wherein:
the provided prescription media objects include user-interactive content; and
the usage feedback is obtained via the user-interactive content included in the provided prescription media objects.

E13. The system of embodiment E8, wherein the prescription media objects are provided to mobile electronic devices of the plurality of users.

E14. The system of embodiment E8, the instructions further comprising instructions to:
provide an indication of a financial reward for one of the users providing user feedback to the provided prescription media object.

E15. A processor-readable medium embodiment storing processor-executable healthcare service provider performance incentivisation instructions, the instructions comprising instructions to:
provide prescription media objects for a plurality of users, wherein the prescription media objects are associated with a plurality of healthcare service providers;
obtain usage feedback on the provided prescription media objects from the plurality of users;
aggregate the obtained usage feedback from the plurality of users; and
analyze the aggregated usage feedback from the plurality of users.

E16. The medium of embodiment E15, the instructions further comprising instructions to:
identify a user trend based on the analysis of the aggregated usage feedback; and
generate a performance report for one of the healthcare service providers based on the identified user trend.

E17. The medium of embodiment E16, wherein the identified user trend includes numbers of times the prescription media objects are provided for the plurality of users.

E18. The medium of embodiment E16, the instructions further comprising instructions to:
wherein the usage feedback includes user feedback to the provided prescription media objects;
determine, for the plurality of users, percentages of user comprehension of information included in the provided prescription media objects based on the obtained user feedback to the provided prescription media objects; and
wherein generating the performance report for the healthcare service provider is based on the determination of the percentages of user comprehension of the information included in the provided prescription media objects.

E19. The medium of embodiment E15, wherein:
the provided prescription media objects include user-interactive content; and
the usage feedback is obtained via the user-interactive content included in the provided prescription media objects.

E20. The medium of embodiment E15, wherein the prescription media objects are provided to mobile electronic devices of the plurality of users.

E21. The medium of embodiment E15, the instructions further comprising instructions to:
provide an indication of a financial reward for one of the users providing user feedback to the provided prescription media object.

F1. A healthcare content sharing processor-implemented method embodiment, comprising:
providing prescription media objects associated with a plurality of healthcare service providers to a plurality of users for sharing;
obtaining information on user sharing of the provided prescription media objects;
aggregating the information on user sharing of the provided prescription media objects; and
analyzing, via a processor, the aggregated information on user sharing of the provided prescription media objects.

F2. The method of embodiment F1, further comprising:
identifying a user trend based on analyzing the aggregated information on user sharing of the provided prescription media objects; and
generating a performance report for one of the healthcare service providers based on the identified user trend.

F3. The method of embodiment F1, wherein obtaining information on the user sharing of the provided prescription media objects includes obtaining numbers of views of the prescription media objects shared by the users.

F4. The method of embodiment F1, wherein:
the provided prescription media objects include user-interactive content; and
the information on user sharing of the provided prescription media objects is obtained via the user-interactive content included in the provided prescription media objects.

F5. The method of embodiment F1, wherein the prescription media objects are provided to mobile electronic devices of the plurality of users.

F6. The method of embodiment F1, further comprising:
providing an indication of a financial reward for one of the users sharing one of the provided prescription media objects.

F7. The method of embodiment F1, further comprising:
obtaining an indication of user sharing of one of the provided prescription media objects with a new user; and
providing a request for the new user to enroll with a healthcare service provider.

F8. A healthcare content sharing system embodiment, comprising:
a processor; and
a memory disposed in communication with the processor and storing processor-executable instructions, the instructions comprising instructions to:
   provide prescription media objects associated with a plurality of healthcare service providers to a plurality of users for sharing;
   obtain information on user sharing of the provided prescription media objects;
   aggregate the information on user sharing of the provided prescription media objects; and
   analyze the aggregated information on user sharing of the provided prescription media objects.

F9. The system of embodiment F8, the instructions further comprising instructions to:
identify a user trend based on analyzing the aggregated information on user sharing of the provided prescription media objects; and
generate a performance report for one of the healthcare service providers based on the identified user trend.

F10. The system of embodiment F8, wherein obtaining information on the user sharing of the provided prescription media objects includes obtaining numbers of views of the prescription media objects shared by the users.

F11. The system of embodiment F8, wherein:
the provided prescription media objects include user-interactive content; and
the information on user sharing of the provided prescription media objects is obtained via the user-interactive content included in the provided prescription media objects.

F12. The system of embodiment F8, wherein the prescription media objects are provided to mobile electronic devices of the plurality of users.

F13. The system of embodiment F8, the instructions further comprising instructions to:
provide an indication of a financial reward for one of the users sharing one of the provided prescription media objects.

F14. The system of embodiment F8, the instructions further comprising instructions to:
obtain an indication of user sharing of one of the provided prescription media objects with a new user; and
provide a request for the new user to enroll with a healthcare service provider.

F15. A processor-readable medium embodiment storing processor-executable healthcare content sharing instructions, the instructions comprising instructions to:
provide prescription media objects associated with a plurality of healthcare service providers to a plurality of users for sharing;
obtain information on user sharing of the provided prescription media objects;
aggregate the information on user sharing of the provided prescription media objects; and
analyze the aggregated information on user sharing of the provided prescription media objects.

F16. The medium of embodiment F15, the instructions further comprising instructions to:
identify a user trend based on analyzing the aggregated information on user sharing of the provided prescription media objects; and
generate a performance report for one of the healthcare service providers based on the identified user trend.

F17. The medium of embodiment F15, wherein obtaining information on the user sharing of the provided prescription media objects includes obtaining numbers of views of the prescription media objects shared by the users.

F18. The medium of embodiment F15, wherein:
the provided prescription media objects include user-interactive content; and
the information on user sharing of the provided prescription media objects is obtained via the user-interactive content included in the provided prescription media objects.

F19. The medium of embodiment F15, wherein the prescription media objects are provided to mobile electronic devices of the plurality of users.

F20. The medium of embodiment F15, the instructions further comprising instructions to:
provide an indication of a financial reward for one of the users sharing one of the provided prescription media objects.

F21. The medium of embodiment F15, the instructions further comprising instructions to:
obtain an indication of user sharing of one of the provided prescription media objects with a new user; and
provide a request for the new user to enroll with a healthcare service provider.

G1. A healthcare consultation processor-implemented method embodiment, comprising:
obtaining a trigger media object for coordinated patient management for a user;
obtaining a medical history record of the user using the obtained trigger media object;
analyzing, via a processor, the obtained medical history record of the user;
identifying, based on the analysis of the medical history record, a need for user consultation with a provider of a healthcare service; and
providing, for a plurality of such providers of the healthcare service, an indication of the identified need for user consultation.

G2. The method of embodiment G1, further comprising:
obtaining responses from the providers of the healthcare service to the provided indication of the identified need for user consultation;
providing, for the user, information on the responsive providers of the healthcare service based on the obtained responses; and
obtaining a user selection of one of the responsive providers of the healthcare service for user consultation.

G3. The method of embodiment G2, further comprising:
upon obtaining the user selection of one of the responsive providers of the healthcare service for user consultation,
   providing the medical history record of the user to the user-selected provider of the healthcare service; and
   providing an indication to establish a communication between a user device of the user and the user-selected provider of the healthcare service for user consultation.

G4. The method of embodiment G2, wherein obtaining responses from the providers of the healthcare service includes obtaining bids for providing user consultation from the providers of the healthcare service.

G5. The method of embodiment G3, further comprising:
identifying, based on the analysis of the medical history record, a current treatment plan for the user;
obtaining feedback on the user consultation from the user-selected provider of the healthcare service; and
generating a modified treatment plan for the user based on the obtained feedback on the user consultation.

G6. The method of embodiment G3, further comprising:
upon providing the indication to establish the communication between the user and the user-selected provider,
   obtaining a request to provide a prescription media object related to the user consultation;
   providing the requested prescription media object for the user;
   providing a request for user feedback to the provided prescription media object;
   obtaining the user feedback to the provided prescription media object; and
   validating, based on the obtained user feedback, user comprehension of information included in the provided prescription media object related to the user consultation.

G7. The method of embodiment G3, further comprising:
obtaining feedback on the user consultation from the user;
generating a performance report on the user consultation based on the obtained feedback on the user consultation from the user; and
providing the performance report on the user consultation.

G8. The method of embodiment G3, wherein the user device is a mobile electronic device.

G9. A healthcare consultation system embodiment, comprising:
a processor; and
a memory disposed in communication with the processor and storing processor-executable instructions, the instructions comprising instructions to:
   obtain a trigger media object for coordinated patient management for a user;
   obtain a medical history record of the user using the obtained trigger media object;
   analyze the obtained medical history record of the user;
   identify, based on the analysis of the medical history record, a need for user consultation with a provider of a healthcare service; and
   provide, for a plurality of such providers of the healthcare service, an indication of the identified need for user consultation.

G10. The system of embodiment G9, the instructions further comprising instructions to:
obtain responses from the providers of the healthcare service to the provided indication of the identified need for user consultation;
provide, for the user, information on the responsive providers of the healthcare service based on the obtained responses; and
obtain a user selection of one of the responsive providers of the healthcare service for user consultation.

G11. The system of embodiment G10, the instructions further comprising instructions to:
upon obtaining the user selection of one of the responsive providers of the healthcare service for user consultation,
   provide the medical history record of the user to the user-selected provider of the healthcare service; and
   provide an indication to establish a communication between a user device of the user and the user-selected provider of the healthcare service for user consultation.

G12. The system of embodiment G10, wherein obtaining responses from the providers of the healthcare service includes obtaining bids for providing user consultation from the providers of the healthcare service.

G13. The system of embodiment G11, the instructions further comprising instructions to:
identify, based on the analysis of the medical history record, a current treatment plan for the user;
obtain feedback on the user consultation from the user-selected provider of the healthcare service; and
generate a modified treatment plan for the user based on the obtained feedback on the user consultation.

G14. The system of embodiment G11, the instructions further comprising instructions to:
upon providing the indication to establish the communication between the user and the user-selected provider,
   obtain a request to provide a prescription media object related to the user consultation;
   provide the requested prescription media object for the user;
   provide a request for user feedback to the provided prescription media object;
   obtain the user feedback to the provided prescription media object; and
   validate, based on the obtained user feedback, user comprehension of information included in the provided prescription media object related to the user consultation.

G15. The system of embodiment G11, the instructions further comprising instructions to:
obtain feedback on the user consultation from the user;
generate a performance report on the user consultation based on the obtained feedback on the user consultation from the user; and
provide the performance report on the user consultation.

G16. The system of embodiment G11, wherein the user device is a mobile electronic device.

G17. A processor-readable medium embodiment storing processor-executable healthcare consultation instructions, the instructions comprising instructions to:
obtain a trigger media object for coordinated patient management for a user;
obtain a medical history record of the user using the obtained trigger media object;
analyze the obtained medical history record of the user;
identify, based on the analysis of the medical history record, a need for user consultation with a provider of a healthcare service; and
provide, for a plurality of such providers of the healthcare service, an indication of the identified need for user consultation.

G18. The medium of embodiment G17, the instructions further comprising instructions to:
obtain responses from the providers of the healthcare service to the provided indication of the identified need for user consultation;
provide, for the user, information on the responsive providers of the healthcare service based on the obtained responses; and
obtain a user selection of one of the responsive providers of the healthcare service for user consultation.

G19. The medium of embodiment G18, the instructions further comprising instructions to:
upon obtaining the user selection of one of the responsive providers of the healthcare service for user consultation,
   provide the medical history record of the user to the user-selected provider of the healthcare service; and
   provide an indication to establish a communication between a user device of the user and the user-selected provider of the healthcare service for user consultation.

G20. The medium of embodiment G18, wherein obtaining responses from the providers of the healthcare service includes obtaining bids for providing user consultation from the providers of the healthcare service.

G21. The medium of embodiment G19, the instructions further comprising instructions to:
identify, based on the analysis of the medical history record, a current treatment plan for the user;
obtain feedback on the user consultation from the user-selected provider of the healthcare service; and
generate a modified treatment plan for the user based on the obtained feedback on the user consultation.

G22. The medium of embodiment G19, the instructions further comprising instructions to:
upon providing the indication to establish the communication between the user and the user-selected provider,
   obtain a request to provide a prescription media object related to the user consultation;
   provide the requested prescription media object for the user;
   provide a request for user feedback to the provided prescription media object;
   obtain the user feedback to the provided prescription media object; and
   validate, based on the obtained user feedback, user comprehension of information included in the provided prescription media object related to the user consultation.

G23. The medium of embodiment G19, the instructions further comprising instructions to:
obtain feedback on the user consultation from the user;
generate a performance report on the user consultation based on the obtained feedback on the user consultation from the user; and
provide the performance report on the user consultation.

G24. The medium of embodiment G19, wherein the user device is a mobile electronic device.

G25. An informed consultation processor-implemented method embodiment, comprising:
generating via a processor a trigger media object for coordinate patient management for a user;
providing the generated trigger media object;
obtaining an indication of a need for user consultation with a provider of a healthcare service;
providing a request for information on providers of the healthcare service; and
obtaining the requested information on providers of the healthcare service.

G26. The method of embodiment G25, further comprising:
providing a user selection of one of the providers of the healthcare service for user consultation;
obtaining an indication to establish a communication between a user device of the user and the user-selected provider of the healthcare service for user consultation; and
establishing a communication between the user device and the user-selected provider of the healthcare service for user consultation.

G27. The method of embodiment G26, further comprising:
upon establishing the communication between the user device and the user-selected provider of the healthcare service,
   obtaining an indication of a new treatment plan for the user based on the user consultation with the user-selected provider of the healthcare service.

G28. The method of embodiment G26, further comprising:
upon establishing the communication between the user device and the user-selected provider of the healthcare service,
   obtaining a prescription media object related to the user consultation with the user-selected provider of the healthcare service; and
   presenting the prescription media object for the user.

G29. The method of embodiment G28, further comprising:
obtaining a request for user feedback to the obtained prescription media object related to the user consultation;
generating the user feedback in response to obtaining the request for user feedback; and
providing the generated user feedback to the obtained prescription media object related to the user consultation.

G30. The method of embodiment G29, further comprising:
upon, providing the generated user feedback,
   obtaining an indication of validation of user comprehension of information included in the obtained prescription media object related to the user consultation; and
   obtaining an indication of a financial reward related to the validation of user comprehension of the information included in the obtained prescription media object related to the user consultation.

G31. The method of embodiment G26, wherein the user device is a mobile electronic device.

G32. An informed consultation apparatus embodiment, comprising:
a processor; and
a memory disposed in communication with the processor and storing processor-executable instructions, the instructions comprising instructions to:
   generate a trigger media object for coordinate patient management for a user;
   provide the generated trigger media object;
   obtain an indication of a need for user consultation with a provider of a healthcare service;
   provide a request for information on providers of the healthcare service; and
   obtain the requested information on providers of the healthcare service.

G33. The apparatus of embodiment G32, the instructions further comprising instructions to:
provide a user selection of one of the providers of the healthcare service for user consultation;
obtain an indication to establish a communication between a user device of the user and the user-selected provider of the healthcare service for user consultation; and
establish a communication between the user device and the user-selected provider of the healthcare service for user consultation.

G34. The apparatus of embodiment G33, the instructions further comprising instructions to:
upon establishing the communication between the user device and the user-selected provider of the healthcare service,
   obtain an indication of a new treatment plan for the user based on the user consultation with the user-selected provider of the healthcare service.

G35. The apparatus of embodiment G33, the instructions further comprising instructions to:
upon establishing the communication between the user device and the user-selected provider of the healthcare service,
   obtain a prescription media object related to the user consultation with the user-selected provider of the healthcare service; and
   present the prescription media object for the user.

G36. The apparatus of embodiment G35, the instructions further comprising instructions to:
obtain a request for user feedback to the obtained prescription media object related to the user consultation;
generate the user feedback in response to obtaining the request for user feedback; and
provide the generated user feedback to the obtained prescription media object related to the user consultation.

G37. The apparatus of embodiment G36, the instructions further comprising instructions to:
upon, providing the generated user feedback,
   obtain an indication of validation of user comprehension of information included in the obtained prescription media object related to the user consultation; and
   obtain an indication of a financial reward related to the validation of user comprehension of the information included in the obtained prescription media object related to the user consultation.

G38. The apparatus of embodiment G33, wherein the user device is a mobile electronic device.

G39. A processor-readable medium embodiment storing processor-executable informed consultation instructions, the instructions comprising instructions to:
generate a trigger media object for coordinate patient management for a user;
provide the generated trigger media object;
obtain an indication of a need for user consultation with a provider of a healthcare service;
provide a request for information on providers of the healthcare service; and
obtain the requested information on providers of the healthcare service.

G40. The medium of embodiment G39, the instructions further comprising instructions to:
provide a user selection of one of the providers of the healthcare service for user consultation;
obtain an indication to establish a communication between a user device of the user and the user-selected provider of the healthcare service for user consultation; and
establish a communication between the user device and the user-selected provider of the healthcare service for user consultation.

G41. The medium of embodiment G40, the instructions further comprising instructions to:
upon establishing the communication between the user device and the user-selected provider of the healthcare service,
   obtain an indication of a new treatment plan for the user based on the user consultation with the user-selected provider of the healthcare service.

G42. The medium of embodiment G40, the instructions further comprising instructions to:
upon establishing the communication between the user device and the user-selected provider of the healthcare service,
   obtain a prescription media object related to the user consultation with the user-selected provider of the healthcare service; and
   present the prescription media object for the user.

G43. The medium of embodiment G42, the instructions further comprising instructions to:
obtain a request for user feedback to the obtained prescription media object related to the user consultation;
generate the user feedback in response to obtaining the request for user feedback; and
provide the generated user feedback to the obtained prescription media object related to the user consultation.

G44. The medium of embodiment G43, the instructions further comprising instructions to:
upon, providing the generated user feedback,
   obtain an indication of validation of user comprehension of information included in the obtained prescription media object related to the user consultation; and
   obtain an indication of a financial reward related to the validation of user comprehension of the information included in the obtained prescription media object related to the user consultation.

G45. The medium of embodiment G40, wherein the user device is a mobile electronic device.

G46. The method of embodiment G40, further comprising:
selecting, based on the obtained bids from the responsive providers of the healthcare service, a subset of the responsive providers of the healthcare service on whom information is provided for the user.

G47. The system of embodiment G12, the instructions further comprising instructions to:
select, based on the obtained bids from the responsive providers of the healthcare service, a subset of the responsive providers of the healthcare service on whom information is provided for the user.

G48. The medium of embodiment G20, the instructions further comprising instructions to:
select, based on the obtained bids from the responsive providers of the healthcare service, a subset of the responsive providers of the healthcare service on whom information is provided for the user.

H1. A user management processor-implemented method embodiment, comprising:
obtaining a request for a video from a user;
providing a request for a user identification of the user;
obtaining the user identification of the user;
querying via a processor a user database using the obtained user identification;
determining that the user is authenticated to access the video, based on querying the user database; and
providing the requested video for the user.

H2. The method of embodiment H1, wherein the request for the video is obtained from a mobile device of the user.

H3. The method of embodiment H1, wherein the video includes information on a healthcare topic.

H4. The method of embodiment H1, further comprising:
providing a newsfeed related to the requested video for the user.

H5. The method of embodiment H4, further comprising:
providing links to videos related to the requested video for the user.

H6. The method of embodiment H5, further comprising:
obtaining a request for one of the videos related to the requested video for the user; and
providing the requested related video for the user.

H7. A user management system embodiment, comprising:
a processor; and
a memory disposed in communication with the processor and storing processor-executable instructions, the instructions comprising instructions to:
   obtain a request for a video from a user;
   provide a request for a user identification of the user;
   obtain the user identification of the user;
   query a user database using the obtained user identification;
   determine that the user is authenticated to access the video, based on querying the user database; and
   provide the requested video for the user.

H8. The system of embodiment H7, wherein the request for the video is obtained from a mobile device of the user.

H9. The system of embodiment H7, wherein the video includes information on a healthcare topic.

H10. The system of embodiment H7, the instructions further comprising instructions to:
provide a newsfeed related to the requested video for the user.

H11. The system of embodiment H10, the instructions further comprising instructions to:
provide links to videos related to the requested video for the user.

H12. The system of embodiment Hu, the instructions further comprising instructions to:
obtain a request for one of the videos related to the requested video for the user; and
provide the requested related video for the user.

H13. A processor-readable medium embodiment storing processor-executable user management instructions, the instructions comprising instructions to:
obtain a request for a video from a user;
provide a request for a user identification of the user;
obtain the user identification of the user;
query a user database using the obtained user identification;
determine that the user is authenticated to access the video, based on querying the user database; and
provide the requested video for the user.

H14. The medium of embodiment H13, wherein the request for the video is obtained from a mobile device of the user.

H15. The medium of embodiment H13, wherein the video includes information on a healthcare topic.

H16. The medium of embodiment H13, the instructions further comprising instructions to:
provide a newsfeed related to the requested video for the user.

H17. The medium of embodiment H16, the instructions further comprising instructions to:
provide links to videos related to the requested video for the user.

H18. The medium of embodiment H17, the instructions further comprising instructions to:
obtain a request for one of the videos related to the requested video for the user; and
provide the requested related video for the user.

In order to address various issues and improve over the prior art, the invention is directed to apparatuses, methods and systems for a mobile healthcare manager. The entirety of this application (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs of the MHM and/or characteristics of the hardware, software, network framework, monetization model and/or the like, various embodiments of the MHM may be implemented that enable a great deal of flexibility and customization. The instant disclosure discusses example implementations of the MHM within the context of post-diagnosis/prescription user healthcare management that are illustrative. However, it is to be understood that the system described herein can be readily configured for a wide range of other applications and/or implementations. For example, implementations of the MHM can be configured to operate within the context of medical procedures, prescription medicine, pre- and post-medical-procedure care, medical devices, medical diagnostics, disease management, coordination of medical care, over-the-counter medications, vitamin supplements, and/or the like. Alternate implementations of the system may be utilized in various spheres outside healthcare services, including, but not limited to, young driver education, automobile insurance discount incentives, and/or the like. It is to be understood that the MHM may be further adapted to other implementations and/or coordinated user management applications.

What is claimed is:

1. A prescription comprehension validation processor-implemented method, comprising:
obtaining a coordinated patient management trigger;
identifying via a processor a prescription media object to provide for a user based on the obtained trigger;
providing the identified prescription media object for the user;
providing a request for user feedback to the provided prescription media object; and
obtaining the user feedback to the provided prescription media object.

2. The method of claim 1, wherein:
the provided prescription media object includes user-interactive content; and
the user feedback to the provided prescription media object is obtained via the user-interactive content included in the prescription media object.

3. The method of claim 1, further comprising:
analyzing the obtained user feedback to the provided prescription media object; and
validating, based on the analysis, user comprehension of information included in the provided prescription media object based on the obtained user feedback to the provided prescription media object.

4. The method of claim 3, further comprising:
providing an indication of a financial reward for the user, upon validating user comprehension of the information included in the provided prescription media object.

5. The method of claim 3, further comprising:
providing an indication that a healthcare service provider will provide a healthcare service for the user, upon validating user comprehension of the information included in the provided prescription media object.

6. The method of claim 1, wherein the prescription media object is provided to a mobile electronic device of the user.

7. The method of claim 1, wherein the request for user feedback includes a request for a patient reported outcome.

8. A prescription comprehension validation system, comprising:
a processor; and
a memory disposed in communication with the processor and storing processor-executable instructions, the instructions comprising instructions to:
obtain a coordinated patient management trigger;
identify a prescription media object to provide for a user based on the obtained trigger;
provide the identified prescription media object for the user;
provide a request for user feedback to the provided prescription media object; and
obtain the user feedback to the provided prescription media object.

9. The system of claim 8, wherein:
the provided prescription media object includes user-interactive content; and
the user feedback to the provided prescription media object is obtained via the user-interactive content included in the prescription media object.

10. The system of claim 8, the instructions further comprising instructions to:
analyze the obtained user feedback to the provided prescription media object; and
validate, based on the analysis, user comprehension of information included in the provided prescription media object based on the obtained user feedback to the provided prescription media object.

11. The system of claim 10, the instructions further comprising instructions to:
provide an indication of a financial reward for the user, upon validating user comprehension of the information included in the provided prescription media object.

12. The system of claim 10, the instructions further comprising instructions to:
provide an indication that a healthcare service provider will provide a healthcare service for the user, upon validating user comprehension of the information included in the provided prescription media object.

13. The system of claim 8, wherein the prescription media object is provided to a mobile electronic device of the user.

14. The system of claim 8, wherein the request for user feedback includes a request for a patient reported outcome.

15. A processor-readable medium storing processor-executable prescription comprehension validation instructions, the instructions comprising instructions to:
obtain a coordinated patient management trigger;
identify a prescription media object to provide for a user based on the obtained trigger;
provide the identified prescription media object for the user;
provide a request for user feedback to the provided prescription media object; and
obtain the user feedback to the provided prescription media object.

16. The medium of claim 15, wherein:
the provided prescription media object includes user-interactive content; and
the user feedback to the provided prescription media object is obtained via the user-interactive content included in the prescription media object.

17. The medium of claim 15, the instructions further comprising instructions to:
analyze the obtained user feedback to the provided prescription media object; and
validate, based on the analysis, user comprehension of information included in the provided prescription media object based on the obtained user feedback to the provided prescription media object.

18. The medium of claim 17, the instructions further comprising instructions to:
provide an indication of a financial reward for the user, upon validating user comprehension of the information included in the provided prescription media object.

19. The medium of claim 17, the instructions further comprising instructions to:
provide an indication that a healthcare service provider will provide a healthcare service for the user, upon validating user comprehension of the information included in the provided prescription media object.

20. The medium of claim 15, wherein the prescription media object is provided to a mobile electronic device of the user.

21. The medium of claim 15, wherein the request for user feedback includes a request for a patient reported outcome.

22. A prescription comprehension confirmation processor-implemented method, comprising:
generating via a processor a coordinated patient management trigger;
providing the coordinated patient management trigger;
obtaining a prescription media object in response to providing the coordinated patient management trigger;
presenting the obtained prescription media object for the user;
obtaining a request for user feedback to the obtained prescription media object; and
providing the user feedback to the obtained prescription media object.

23. The method of claim 22, wherein:
the obtained prescription media object includes user-interactive content; and
the user feedback to the obtained prescription media object is provided via the user-interactive content included in the prescription media object.

24. The method of claim 22, further comprising:
obtaining an indication of validation of user comprehension of information in the obtained prescription media object, in response to providing the user feedback to the obtained prescription media object.

25. The method of claim 22, further comprising:
obtaining an indication of a financial reward for the user, in response to providing the user feedback to the obtained prescription media object.

26. The method of claim 22, further comprising:
obtaining an indication that a healthcare service provider will provide a healthcare service for the user, in response to providing the user feedback to the obtained prescription media object.

27. The method of claim 22, wherein the processor is included within a mobile electronic device.

28. The method of claim 22, wherein providing the user feedback to the obtained prescription media object includes providing a patient reported outcome.

29. A prescription comprehension confirmation apparatus, comprising:
a processor; and
a memory disposed in communication with the processor and storing processor-executable instructions, the instructions comprising instructions to:
generate a coordinated patient management trigger;
provide the coordinated patient management trigger;
obtain a prescription media object in response to providing the coordinated patient management trigger;
present the obtained prescription media object for the user;
obtain a request for user feedback to the obtained prescription media object; and
provide the user feedback to the obtained prescription media object.

30. The apparatus of claim 29, wherein:
the obtained prescription media object includes user-interactive content; and
the user feedback to the obtained prescription media object is provided via the user-interactive content included in the prescription media object.

31. The apparatus of claim 29, the instructions further comprising instructions to:
obtain an indication of validation of user comprehension of information in the obtained prescription media object, in response to providing the user feedback to the obtained prescription media object.

32. The apparatus of claim 29, the instructions further comprising instructions to:
obtain an indication of a financial reward for the user, in response to providing the user feedback to the obtained prescription media object.

33. The apparatus of claim 29, the instructions further comprising instructions to:
obtain an indication that a healthcare service provider will provide a healthcare service for the user, in response to providing the user feedback to the obtained prescription media object.

34. The apparatus of claim 29, wherein the processor is included within a mobile electronic device.

35. The apparatus of claim 29, wherein providing the user feedback to the obtained prescription media object includes providing a patient reported outcome.

36. A processor-readable medium storing processor-executable prescription comprehension confirmation instructions, the instructions comprising instructions to:
generate a coordinated patient management trigger;
provide the coordinated patient management trigger;
obtain a prescription media object in response to providing the coordinated patient management trigger;
present the obtained prescription media object for the user;
obtain a request for user feedback to the obtained prescription media object; and
provide the user feedback to the obtained prescription media object.

37. The medium of claim 36, wherein:
the obtained prescription media object includes user-interactive content; and
the user feedback to the obtained prescription media object is provided via the user-interactive content included in the prescription media object.

38. The medium of claim 36, the instructions further comprising instructions to:
obtain an indication of validation of user comprehension of information in the obtained prescription media object, in response to providing the user feedback to the obtained prescription media object.

39. The medium of claim 36, the instructions further comprising instructions to:
obtain an indication of a financial reward for the user, in response to providing the user feedback to the obtained prescription media object.

40. The medium of claim 36, the instructions further comprising instructions to:
obtain an indication that a healthcare service provider will provide a healthcare service for the user, in response to providing the user feedback to the obtained prescription media object.

41. The medium of claim 36, wherein the medium is included within a mobile electronic device.

42. The medium of claim 36, wherein providing the user feedback to the obtained prescription media object includes providing a patient reported outcome.
